(19) United States
(12) Patent Application Publication
(10) Pub. No.: US 2026/0042940 A1
(43) Pub. Date: Feb. 12, 2026

(54) Conductive Adhesives And Epoxies

(71) Applicant: Nanotech Energy, Inc., Sunny Isles Beach, FL (US)

(72) Inventors: Maher F. El-Kady, Los Angeles, CA (US); Pashupati Pokharel, Chico, CA (US)

(21) Appl. No.: 19/364,504

(22) Filed: Oct. 21, 2025

Related U.S. Application Data
(63) Continuation of application No. PCT/US24/25183, filed on Apr. 18, 2024.
(60) Provisional application No. 63/497,647, filed on Apr. 21, 2023.

(51) Int. Cl. C09J 9/02; C08G 59/22; C08G 59/24; C08G 59/40; C08G 59/50; C08K 3/04; C08K 3/08; C08K 5/01; C08K 5/49; C08K 7/00; C08L 63/00; C09J 163/00

(52) U.S. Cl. CPC C09J 9/02; C08G 59/223; C08G 59/245; C08G 59/4021; C08G 59/50; C08K 3/042; C08K 5/01; C08K 5/49; C08K 7/00; C08L 63/00; C09J 163/00; C08G 2170/00; C08K 2003/0806; C08K 2201/004; C08K 2201/006; C08L 2203/20; C08L 2207/324

(57) ABSTRACT

A conductive epoxy composition is disclosed comprising an epoxy resin, a low-viscosity hydrocarbon diluent, silver, and graphene. The one-part formulation provides enhanced electrical conductivity, mechanical strength, and process stability. The epoxy resin may include resorcinol diglycidyl ether, diglycidyl ether of Bisphenol A, or Bisphenol F. The hydrocarbon diluent may include glycidyl-ether-family resins having defined carbon-chain characteristics and molecular weights. Silver may be present in particulate, flake, nanoparticle, or coated forms at about 55-90 wt. %, while graphene may be present at 0.03-0.3 wt. % with dimensions of 1-10 μm and surface areas of 400-2,000 m²/g. Optional additives include solvents, ionic liquids, latent curing agents, and strength enhancers to optimize curing and adhesion.

### CROSS REFERENCE TO OTHER APPLICATION(S)

This application is a continuation of PCT Application No. PCT/US2024/025183, filed 2024 Apr. 18, which claims the benefit of U.S. Provisional Application No. 63/497,647, filed 2023 Apr. 21, both of which are incorporated herein in their entirety by reference.

### BACKGROUND

Electrical bonding is used in the production of printed circuit boards, batteries, diodes, capacitors, resistors, transistors, processors, thermal management devices, and integrated circuits, and one such common electrical bonding is soldering. In theory, conductive epoxy adhesives would provide a tougher and more durable joint than the solder; however, extant conductive adhesive formulations fail to provide adequate performance to enable them for industrial application.

### SUMMARY

It is appreciated by the inventors of the instant application that soldering as a means of electrical bonding presents a number of performance and safety risks. The use of lead-tin solder as a bonding material for electronic components has the potential for lead poisoning, and is subject to regulation as industrial electronic waste. Further, soldering produces bonds which are typically softer and weaker than the other bonds in the device in which they are situated, and are prone to failure. While various epoxy-based adhesive alternatives are available in the market, many form brittle bonds with dissimilar substrates. As such, electrical components coupled with such inflexible adhesives often fail under mechanical shock or vibration. Devices such as calculators, telephones, and laptop computers have components that are surface mounted onto wiring boards with narrow bond thicknesses, which creates a bond when using rigid epoxy that is too weak and/or too rigid to withstand drops and minor impacts. Further, many such conductive adhesive formulations, which have attempted to address these issues produce a bond with poor electrical conductivity or poor thermal stability, which renders the conductive adhesive unsuitable for use in an electronic device. In addition, conductive adhesives often use high concentrations of metal particles (e.g., at least about 85%) and exhibit limitations such as a drop resistance less than that of lead-tin solder and viscosities too high for application by, for example, screen-printing. Disclosed herein is an industrially feasible method and compositions for a flexible graphene powered electrically conductive epoxy-based adhesive, which can exhibit drop-resistance while retaining high tensile characteristics with excellent adhesion property, addressing various performance and safety risks present in extant conductive adhesives.

Further, the use of adhesives offers many advantages over binding techniques such as sewing, mechanical fastening, thermal bonding, etc. Although lead/tin solders have been used in the electronic industry for many years, they require high temperatures for operation, meaning that it cannot be used with heat-sensitive materials.

In some embodiments, the conductive adhesives disclosed herein may be used as an alternative to lead-based solders. Their low curing temperatures provide a completely safe solution for bonding heat-sensitive components during manufacturing. In some embodiments, the conductive adhesives of the instant disclosure may be used for the assembly and repair of electrical modules, waveguides, flat cables, and high-frequency shields. In some embodiments, the conductive adhesives can also find extensive applications in bonding semiconductor chips, integrated monolithic circuits, diodes, transistors, and other components in thin film and thick film hybrid microelectronic circuits.

Aspects disclosed herein provide a 1-part conductive epoxy comprising: an epoxy resin; a diluent comprising a low viscosity hydrocarbon; silver; and graphene. In some embodiments, the 1-part conductive epoxy further comprises: a solvent; an ionic liquid; a latent curing agent; a strength additive; or any combination thereof. In some embodiments, the epoxy resin comprises: a resorcinol diglyceryl ether epoxy resin; a diglycidyl ether of Bisphenol A; a diglycidyl ether of Bisphenol F; or any combination thereof. In some embodiments, the diluent comprises a liquid hydrocarbon resin. In some embodiments, the diluent is chemically inert or non-reactive. In some embodiments, the diluent is non-reactive with silver and graphene. In some embodiments, the diluent serves as a plasticizer. In some embodiments, the diluent increases the flexibility of the epoxy. In some embodiments, the diluent comprises a liquid hydrocarbon resin from the glycidyl ether family. In some embodiments, the diluent comprises a glycidyl ether family having a linear carbon chain with at least one carbon ring in the chain. In some embodiments, the diluent comprises liquid hydrocarbon resin from a glycidyl ether family having at least 10 carbons. In some embodiments, the diluent comprises a liquid hydrocarbon resin from the glycidyl ether family having 10 to 20 carbons. In some embodiments, the diluent comprises a liquid hydrocarbon resin from the glycidyl ether family having about 14 carbons, or 4,4′-dimethyl-2,2-diphenylpropane. In some embodiments, the diluent comprises a glycidyl ether family liquid hydrocarbon resin having a molecular weight of at least 200 g/mol. In some embodiments, the diluent comprises a liquid hydrocarbon resin from the glycidyl ether family having a molecular weight of 200-300 g/mol. In some embodiments, the diluent comprises a liquid hydrocarbon resin from the glycidyl ether family having a molecular weight of less than 300 g/mol. In some embodiments, the diluent comprises a liquid hydrocarbon resin from the glycidyl ether family having a molecular weight of about 224 g/mol. In some embodiments, the graphene is comprised in a concentration of at least 0.03% (wt.). In some embodiments, the graphene is comprised in a concentration from about 0.03% to about 0.1%. In some embodiments, the graphene has a width, a length, or both of about 1 μm to 10 μm. In some embodiments, the graphene has a surface area of about 400 m²/g to about 2,000 m²/g. In some embodiments, the graphene has a thickness of about 1 nm to about 5 nm. In some embodiments, the silver comprises silver flakes, colloidal silver nanoparticles, silver nanowires, spherical silver microparticles, silver-coated copper, silver-coated glass powder, silver-coated ceramic powder, or any combination thereof. In some embodiments, the silver has a width, a length, or both of about 1 μm to about 30 μm. In some embodiments, the graphene and the silver are suspended in a polymer matrix formed by the epoxy resin. In some embodiments, the 1-part conductive epoxy has a concentration by weight of the epoxy resin of at most about 25%. In some embodiments, the 1-part conductive epoxy has a concentration by weight of the diluent of at least about 2%. In some embodiments, the 1-part conductive epoxy has a concentration by weight of the silver of about 55% to about 90%. In some embodiments, the 1-part conductive epoxy has a concentration by weight of the graphene of less than about 0.3%. In some embodiments, the solvent comprises methyl ethyl ketone, benzyl alcohol, or both. In some embodiments, the ionic liquid comprises tributyl(ethyl) phosphonium diethyl phosphate, trihexyl (tetradecyl) phosphonium bis 2,4,4-(trimethyl pentyl)-phosphinate, or both. In some embodiments, the latent curing agent comprises dicyandiamide, organic acid hydrazide, tertiary amine imidazole, a boron trifluoride amine complex, or any combination thereof. In some embodiments, the strength additive comprises neopentyl glycol, butadiene-acrylonitrile, or both. In some embodiments, the strength additive comprises the neopentyl glycol, wherein the neopentyl glycol comprises an epoxidized neopentyl glycol adduct. In some embodiments, the strength additive comprises the butadiene-acrylonitrile, wherein the butadiene-acrylonitrile comprises an amine-terminated butadiene-acrylonitrile copolymer. In some embodiments, the conductive epoxy has a concentration by weight of the solvent of less than about 30%. In some embodiments, the conductive epoxy has a concentration by weight of the ionic liquid of at most about 4%. In some embodiments, the conductive epoxy has a concentration by weight of the latent curing agent of at most about 10%. In some embodiments, having a concentration by weight of the strength additive of at most about 8%. In some embodiments, the conductive epoxy has a viscosity of about 10 Pa*s to about 510 Pa*s at a shear rate of 1 Hz (1/s). In some embodiments, the conductive epoxy has a volume resistivity when cured of at most about 15 mΩ*m. In some embodiments, the conductive epoxy has an electrical conductivity when cured of at least about 100 S/cm. In some embodiments, the conductive epoxy has a thermal conductivity when cured of about 1 W/mK to about 20 W/mK. In some embodiments, the conductive epoxy has a lap shear stress when cured of about 40 psi to about 3,000 psi. In some embodiments, the conductive epoxy has a Thixotropic index of about 2 to about 10. In some embodiments, the conductive epoxy has a storage modulus when cured of about 200 MPa to 3,000 MPa.

Aspects disclosed herein provide a method of forming a 1-part conductive epoxy, the method comprising: forming a compound comprising: an epoxy resin; a diluent; and graphene; a latent curing agent; mixing the compound; adding silver to the compound; and mixing the compound. In some embodiments, the epoxy resin comprises: a resorcinol diglycidyl ether epoxy resin; a Cycloaliphatic epoxy resin; a diglycidyl ether of Bisphenol A; a diglycidyl ether of Bisphenol F; or any combination thereof. In some embodiments, the diluent comprises a liquid hydrocarbon resin. In some embodiments, the diluent comprises a liquid hydrocarbon resin with low viscosity. In some embodiments, the diluent is non-reactive. In some embodiments, the diluent comprises a liquid hydrocarbon resin from the glycidyl ether family having a linear carbon chain with at least one carbon ring in the chain. In some embodiments, wherein the diluent comprises a liquid hydrocarbon resin from the glycidyl ether family having at least 10 carbons. In some embodiments, the diluent comprises a liquid hydrocarbon resin from the glycidyl ether family having 10 to 20 carbons. In some embodiments, the diluent comprises a liquid hydrocarbon resin from the glycidyl ether family having about 14 carbons, or 4,4′-dimethyl-2,2-diphenylpropane. In some embodiments, the diluent comprises a liquid hydrocarbon resin from the glycidyl ether family having a molecular weight of at least 200 g/mol. In some embodiments, the diluent comprises a liquid hydrocarbon resin from the glycidyl ether family having a molecular weight of 200-300 g/mol. In some embodiments, wherein the diluent comprises a liquid hydrocarbon resin from the glycidyl ether family having a molecular weight of less than 300 g/mol. In some embodiments, the diluent comprises a liquid hydrocarbon resin from glycidyl ether family having a molecular weight of about 224 g/mol. In some embodiments, the diluent acts as a plasticizer. In some embodiments, the diluent increases the flexibility of the epoxy. In some embodiments, the chemisorption of the diluent on the surfaces of the graphene prevents agglomeration of the graphene. In some embodiments, the diluent increases the loading capacity of metal nanoparticles or silver. In some embodiments, the diluent increases the loading capacity of metal nanoparticles or silver. In some embodiments, the graphene acts as a dispersing agent in the mixing of the compound. In some embodiments, the silver comprises silver flakes, colloidal silver nanoparticles, silver nanowires, spherical silver microparticles, silver-coated copper, silver-coated glass powder, silver-coated ceramic powder, or any combination thereof. In some embodiments, the silver has a width, a length, or both of about 1 μm to about 30 μm. In some embodiments, the graphene has a width, a length, or both of about 1 μm to about 10 μm and a thickness of about 1 nm to about 10 nm. In some embodiments, the graphene comprises graphene flakes from 1 to 10 layers. In some embodiments, the graphene comprises exfoliated graphene sheets. In some embodiments, the graphene has a surface area of about 400 m²/g to about 2,000 m²/g. In some embodiments, the graphene comprises exfoliated graphene sheets having a surface area of about 400 m²/g to about 2,000 m²/g. In some embodiments, the graphene has a thickness of about 1 nm to about 10 nm. In some embodiments, a concentration by weight of the epoxy resin in the first compound is at most about 25%. In some embodiments, a concentration by weight of the diluent in the first compound is at least about 2%. In some embodiments, a concentration by weight of the silver in the first compound is about 55% to about 90%. In some embodiments, a concentration by weight of the graphene in the first compound is less than about 0.3%. In some embodiments, the compound further comprises: a solvent; an ionic liquid; a latent curing agent; a strength additive; or any combination thereof. In some embodiments, the solvent comprises methyl ethyl ketone, benzyl alcohol, or any combination thereof. In some embodiments, the ionic liquid comprises tributyl(ethyl) phosphonium diethyl phosphate, trihexyl (tetradecyl) phosphonium bis 2,4,4-(trimethyl pentyl)-phosphinate, or both. In some embodiments, the latent curing agent comprises a modified polyamine, dicyanamide, a boron trifluoride amine complex, or any combination thereof. In some embodiments, the strength additive comprises neopentyl glycol, butadiene-acrylonitrile, or both. In some embodiments, the concentration by weight of the solvent in the compound is less than about 30%. In some embodiments, a concentration by weight of the ionic liquid in the compound is at most about 4%. In some embodiments, a concentration by weight of the latent curing agent in the compound is about 0.51% to about 10%. In some embodiments, a concentration by weight of the strength additive in the compound is at most about 8%. In some embodiments, the mixing of graphene and low viscosity liquid hydrocarbon resin is a high-shear mixing process. In some embodiments, at least a portion of the step of mixing the compound is performed at a mixer speed of about 5,000 rpm to about 20,000 rpm. In some embodiments, the mixing the compound is performed at a mixer speed of about 500 rpm to about 2000 rpm for about 0.5 hrs to about 2 hrs. In some embodiments, at least a portion of forming the compound exfoliates the graphene in the diluent. In some embodiments, at least a portion of forming the compound exfoliates the graphene in the diluent and increases the surface area of the graphene. In some embodiments, at least a portion of forming the compound is performed by ultra-sonification, high shear mixing, ball mixing, roll mixing, planetary mixing, or any combination thereof. In some embodiments, forming the compound is performed for about 10 minutes to about 200 minutes. In some embodiments, adding silver to the compound is performed over a time period of about 5 minutes to about 15 minutes. In some embodiments, mixing the compound is performed over a time period of about 30 minutes to about 60 minutes. In some embodiments, at least a portion of mixing the compound is performed under vacuum. In some embodiments, at least a portion of mixing the compound is performed below 25° C.

Aspects disclosed herein provide a two-part conductive epoxy comprising: a first part comprising: an epoxy resin; a non-reactive diluent; silver; and graphene. a second part comprising: at least one curing agent; a reactive diluent; silver; and graphene. In some embodiments, the first part of the conductive epoxy and the second part of the conductive epoxy are present in a ratio of about 1:1 to about 2:1 by weight. In some embodiments, the epoxy resin comprises: diglycidyl ether of Bisphenol A; diglycidyl ether of Bisphenol F; a reactive diluent; diglycidyl ether of Bisphenol A and diglycidyl ether of Bisphenol F with a reactive diluent; or any combination thereof. In some embodiments, the reactive diluent comprises 2-ethylhexyl glycidyl ether. In some embodiments, the non-reactive diluent comprises a liquid hydrocarbon resin. In some embodiments, the non-reactive diluent comprises a liquid hydrocarbon resin with low viscosity. In some embodiments, the non-reactive diluent is non-reactive. In some embodiments, the non-reactive diluent comprises a liquid hydrocarbon resin from the glycidyl ether family having a linear carbon chain with at least one carbon ring in the chain. In some embodiments, the non-reactive diluent comprises a liquid hydrocarbon resin from the glycidyl ether family having at least 10 carbons. In some embodiments, the non-reactive diluent comprises a liquid hydrocarbon resin from the glycidyl ether family having 10 to 20 carbons. In some embodiments, the non-reactive diluent comprises a liquid hydrocarbon resin from the glycidyl ether family having about 14 carbons, or 4,4′-dimethyl-2,2-diphenylpropane. In some embodiments, the non-reactive diluent comprises a liquid hydrocarbon resin from the glycidyl ether family having a molecular weight of at least 200 g/mol. In some embodiments, the non-reactive diluent comprises a liquid hydrocarbon resin from the glycidyl ether family having a molecular weight of 200-300 g/mol. In some embodiments, the non-reactive diluent comprises a liquid hydrocarbon resin from the glycidyl ether family having a molecular weight of less than 300 g/mol. In some embodiments, the non-reactive diluent comprises a liquid hydrocarbon resin from the glycidyl ether family having a molecular weight of about 224 g/mol. In some embodiments, the non-reactive diluent acts as a plasticizer. In some embodiments, the non-reactive diluent increases the flexibility of the epoxy. In some embodiments, chemisorption of the diluent on the surfaces of the graphene prevents agglomeration of the graphene. In some embodiments, the diluent increases the loading capacity of metal nanoparticles, or the silver. In some embodiments, the diluent increases the loading capacity of metal nanoparticles, or the silver relative to the increase in viscosity resulting from the addition of the metal nanoparticles, or the silver. In some embodiments, the graphene acts as a dispersing agent in the mixing of the compound. In some embodiments, the silver comprises silver flakes, colloidal silver nanoparticles, silver nanowires, spherical silver microparticles, silver-coated copper, silver-coated glass powder, silver-coated ceramic powder, or any combination thereof. In some embodiments, the silver has a width, a length, or both of about 1 μm to about 30 μm. In some embodiments, the graphene has a width, a length, or both of about 1 μm to about 10 μm and thickness of about 1 nm to about 10 nm. In some embodiments, the graphene comprises graphene flakes from 1 to 10 layers. In some embodiments, the graphene comprises exfoliated graphene sheets. In some embodiments, the graphene has a surface area of about 400 m²/g to about 2,000 m²/g. In some embodiments, the graphene comprises exfoliated graphene sheets having a surface area of about 400 m²/g to about 2,000 m²/g. In some embodiments, the graphene has a thickness of about 1 nm to about 10 nm. In some embodiments, a concentration by weight of the epoxy resin in the first compound is at most about 25%. In some embodiments, a concentration by weight of the non-reactive diluent in the first compound is at least about 2%. In some embodiments, a concentration by weight of the silver in the first compound Is about 55% to about 90%. In some embodiments, a concentration by weight of the graphene in the first compound is less than about 0.3%. In some embodiments, the compound further comprises: a solvent; a strength additive; or any combination thereof. In some embodiments, the solvent comprises benzyl alcohol. In some embodiments, the curing agent comprises a modified cycloaliphatic polyamine, a modified aliphatic amine, a phenylamine-based modified polyamine, a modified amine, or any combination thereof. In some embodiments, the strength additive comprises CTBN-Toughened Epoxidized Neopentyl Glycol Adduct, Amine-terminated butadiene-acrylonitrile copolymer, or both. In some embodiments, the concentration by weight of the solvent in the compound is less than about 15%. In some embodiments, a concentration by weight of the curing agent in the compound is about 1% to about 20%. In some embodiments, a concentration by weight of the strength additive in the compound is at most about 15%. In some embodiments, a concentration by weight of the strength additive in the compound is about 2% to about 10%. In some embodiments, the conductive epoxy has a viscosity of about 10 Pa*s to about 510 Pa*s at a shear rate of 1 Hz (1/s). In some embodiments, the conductive epoxy has a volume resistivity when cured of at most about 15 mΩ*m. In some embodiments, the conductive epoxy has an electrical conductivity when cured of at least about 100 S/cm. In some embodiments, the conductive epoxy has a thermal conductivity when cured of about 1 W/mK to about 20 W/mK. In some embodiments, the conductive epoxy has a lap shear stress when cured of about 40 psi to about 3,000 psi. In some embodiments, the conductive epoxy has a Thixotropic index of about 2 to about 10. In some embodiments, the conductive epoxy has a storage modulus when cured of about 200 mPa to 3,000 mPa.

Aspects provided herein provide a method of forming a 2-part conductive epoxy, the method comprising: forming a first part of the conductive epoxy by: forming a first compound comprising: a non-reactive diluent; and graphene; mixing the first compound; forming a second compound comprising: the first compound; and an epoxy resin; mixing the second compound; adding silver to the second compound to form a third compound; and mixing the third compound; forming a second part of the conductive epoxy by: forming a fourth compound comprising: a non-reactive diluent; and graphene; mixing the fourth compound; forming a fifth compound comprising: the fourth compound; and a curing agent; mixing the fifth compound; adding silver to the fifth compound to form a sixth compound; and mixing the sixth compound. In some embodiments, mixing the first part of the conductive epoxy and the second part of the conductive epoxy. In some embodiments, mixing the first part of the conductive epoxy and the second part of the conductive epoxy in a ratio of about 1:1 to about 2:1 by weight. In some embodiments, the epoxy resin comprises: diglycidyl ether of Bisphenol A; diglycidyl ether of Bisphenol F; a reactive diluent; diglycidyl ether of Bisphenol A and diglycidyl ether of Bisphenol F with a reactive diluent; or any combination thereof. In some embodiments, the reactive diluent comprises 2-ethylhexyl glycidyl ether. In some embodiments, the non-reactive diluent comprises a liquid hydrocarbon resin. In some embodiments, the non-reactive diluent comprises a liquid hydrocarbon resin with a low viscosity. In some embodiments, the non-reactive diluent is non-reactive. In some embodiments, the non-reactive diluent comprises a liquid hydrocarbon resin from the glycidyl ether family. In some embodiments, the non-reactive diluent comprises a liquid hydrocarbon resin from the glycidyl ether family having a linear carbon chain with at least one carbon ring in the chain. In some embodiments, the non-reactive diluent comprises a liquid hydrocarbon resin from the glycidyl ether family having at least 10 carbons. In some embodiments, the non-reactive diluent comprises a liquid hydrocarbon resin from the glycidyl ether family having 10 to 20 carbons. In some embodiments, the non-reactive diluent comprises a liquid hydrocarbon resin from the glycidyl ether family having about 14 carbons, or 4,4′-dimethyl-2,2-diphenylpropane. In some embodiments, the non-reactive diluent comprises a liquid hydrocarbon resin from the glycidyl ether family having a molecular weight of at least 200 g/mol. In some embodiments, the non-reactive diluent comprises a liquid hydrocarbon resin from the glycidyl ether family having a molecular weight of 200-300 g/mol. In some embodiments, the non-reactive diluent comprises a liquid hydrocarbon resin from the glycidyl ether family having a molecular weight of less than 300 g/mol. In some embodiments, the non-reactive diluent comprises a liquid hydrocarbon resin from the glycidyl ether family having a molecular weight of about 224 g/mol. In some embodiments, the non-reactive diluent acts as a plasticizer. In some embodiments, the non-reactive diluent increases the flexibility of the epoxy. In some embodiments, the chemisorption of the diluent on the surfaces of the graphene prevents agglomeration of the graphene. In some embodiments, the diluent increases the loading capacity of metal nanoparticles, or the silver. In some embodiments, the diluent increases the loading capacity of metal nanoparticles or silver. In some embodiments, the graphene acts as a dispersing agent in the mixing of the first part of the conductive epoxy. In some embodiments, the silver comprises silver flakes, colloidal silver nanoparticles, silver nanowires, spherical silver microparticles, silver-coated copper, silver-coated glass powder, silver-coated ceramic powder, or any combination thereof. In some embodiments, the silver has a width, a length, or both of about 1 μm to about 30 μm. In some embodiments, the graphene has a width, a length, or both of about 1 μm to about 10 μm and a thickness of about 1 nm to about 10 nm. In some embodiments, the graphene comprises graphene flakes from 1 to 10 layers. In some embodiments, the graphene comprises exfoliated graphene sheets. In some embodiments, the graphene has a surface area of about 400 m²/g to about 2,000 m²/g. In some embodiments, the graphene comprises exfoliated graphene sheets having a surface area of about 400 m²/g to about 2,000 m²/g. In some embodiments, the graphene has a thickness of about 1 nm to about 10 nm. In some embodiments, a concentration by weight of the epoxy resin in the first compound is at most about 25%. In some embodiments, a concentration by weight of the non-reactive diluent in the first compound is at least about 2%. In some embodiments, a concentration by weight of the silver in the first compound is about 55% to about 90%. In some embodiments, a concentration by weight of the graphene in the first compound is less than about 0.3%. In some embodiments, the compound further comprises: a solvent; a strength additive; or any combination thereof. In some embodiments, the solvent comprises benzyl alcohol. In some embodiments, the curing agent comprises a modified cycloaliphatic polyamine, a modified aliphatic amine, a phenalkamine-based modified polyamine, a modified amine, or any combination thereof. In some embodiments, the strength additive comprises CTBN-Toughened Epoxidized Neopentyl Glycol Adduct, Amine-terminated butadiene-acrylonitrile copolymer, or both. In some embodiments, the concentration by weight of the solvent in the compound is less than about 15%. In some embodiments, a concentration by weight of the curing agent in the compound is about 1% to about 20%. In some embodiments, a concentration by weight of the strength additive in the compound is at most about 15%. In some embodiments, a concentration by weight of the strength additive in the compound is about 2% to about 10%. In some embodiments, the mixing of graphene and the non-reactive diluent is a high-shear mixing process. In some embodiments, at least a portion of the mixing the first compound or the mixing the fourth compound is performed at a mixer speed of about 5,000 rpm to about 20,000 rpm. In some embodiments, the mixing the second compound or the mixing the fifth compound is performed at a mixer speed of about 500 rpm to about 2000 rpm for about 0.5 hrs to about 2 hrs. In some embodiments, at least a portion of the mixing the first compound or the mixing the fourth compound exfoliates the graphene in the diluent. In some embodiments, at least a portion of the mixing the first compound or the mixing the fourth compound exfoliates the graphene in the diluent and increases the surface area of the graphene. In some embodiments, at least a portion of the mixing the first compound or the mixing the fourth compound is performed by ultrasonification, high shear mixing, ball mixing, roll mixing planetary mixing, or any combination thereof. In some embodiments, the mixing the first compound or the mixing the fourth compound is performed for about 10 minutes to about 200 minutes. In some embodiments, the mixing of the second compound or the mixing the fifth compound is performed over a time period of about 5 minutes to about 15 minutes. In some embodiments, the mixing the third compound or the mixing the sixth compound is performed over a time period of about 30 minutes to about 60 minutes. In some embodiments, at least a portion of the mixing the third compound or the mixing the sixth compound is performed under vacuum. In some embodiments, at least a portion of the mixing the third compound or the mixing the sixth compound is performed below 25° C.

Another aspect provided herein is an integrated circuit comprising: a first electronics component; a second electronics component; and the conductive epoxy herein conductively coupling at least a portion of the first electronics component to at least a portion of the second electronics component.

Another aspect provided method of forming an integrated circuit, the method comprising: receiving a first electronics component and a second electronics component; applying the conductive epoxy herein to at least a first portion of the first electronics component, at least a second portion of the second electronics component, or both; adjoining the first electronics component and the second electronics component at the first portion, the second portion, or both; and curing the conductive epoxy. In some embodiments, the curing of the conductive epoxy is performed at a temperature of about 100° C. to about 200° C. In some embodiments, the curing the conductive epoxy is performed for a period of time of about 1 minute to about 60 minutes. In some embodiments, the method further comprises mixing a first part and a second part of the conductive epoxy before applying the conductive epoxy.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 is a first diagram of an exemplary one-part conductive epoxy, per one or more embodiments herein;

FIG. 2 is a second diagram of an exemplary one-part conductive epoxy, per one or more embodiments herein;

FIG. 3 is a diagram of an exemplary two-part conductive epoxy, per one or more embodiments herein;

FIG. 4A is an image of an exemplary conductive epoxy on a flexible substrate, per one or more embodiments herein;

FIG. 4B is an image of an exemplary conductive epoxy on a printed circuit board (PCB) substrate, per one or more embodiments herein;

FIG. 5A is a chart of cure temperature vs. conductivity for the first exemplary two-part epoxy cured for two hours, per one or more embodiments herein;

FIG. 5B is a chart of cure temperature vs. conductivity for the fifth exemplary two-part epoxy cured for two hours, per one or more embodiments herein;

FIG. 6A is a chart of cure time vs. conductivity for an exemplary first conductive two-part epoxy cured at a temperature of about 150° C., per one or more embodiments herein; and

FIG. 6B is a chart of cure time vs. conductivity for an exemplary fifth conductive two-part epoxy cured at a temperature of about 23° C., per one or more embodiments herein.

FIG. 7 shows differential scanning calorimetry (DSC) and thermogravimetric analysis (TGA) thermograms of the first exemplary one-part epoxy.

FIG. 8 shows DSC and TGA thermograms of the eighth exemplary one-part epoxy.

FIG. 9 shows the dynamic mechanical analysis of the first exemplary one-part epoxy.

FIG. 10 shows the dynamic mechanical analysis of the eighth exemplary one-part epoxy.

FIG. 11 shows a comparison of the electrical conductivity of exemplary one-part epoxies 1-10.

FIG. 12 shows a comparison of the thermal conductivity of exemplary one-part epoxies 1-10.

FIG. 13 shows a comparison of the lap shear strength of exemplary one-part epoxies 1-10.

FIG. 14 shows DSC and TGA thermograms of the first exemplary two-part epoxy.

FIG. 15 shows DSC and TGA thermograms of the fifth exemplary two-part epoxy.

FIG. 16 shows a viscosity curve and stress curve of the first exemplary two-part epoxy.

FIG. 17 shows a comparison of the electrical conductivity of exemplary two-part epoxies.

FIG. 18 shows a comparison of the lap shear strength of exemplary two-part epoxies.

FIG. 19 shows a comparison of the thermal conductivity of exemplary two-part epoxies.

### DETAILED DESCRIPTION

It is appreciated by the inventors of the instant application that soldering as a means of electrical bonding presents a number of performance and safety risks. The use of lead-tin solder as a bonding material for electronic components has the potential for lead poisoning, and is subject to regulation as industrial electronic waste. Further, soldering produces bonds which are typically softer and weaker than the other bonds in the device in which they are situated, and are prone to failure. While various epoxy-based adhesive alternatives are available in the market, many form brittle bonds with dissimilar substrates. As such, electrical components coupled with such inflexible adhesives often fail under mechanical shock or vibration. Devices such as calculators, telephones, and laptop computers have components that are surface mounted onto wiring boards with narrow bond thicknesses, which creates a bond when using rigid epoxy that is too weak and/or too rigid to withstand drops and minor impacts. Further, many such conductive adhesive formulations, which have attempted to address these issues produce a bond with poor electrical conductivity or poor thermal stability, which renders the conductive adhesive unsuitable for use in an electronic device.

Further, current conductive adhesives often require high concentrations by weight of non-flake silver powders (e.g., irregularly shaped silver powders, spherical silver powders) of at least about 85% and still exhibit a drop resistance of less than that of lead-tin solder. Further, given such high silver content, such adhesives are often too viscous for application by, for example, screen-printing.

As such, there is a current unmet need for conductive epoxies for securely bonding electrical components that exhibit a high strength, improved electrical and thermal conductivity, which is suitable for applications such as screen-printing. The conductive adhesives and methods of forming thereof herein employ conductive graphene and silver with a diluent (e.g., a low viscosity, low volatility liquid hydrocarbon resins) to form bonds with increasing flexibility, crack resistance, fatigue resistance, impact resistance, tensile strength, and peel resistance, and which can be manufactured at high speed and reduced cost. The diluent can improve the adhesion, chemical resistance, water resistance, and corrosion resistance of the conductive epoxies. The conductive graphene and silver-filled epoxies herein can be used for drawing conducting lines and mounting electronic components, wherein the synergistic coupling between the graphene and silver within the conductive epoxies increases the strength and conductivity of films formed therefrom, permitting such improved mechanical and electrical performance to be realized even when applied in very thin layers or when applied by screen printing. Exemplary epoxies formed using the methods described herein may have viscosities in the range of 10 Pa*s at shear rate 1 (1/s) to 510 Pa*s at shear rate 1 (1/s) at room temperature and thixotropic index in the range of 3.0 to 6, and may be suitable for screen printing; very high electrical conductivities in the range of 500 S/cm to 50,000 S/cm and very low volume resistivities in the range of 10\hat{ }−3 ohm*cm to 10\hat{ }−6 ohm*cm at room temperature suitable for use in high quality electronic devices; tensile strength up to about 17 MPa (˜2490 psi) suitable for formation of electrical bonds which are unlikely to fail under mechanical shock, strain, or load; and thermal conductivity in the range of 3.0 W/m*K to 15.0 W/m*K at room temperature suitable for formation of electrical bonds which must be thermally conductive, for example, in devices that need to be able to dissipate heat to maintain safe or optimal operating temperatures.

### Conductive Epoxies and Adhesives

Disclosed herein are one-part and two-part conductive epoxy and adhesive formulations.

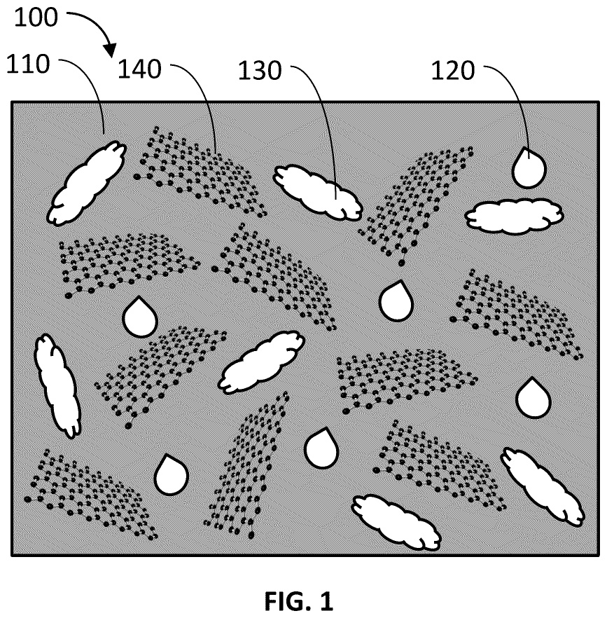

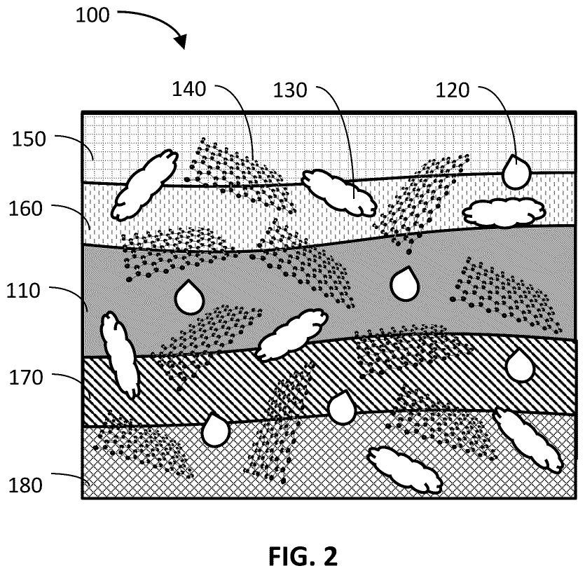

Provided herein are one-part conductive epoxy and adhesive formulations (per FIGS. 1-2). In some embodiments, the conductive epoxy 100 comprises an epoxy resin 110, a diluent 120, silver 130, and graphene 140, as in FIG. 1. In some embodiments, per FIG. 2, the conductive epoxy 100 further comprises a solvent 150, an ionic liquid 160, a curing agent 170, a strength additive 180, or any combination thereof.

The 1-part conductive epoxy can include: (a) a solvent; (b) an ionic liquid; (c) a curing agent; (d) a strength additive; or (e) any combination thereof. In some embodiments, the solvent comprises methyl ethyl ketone, benzyl alcohol, or both. In some embodiments, the ionic liquid comprises tributyl(ethyl) phosphonium diethyl phosphate, trihexyl(tetradecyl) phosphonium bis 2,4,4-(trimethyl pentyl)-phosphinate, or both. In some embodiments, the curing agent comprises dicyandiamide, a modified amine, organic acid hydrazide, tertiary amine imidazole, a boron trifluoride amine complex, or any combination thereof. In some embodiments, the strength additive comprises neopentyl glycol, butadiene-acrylonitrile, or both. In some embodiments, the strength additive comprises the neopentyl glycol, wherein the neopentyl glycol comprises an epoxidized neopentyl glycol adduct. In some embodiments, the strength additive comprises the butadiene-acrylonitrile, wherein the butadiene-acrylonitrile comprises an amine-terminated butadiene-acrylonitrile copolymer.

The 1-part conductive epoxy can comprise one or more epoxy resins or combinations of different epoxy resins and latent hardeners. Multifunctional epoxies include different commercially available epoxy resins such as resorcinol diglycidyl ether epoxy resin, cycloaliphatic epoxy resin, diglycidyl ether of Bisphenol A, diglycidyl ether of Bisphenol F, blend of diglycidyl ether of Bisphenol A & F, etc. The latent curing agents for 1-part conductive epoxy formulations may comprise boron trifluoride amine complexes, dicyandiamide, organic acid hydrazide, modified polyamine, tertiary amine imidazole, etc. Commercially available latent curing agents from Evonik, such as Ancamine 2441 and Dicyanex 1400B, and combinations of them may be used for this formulation. Commercially available epoxy resins diglycidyl ether of Bisphenol A (Devcon Epoxy A), Epon Resin 828 from Hexion, Epon Resin 862 from Hexion, Epikote Resin 240 from Westlake, can be thoroughly mixed with an appropriate amount of latent curing agent and accelerator to form the one-part epoxy formulations. The commercially available epoxy resin H61-110 from Epoxy Technology may include a latent curing agent and catalyst. Commercially available ionic liquid tributyl(ethyl) phosphonium diethyl phosphate (Cyphos IL169) and trihexyl (tetradecyl) phosphonium bis 2,4,4-(trimethyl pentyl)-phosphinate (Cyphos IL104, 0.5%-2.0% by mass may be suitable for this formulation. Chemically inert diluent (Epodil LV5) from Evonik can be included in the formulation to balance the stoichiometry and control the viscosity of the formula. CTBN-Toughened Epoxidized Neopentyl Glycol Adduct (HYPOX RM20) from Huntsman has a lower viscosity additive coupled with a high rubber content, which improves the properties of epoxy, as the end-use application may require toughening and lower viscosity.

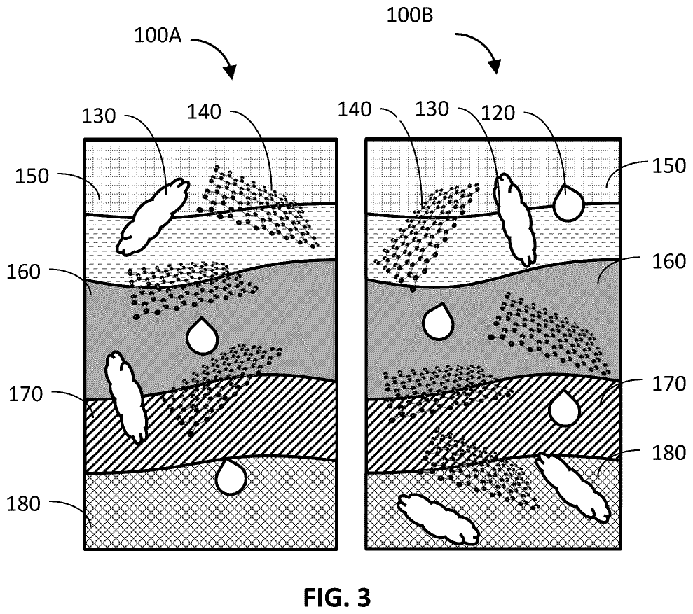

Also provided herein are two-part conductive epoxy and adhesive formulations per FIG. 3, the conductive epoxy 100 has a first part 100A and a second part 100B. In some embodiments, mixing the first part 100A and the second part 100B forms the conductive epoxy 100. In some embodiments, the first part 100A and the second part 100B both comprise the diluent 120. In some embodiments, the first part 100A comprises the epoxy resin 110. In some embodiments, the second part 100B comprises the curing agent 170. In some embodiments, the conductive epoxy has a first part and a second part, wherein mixing the first part and the second part forms the conductive epoxy. In some embodiments, the first part and the second part both comprise the diluent. In some embodiments, the first part comprises the epoxy resin. In some embodiments, the second part comprises the curing agent. The 2-part conductive epoxy formulation can include a curing agent comprising a modified amine, modified amine comprises a modified polyamine, modified cycloaliphatic polyamine, modified aliphatic amine, phenalkamine-based modified polyamine, or any combination thereof. In some embodiments, the strength additive in the 2-part conductive epoxy formulation comprises neopentyl glycol, butadiene-acrylonitrile, or both.

In the two-part conductive epoxy adhesives, the first part (e.g., part A) can comprise one or more liquid epoxy resins. Multifunctional epoxies include different combinations of commercially available epoxy resins such as diglycidyl ether of Bisphenol A, diglycidyl ether of Bisphenol F, blend of diglycidyl ether of Bisphenol A & F, etc.

The room temperature epoxy curing agents for the second part (e.g., part B) formulation may comprise polyamines and modified polyamines. Commercially available curing agents from Evonik such as Ancamine 1618, Ancimine 2914UF, Sunmide CX 1151 and combinations of and Epicure 580 from Hexion may be used for these formulations. Commercially available epoxy resins, diglycidyl ether of Bisphenol A (Devcon Epoxy A), Epikote Resin 240 from Westlake can be thoroughly mixed with an appropriate volume of diluents and conductive fillers. Both reactive diluent (Epodil 746) and chemically inert diluent (Epodil LV5) from Evonik can be comprised in the formulation to balance the stoichiometry and control the viscosity of the part A and part B formula. CTBN-Toughened Epoxidized Neopentyl Glycol Adduct (HYPOX RM20) from Huntsman has a lower viscosity additive coupled with high rubber content which can optimize the mechanical properties of part A. Relatively high viscosity additive Hypro 1300X16 ATBN form Huntsman can be added to part B. The non-reactive diluent, having relatively low viscosity long-chain hydrocarbon may serve an important role to reduce the brittle nature of the conductive adhesive by decreasing the cross-link density in the final composition of the electrically conductive adhesive by acting as a plasticizer with lubricating properties, and significantly improves the solid filler loading. The ultra-graphene (high surface area) and thermoplastic elastomers or CTBN or ATBN-toughened adducts in conductive silver/epoxy compositions are responsible for further enhancing the thermal shock resistance and mechanical strength of the cured articles produced from said compositions. High surface area of the graphene, along with CTBN-toughened epoxidized adduct for part A and an amine-terminated butadiene-acrylonitrile copolymer for part B, was employed before the loading of the metal particles to improve adhesive strength and thermal shock resistance. Both CTBN and ATBN toughen adducts, along with graphene, are found useful to improve the toughness, flexibility, adhesion, and impact resistance of two-part epoxy resin systems.

### Resin

In some embodiments of one-part epoxy formulations, the epoxy resin comprises a resorcinol diglycidyl ether Epoxy Resin, Cycloaliphatic Epoxy Resin, diglycidyl ether of Bisphenol A, diglycidyl ether of Bisphenol F, a blend of diglycidyl ether of Bisphenol A & F, or any combination thereof. The specific resins and their concentrations herein enable the homogeneous distribution of the graphene and silver throughout the epoxies herein, while maintaining a viscosity and thixotropic index suitable for a broad range of application methods of forming cured products with high lap shear stress and storage modulus.

In some embodiments of one-part epoxy formulations, the epoxy resin is comprised in an amount of about 3% (wt.) to about 12% (wt.). In some embodiments of one-part epoxy formulations, the epoxy resin is comprised in an amount of about 3% (wt.) to about 4% (wt.), about 3% (wt.) to about 4.8% (wt.), about 3% (wt.) to about 4.8% (wt.), about 3% (wt.) to about 5% (wt.), about 3% (wt.) to about 6% (wt.), about 3% (wt.) to about 7% (wt.), about 3% (wt.) to about 8% (wt.), about 3% (wt.) to about 9% (wt.), about 3% (wt.) to about 9.6% (wt.), about 3% (wt.) to about 10% (wt.), about 3% (wt.) to about 12% (wt.), about 4% (wt.) to about 4.8% (wt.), about 4% (wt.) to about 4.8% (wt.), about 4% (wt.) to about 5% (wt.), about 4% (wt.) to about 6% (wt.), about 4% (wt.) to about 7% (wt.), about 4% (wt.) to about 8% (wt.), about 4% (wt.) to about 9% (wt.), about 4% (wt.) to about 9.6% (wt.), about 4% (wt.) to about 10% (wt.), about 4% (wt.) to about 12% (wt.), about 4.8% (wt.) to about 4.8% (wt.), about 4.8% (wt.) to about 5% (wt.), about 4.8% (wt.) to about 6% (wt.), about 4.8% (wt.) to about 7% (wt.), about 4.8% (wt.) to about 8% (wt.), about 4.8% (wt.) to about 9% (wt.), about 4.8% (wt.) to about 9.6% (wt.), about 4.8% (wt.) to about 10% (wt.), about 4.8% (wt.) to about 12% (wt.), about 4.8% (wt.) to about 5% (wt.), about 4.8% (wt.) to about 6% (wt.), about 4.8% (wt.) to about 7% (wt.), about 4.8% (wt.) to about 8% (wt.), about 4.8% (wt.) to about 9% (wt.), about 4.8% (wt.) to about 9.6% (wt.), about 4.8% (wt.) to about 10% (wt.), about 4.8% (wt.) to about 12% (wt.), about 5% (wt.) to about 6% (wt.), about 5% (wt.) to about 7% (wt.), about 5% (wt.) to about 8% (wt.), about 5% (wt.) to about 9% (wt.), about 5% (wt.) to about 9.6% (wt.), about 5% (wt.) to about 10% (wt.), about 5% (wt.) to about 12% (wt.), about 6% (wt.) to about 7% (wt.), about 6% (wt.) to about 8% (wt.), about 6% (wt.) to about 9% (wt.), about 6% (wt.) to about 9.6% (wt.), about 6% (wt.) to about 10% (wt.), about 6% (wt.) to about 12% (wt.), about 7% (wt.) to about 8% (wt.), about 7% (wt.) to about 9% (wt.), about 7% (wt.) to about 9.6% (wt.), about 7% (wt.) to about 10% (wt.), about 7% (wt.) to about 12% (wt.), about 8% (wt.) to about 9% (wt.), about 8% (wt.) to about 9.6% (wt.), about 8% (wt.) to about 10% (wt.), about 8% (wt.) to about 12% (wt.), about 9% (wt.) to about 9.6% (wt.), about 9% (wt.) to about 10% (wt.), about 9% (wt.) to about 12% (wt.), about 9.6% (wt.) to about 10% (wt.), about 9.6% (wt.) to about 12% (wt.), or about 10% (wt.) to about 12% (wt.), including increments therein. In some embodiments of one-part epoxy formulations, the epoxy resin is comprised in an amount of about 3% (wt.), about 4% (wt.), about 4.8% (wt.), about 4.8% (wt.), about 5% (wt.), about 6% (wt.), about 7% (wt.), about 8% (wt.), about 9% (wt.), about 9.6% (wt.), about 10% (wt.), or about 12% (wt.). In some embodiments of one-part epoxy formulations, the epoxy resin is comprised in an amount of at least about 3% (wt.), about 4% (wt.), about 4.8% (wt.), about 4.8% (wt.), about 5% (wt.), about 6% (wt.), about 7% (wt.), about 8% (wt.), about 9% (wt.), about 9.6% (wt.), or about 10% (wt.). In some embodiments of one-part epoxy formulations, the epoxy resin is comprised in an amount of at most about 4% (wt.), about 4.8% (wt.), about 4.8% (wt.), about 5% (wt.), about 6% (wt.), about 7% (wt.), about 8% (wt.), about 9% (wt.), about 9.6% (wt.), about 10% (wt.), or about 12% (wt.).

In some embodiments of two-part epoxy formulations, the epoxy resin comprises a diglycidyl ether of Bisphenol A, diglycidyl ether of Bisphenol F, a blend of diglycidyl ether of Bisphenol A & F, or any combination thereof. The specific resins and their concentrations herein enable the homogeneous distribution of the graphene and silver throughout the epoxies herein, while maintaining a viscosity and thixotropic index suitable for a broad range of application methods of forming cured products with high lap shear stress and storage modulus.

In some embodiments of two-part epoxy formulations, the epoxy resin is comprised in an amount of about 5% (wt.) to about 20% (wt.). In some embodiments of two-part epoxy formulations, the epoxy resin is comprised in an amount of about 5% (wt.) to about 8% (wt.), about 5% (wt.) to about 8.66% (wt.), about 5% (wt.) to about 10% (wt.), about 5% (wt.) to about 10.65% (wt.), about 5% (wt.) to about 11% (wt.), about 5% (wt.) to about 11.5% (wt.), about 5% (wt.) to about 12% (wt.), about 5% (wt.) to about 12.21% (wt.), about 5% (wt.) to about 15% (wt.), about 5% (wt.) to about 18.2% (wt.), about 5% (wt.) to about 20% (wt.), about 8% (wt.) to about 8.66% (wt.), about 8% (wt.) to about 10% (wt.), about 8% (wt.) to about 10.65% (wt.), about 8% (wt.) to about 11% (wt.), about 8% (wt.) to about 11.5% (wt.), about 8% (wt.) to about 12% (wt.), about 8% (wt.) to about 12.21% (wt.), about 8% (wt.) to about 15% (wt.), about 8% (wt.) to about 18.2% (wt.), about 8% (wt.) to about 20% (wt.), about 8.66% (wt.) to about 10% (wt.), about 8.66% (wt.) to about 10.65% (wt.), about 8.66% (wt.) to about 11% (wt.), about 8.66% (wt.) to about 11.5% (wt.), about 8.66% (wt.) to about 12% (wt.), about 8.66% (wt.) to about 12.21% (wt.), about 8.66% (wt.) to about 15% (wt.), about 8.66% (wt.) to about 18.2% (wt.), about 8.66% (wt.) to about 20% (wt.), about 10% (wt.) to about 10.65% (wt.), about 10% (wt.) to about 11% (wt.), about 10% (wt.) to about 11.5% (wt.), about 10% (wt.) to about 12% (wt.), about 10% (wt.) to about 12.21% (wt.), about 10% (wt.) to about 15% (wt.), about 10% (wt.) to about 18.2% (wt.), about 10% (wt.) to about 20% (wt.), about 10.65% (wt.) to about 11% (wt.), about 10.65% (wt.) to about 11.5% (wt.), about 10.65% (wt.) to about 12% (wt.), about 10.65% (wt.) to about 12.21% (wt.), about 10.65% (wt.) to about 15% (wt.), about 10.65% (wt.) to about 18.2% (wt.), about 10.65% (wt.) to about 20% (wt.), about 11% (wt.) to about 11.5% (wt.), about 11% (wt.) to about 12% (wt.), about 11% (wt.) to about 12.21% (wt.), about 11% (wt.) to about 15% (wt.), about 11% (wt.) to about 18.2% (wt.), about 11% (wt.) to about 20% (wt.), about 11.5% (wt.) to about 12% (wt.), about 11.5% (wt.) to about 12.21% (wt.), about 11.5% (wt.) to about 15% (wt.), about 11.5% (wt.) to about 18.2% (wt.), about 11.5% (wt.) to about 20% (wt.), about 12% (wt.) to about 12.21% (wt.), about 12% (wt.) to about 15% (wt.), about 12% (wt.) to about 18.2% (wt.), about 12% (wt.) to about 20% (wt.), about 12.21% (wt.) to about 15% (wt.), about 12.21% (wt.) to about 18.2% (wt.), about 12.21% (wt.) to about 20% (wt.), about 15% (wt.) to about 18.2% (wt.), about 15% (wt.) to about 20% (wt.), or about 18.2% (wt.) to about 20% (wt.), including increments therein. In some embodiments of two-part epoxy formulations, the epoxy resin is comprised in an amount of about 5% (wt.), about 8% (wt.), about 8.66% (wt.), about 10% (wt.), about 10.65% (wt.), about 11% (wt.), about 11.5% (wt.), about 12% (wt.), about 12.21% (wt.), about 15% (wt.), about 18.2% (wt.), or about 20% (wt.). In some embodiments of two-part epoxy formulations, the epoxy resin is comprised in an amount of at least about 5% (wt.), about 8% (wt.), about 8.66% (wt.), about 10% (wt.), about 10.65% (wt.), about 11% (wt.), about 11.5% (wt.), about 12% (wt.), about 12.21% (wt.), about 15% (wt.), or about 18.2% (wt.). In some embodiments of two-part epoxy formulations, the epoxy resin is comprised in an amount of at most about 8% (wt.), about 8.66% (wt.), about 10% (wt.), about 10.65% (wt.), about 11% (wt.), about 11.5% (wt.), about 12% (wt.), about 12.21% (wt.), about 15% (wt.), about 18.2% (wt.), or about 20% (wt.).

### Diluent

In some embodiments, the diluent comprises a liquid hydrocarbon resin. In some embodiments, at least a portion of the diluent is non-reactive. In some embodiments, at least a portion of the diluent is reactive. In some embodiments, the diluent is compatible with the epoxy resins and/or hardeners herein (including latent hardeners). The specific diluents and their concentrations within the conductive epoxies herein prevent agglomeration of graphene during formation, storage, and application. The specific diluents and their concentrations within the conductive epoxies herein further enable increased mass loading of metal microparticles for improved conductivity. The specific diluents and their concentrations within the conductive epoxies herein also balance the stoichiometry of the epoxies herein to maintain a set solid loading/viscosity relationship. The specific non-reactive long-chain diluents and their concentrations within the conductive epoxies herein lubricate the conductive epoxy to reduce brittleness and increase flexibility, strength, and uniformity. The specific diluents and their concentrations within the conductive epoxies herein further prevent agglomeration of exfoliated graphene layer(s) through chemisorption on the sheets' surfaces. The specific diluents and their concentrations herein enable the homogeneous distribution of the graphene and silver throughout the epoxies herein, while maintaining a viscosity and thixotropic index suitable for a broad range of application methods of forming cured products with high lap shear stress and storage modulus. In some embodiments, the diluent comprises a liquid hydrocarbon resin from the glycidyl ether family. In some embodiments, the diluent comprises a liquid hydrocarbon resin from the glycidyl ether family having a linear carbon chain with at least one carbon ring in the chain. In some embodiments, the diluent comprises a liquid hydrocarbon resin from the glycidyl ether family having at least 10 carbons. In some embodiments, the diluent comprises a liquid hydrocarbon resin from the glycidyl ether family having 10 to 20 carbons. In some embodiments, the diluent comprises a liquid hydrocarbon resin from the glycidyl ether family having about 14 carbons, or 4,4′-dimethyl-2,2-diphenylpropane. In some embodiments, the diluent comprises a liquid hydrocarbon resin from the glycidyl ether family having a molecular weight of at least 200 g/mol. In some embodiments, the diluent comprises a liquid hydrocarbon resin from the glycidyl ether family having a molecular weight of 200-300 g/mol. In some embodiments, the diluent comprises a liquid hydrocarbon resin from the glycidyl ether family having a molecular weight of less than 300 g/mol. In some embodiments, the diluent comprises a liquid hydrocarbon resin from the glycidyl ether family having a molecular weight of about 224 g/mol.

In some embodiments of one-part epoxy formulations, a non-reactive diluent is utilized, and the non-reactive diluent is a liquid hydrocarbon resin. In some embodiments, the non-reactive diluent comprises a liquid hydrocarbon resin from the glycidyl ether family. In some embodiments, the non-reactive diluent comprises a liquid hydrocarbon resin from the glycidyl ether family having a linear carbon chain with at least one carbon ring in the chain. In some embodiments, the non-reactive diluent comprises a liquid hydrocarbon resin from the glycidyl ether family having at least 10 carbons. In some embodiments, the non-reactive diluent comprises a liquid hydrocarbon resin from the glycidyl ether family having 10 to 20 carbons. In some embodiments, the non-reactive diluent comprises a liquid hydrocarbon resin from the glycidyl ether family having about 14 carbons, or 4,4′-dimethyl-2,2-diphenylpropane. In some embodiments, the non-reactive diluent comprises a liquid hydrocarbon resin from the glycidyl ether family having a molecular weight of at least 200 g/mol. In some embodiments, the non-reactive diluent comprises a liquid hydrocarbon resin from the glycidyl ether family having a molecular weight of 200-300 g/mol. In some embodiments, the non-reactive diluent comprises a liquid hydrocarbon resin from the glycidyl ether family having a molecular weight of less than 300 g/mol. In some embodiments, the non-reactive diluent comprises a liquid hydrocarbon resin from the glycidyl ether family having a molecular weight of about 224 g/mol. In some embodiments of one-part epoxy formulations, the diluent is comprised in an amount of about 1% (wt.) to about 15% (wt.). In some embodiments of one-part epoxy formulations, the diluent is comprised in an amount of about 1% (wt.) to about 2% (wt.), about 1% (wt.) to about 2.8% (wt.), about 1% (wt.) to about 4% (wt.), about 1% (wt.) to about 5% (wt.), about 1% (wt.) to about 7% (wt.), about 1% (wt.) to about 8% (wt.), about 1% (wt.) to about 9% (wt.), about 1% (wt.) to about 9.7% (wt.), about 1% (wt.) to about 11% (wt.), about 1% (wt.) to about 11.86% (wt.), about 1% (wt.) to about 15% (wt.), about 2% (wt.) to about 2.8% (wt.), about 2% (wt.) to about 4% (wt.), about 2% (wt.) to about 5% (wt.), about 2% (wt.) to about 7% (wt.), about 2% (wt.) to about 8% (wt.), about 2% (wt.) to about 9% (wt.), about 2% (wt.) to about 9.7% (wt.), about 2% (wt.) to about 11% (wt.), about 2% (wt.) to about 11.86% (wt.), about 2% (wt.) to about 15% (wt.), about 2.8% (wt.) to about 4% (wt.), about 2.8% (wt.) to about 5% (wt.), about 2.8% (wt.) to about 7% (wt.), about 2.8% (wt.) to about 8% (wt.), about 2.8% (wt.) to about 9% (wt.), about 2.8% (wt.) to about 9.7% (wt.), about 2.8% (wt.) to about 11% (wt.), about 2.8% (wt.) to about 11.86% (wt.), about 2.8% (wt.) to about 15% (wt.), about 4% (wt.) to about 5% (wt.), about 4% (wt.) to about 7% (wt.), about 4% (wt.) to about 8% (wt.), about 4% (wt.) to about 9% (wt.), about 4% (wt.) to about 9.7% (wt.), about 4% (wt.) to about 11% (wt.), about 4% (wt.) to about 11.86% (wt.), about 4% (wt.) to about 15% (wt.), about 5% (wt.) to about 7% (wt.), about 5% (wt.) to about 8% (wt.), about 5% (wt.) to about 9% (wt.), about 5% (wt.) to about 9.7% (wt.), about 5% (wt.) to about 11% (wt.), about 5% (wt.) to about 11.86% (wt.), about 5% (wt.) to about 15% (wt.), about 7% (wt.) to about 8% (wt.), about 7% (wt.) to about 9% (wt.), about 7% (wt.) to about 9.7% (wt.), about 7% (wt.) to about 11% (wt.), about 7% (wt.) to about 11.86% (wt.), about 7% (wt.) to about 15% (wt.), about 8% (wt.) to about 9% (wt.), about 8% (wt.) to about 9.7% (wt.), about 8% (wt.) to about 11% (wt.), about 8% (wt.) to about 11.86% (wt.), about 8% (wt.) to about 15% (wt.), about 9% (wt.) to about 9.7% (wt.), about 9% (wt.) to about 11% (wt.), about 9% (wt.) to about 11.86% (wt.), about 9% (wt.) to about 15% (wt.), about 9.7% (wt.) to about 11% (wt.), about 9.7% (wt.) to about 11.86% (wt.), about 9.7% (wt.) to about 15% (wt.), about 11% (wt.) to about 11.86% (wt.), about 11% (wt.) to about 15% (wt.), or about 11.86% (wt.) to about 15% (wt.), including increments therein. In some embodiments of one-part epoxy formulations, the diluent is comprised in an amount of about 1% (wt.), about 2% (wt.), about 2.8% (wt.), about 4% (wt.), about 5% (wt.), about 7% (wt.), about 8% (wt.), about 9% (wt.), about 9.7% (wt.), about 11% (wt.), about 11.86% (wt.), or about 15% (wt.). In some embodiments of one-part epoxy formulations, the diluent is comprised in an amount of at least about 1% (wt.), about 2% (wt.), about 2.8% (wt.), about 4% (wt.), about 5% (wt.), about 7% (wt.), about 8% (wt.), about 9% (wt.), about 9.7% (wt.), about 11% (wt.), or about 11.86% (wt.). In some embodiments of one-part epoxy formulations, the diluent is comprised in an amount of at most about 2% (wt.), about 2.8% (wt.), about 4% (wt.), about 5% (wt.), about 7% (wt.), about 8% (wt.), about 9% (wt.), about 9.7% (wt.), about 11% (wt.), about 11.86% (wt.), or about 15% (wt.).

In some embodiments, the non-reactive diluent comprises the compound of Formula I. The compound of Formula I comprises a chemical formula of C₁₇H₂₀, is referred to under IUPAC convention as 4,4′-dimethyl-2,2-diphenylpropane, and is represented by the structure below.

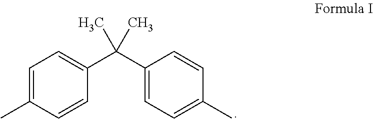

In some embodiments of two-part epoxy formulations, a reactive diluent is utilized. In some embodiments, the reactive diluent is 2-ethylhexyl glycidyl ether (EHGE). In some embodiments, the reactive diluent is comprised in an amount of about 0% (wt.) to about 5% (wt.). In some embodiments of two-part epoxy formulations, the reactive diluent is comprised in an amount of about 0% (wt.) to about 0.5% (wt.), about 0% (wt.) to about 1% (wt.), about 0% (wt.) to about 1.08% (wt.), about 0% (wt.) to about 1.31% (wt.), about 0% (wt.) to about 1.35% (wt.), about 0% (wt.) to about 2% (wt.), about 0% (wt.) to about 2.5% (wt.), about 0% (wt.) to about 3% (wt.), about 0% (wt.) to about 3.5% (wt.), about 0% (wt.) to about 4% (wt.), about 0% (wt.) to about 5% (wt.), about 0.5% (wt.) to about 1% (wt.), about 0.5% (wt.) to about 1.08% (wt.), about 0.5% (wt.) to about 1.31% (wt.), about 0.5% (wt.) to about 1.35% (wt.), about 0.5% (wt.) to about 2% (wt.), about 0.5% (wt.) to about 2.5% (wt.), about 0.5% (wt.) to about 3% (wt.), about 0.5% (wt.) to about 3.5% (wt.), about 0.5% (wt.) to about 4% (wt.), about 0.5% (wt.) to about 5% (wt.), about 1% (wt.) to about 1.08% (wt.), about 1% (wt.) to about 1.31% (wt.), about 1% (wt.) to about 1.35% (wt.), about 1% (wt.) to about 2% (wt.), about 1% (wt.) to about 2.5% (wt.), about 1% (wt.) to about 3% (wt.), about 1% (wt.) to about 3.5% (wt.), about 1% (wt.) to about 4% (wt.), about 1% (wt.) to about 5% (wt.), about 1.08% (wt.) to about 1.31% (wt.), about 1.08% (wt.) to about 1.35% (wt.), about 1.08% (wt.) to about 2% (wt.), about 1.08% (wt.) to about 2.5% (wt.), about 1.08% (wt.) to about 3% (wt.), about 1.08% (wt.) to about 3.5% (wt.), about 1.08% (wt.) to about 4% (wt.), about 1.08% (wt.) to about 5% (wt.), about 1.31% (wt.) to about 1.35% (wt.), about 1.31% (wt.) to about 2% (wt.), about 1.31% (wt.) to about 2.5% (wt.), about 1.31% (wt.) to about 3% (wt.), about 1.31% (wt.) to about 3.5% (wt.), about 1.31% (wt.) to about 4% (wt.), about 1.31% (wt.) to about 5% (wt.), about 1.35% (wt.) to about 2% (wt.), about 1.35% (wt.) to about 2.5% (wt.), about 1.35% (wt.) to about 3% (wt.), about 1.35% (wt.) to about 3.5% (wt.), about 1.35% (wt.) to about 4% (wt.), about 1.35% (wt.) to about 5% (wt.), about 2% (wt.) to about 2.5% (wt.), about 2% (wt.) to about 3% (wt.), about 2% (wt.) to about 3.5% (wt.), about 2% (wt.) to about 4% (wt.), about 2% (wt.) to about 5% (wt.), about 2.5% (wt.) to about 3% (wt.), about 2.5% (wt.) to about 3.5% (wt.), about 2.5% (wt.) to about 4% (wt.), about 2.5% (wt.) to about 5% (wt.), about 3% (wt.) to about 3.5% (wt.), about 3% (wt.) to about 4% (wt.), about 3% (wt.) to about 5% (wt.), about 3.5% (wt.) to about 4% (wt.), about 3.5% (wt.) to about 5% (wt.), or about 4% (wt.) to about 5% (wt.), including increments therein. In some embodiments of two-part epoxy formulations, the reactive diluent is comprised in an amount of about 0% (wt.), about 0.5% (wt.), about 1% (wt.), about 1.08% (wt.), about 1.31% (wt.), about 1.35% (wt.), about 2% (wt.), about 2.5% (wt.), about 3% (wt.), about 3.5% (wt.), about 4% (wt.), or about 5% (wt.). In some embodiments of two-part epoxy formulations, the reactive diluent is comprised in an amount of at least about 0% (wt.), about 0.5% (wt.), about 1% (wt.), about 1.08% (wt.), about 1.31% (wt.), about 1.35% (wt.), about 2% (wt.), about 2.5% (wt.), about 3% (wt.), about 3.5% (wt.), or about 4% (wt.). In some embodiments of two-part epoxy formulations, the reactive diluent is comprised in an amount of at most about 0.5% (wt.), about 1% (wt.), about 1.08% (wt.), about 1.31% (wt.), about 1.35% (wt.), about 2% (wt.), about 2.5% (wt.), about 3% (wt.), about 3.5% (wt.), about 4% (wt.), or about 5% (wt.).

In some embodiments, of two-part epoxy formulations, a non-reactive diluent is utilized, and the non-reactive diluent is a liquid hydrocarbon resin. In some embodiments of two-part epoxy formulations, the non-reactive diluent is comprised in an amount of about 3% (wt.) to about 15% (wt.). In some embodiments of two-part epoxy formulations, the non-reactive diluent is comprised in an amount of about 3% (wt.) to about 3.43% (wt.), about 3% (wt.) to about 5% (wt.), about 3% (wt.) to about 6.1% (wt.), about 3% (wt.) to about 6.3% (wt.), about 3% (wt.) to about 8.85% (wt.), about 3% (wt.) to about 9% (wt.), about 3% (wt.) to about 9.4% (wt.), about 3% (wt.) to about 9.85% (wt.), about 3% (wt.) to about 11% (wt.), about 3% (wt.) to about 13% (wt.), about 3% (wt.) to about 15% (wt.), about 3.43% (wt.) to about 5% (wt.), about 3.43% (wt.) to about 6.1% (wt.), about 3.43% (wt.) to about 6.3% (wt.), about 3.43% (wt.) to about 8.85% (wt.), about 3.43% (wt.) to about 9% (wt.), about 3.43% (wt.) to about 9.4% (wt.), about 3.43% (wt.) to about 9.85% (wt.), about 3.43% (wt.) to about 11% (wt.), about 3.43% (wt.) to about 13% (wt.), about 3.43% (wt.) to about 15% (wt.), about 5% (wt.) to about 6.1% (wt.), about 5% (wt.) to about 6.3% (wt.), about 5% (wt.) to about 8.85% (wt.), about 5% (wt.) to about 9% (wt.), about 5% (wt.) to about 9.4% (wt.), about 5% (wt.) to about 9.85% (wt.), about 5% (wt.) to about 11% (wt.), about 5% (wt.) to about 13% (wt.), about 5% (wt.) to about 15% (wt.), about 6.1% (wt.) to about 6.3% (wt.), about 6.1% (wt.) to about 8.85% (wt.), about 6.1% (wt.) to about 9% (wt.), about 6.1% (wt.) to about 9.4% (wt.), about 6.1% (wt.) to about 9.85% (wt.), about 6.1% (wt.) to about 11% (wt.), about 6.1% (wt.) to about 13% (wt.), about 6.1% (wt.) to about 15% (wt.), about 6.3% (wt.) to about 8.85% (wt.), about 6.3% (wt.) to about 9% (wt.), about 6.3% (wt.) to about 9.4% (wt.), about 6.3% (wt.) to about 9.85% (wt.), about 6.3% (wt.) to about 11% (wt.), about 6.3% (wt.) to about 13% (wt.), about 6.3% (wt.) to about 15% (wt.), about 8.85% (wt.) to about 9% (wt.), about 8.85% (wt.) to about 9.4% (wt.), about 8.85% (wt.) to about 9.85% (wt.), about 8.85% (wt.) to about 11% (wt.), about 8.85% (wt.) to about 13% (wt.), about 8.85% (wt.) to about 15% (wt.), about 9% (wt.) to about 9.4% (wt.), about 9% (wt.) to about 9.85% (wt.), about 9% (wt.) to about 11% (wt.), about 9% (wt.) to about 13% (wt.), about 9% (wt.) to about 15% (wt.), about 9.4% (wt.) to about 9.85% (wt.), about 9.4% (wt.) to about 11% (wt.), about 9.4% (wt.) to about 13% (wt.), about 9.4% (wt.) to about 15% (wt.), about 9.85% (wt.) to about 11% (wt.), about 9.85% (wt.) to about 13% (wt.), about 9.85% (wt.) to about 15% (wt.), about 11% (wt.) to about 13% (wt.), about 11% (wt.) to about 15% (wt.), or about 13% (wt.) to about 15% (wt.), including increments therein. In some embodiments of two-part epoxy formulations, the non-reactive diluent is comprised in an amount of about 3% (wt.), about 3.43% (wt.), about 5% (wt.), about 6.1% (wt.), about 6.3% (wt.), about 8.85% (wt.), about 9% (wt.), about 9.4% (wt.), about 9.85% (wt.), about 11% (wt.), about 13% (wt.), or about 15% (wt.). In some embodiments of two-part epoxy formulations, the non-reactive diluent is comprised in an amount of at least about 3% (wt.), about 3.43% (wt.), about 5% (wt.), about 6.1% (wt.), about 6.3% (wt.), about 8.85% (wt.), about 9% (wt.), about 9.4% (wt.), about 9.85% (wt.), about 11% (wt.), or about 13% (wt.). In some embodiments of two-part epoxy formulations, the non-reactive diluent is comprised in an amount of at most about 3.43% (wt.), about 5% (wt.), about 6.1% (wt.), about 6.3% (wt.), about 8.85% (wt.), about 9% (wt.), about 9.4% (wt.), about 9.85% (wt.), about 11% (wt.), about 13% (wt.), or about 15% (wt.).

### Silver

In some embodiments, the silver comprises silver flakes, colloidal silver nanoparticles, silver nanowires, spherical silver microparticles, silver-coated copper, silver-coated glass powder, silver-coated ceramic powder, or any combination thereof.

The size and morphology of the silver herein enable its homogeneous distribution throughout the epoxies herein, while maintaining a viscosity and thixotropic index suitable for a broad range of application methods. The silver additives and their concentrations enable the formation of dried epoxies with low resistivity and high thermal/electric conductivity. In some embodiments, the silver has a width, a length, or both of about 1 μm to about 30 μm. In some embodiments, the silver has a width, a length, or both of about 1 μm to about 2 μm, about 1 μm to about 5 μm, about 1 μm to about 10 μm, about 1 μm to about 15 μm, about 1 μm to about 20 μm, about 1 μm to about 25 μm, about 1 μm to about 30 μm, about 1 μm to about 35 μm, about 1 μm to about 40 μm, about 1 μm to about 45 μm, about 1 μm to about 50 μm, about 2 μm to about 5 μm, about 2 μm to about 10 μm, about 2 μm to about 15 μm, about 2 μm to about 20 μm, about 2 μm to about 25 μm, about 2 μm to about 30 μm, about 2 μm to about 35 μm, about 2 μm to about 40 μm, about 2 μm to about 45 μm, about 2 μm to about 50 μm, about 5 μm to about 10 μm, about 5 μm to about 15 μm, about 5 μm to about 20 μm, about 5 μm to about 25 μm, about 5 μm to about 30 μm, about 5 μm to about 35 μm, about 5 μm to about 40 μm, about 5 μm to about 45 μm, about 5 μm to about 50 μm, about 10 μm to about 15 μm, about 10 μm to about 20 μm, about 10 μm to about 25 μm, about 10 μm to about 30 μm, about 10 μm to about 35 μm, about 10 μm to about 40 μm, about 10 μm to about 45 μm, about 10 μm to about 50 μm, about 15 μm to about 20 μm, about 15 μm to about 25 μm, about 15 μm to about 30 μm, about 15 μm to about 35 μm, about 15 μm to about 40 μm, about 15 μm to about 45 μm, about 15 μm to about 50 μm, about 20 μm to about 25 μm, about 20 μm to about 30 μm, about 20 μm to about 35 μm, about 20 μm to about 40 μm, about 20 μm to about 45 μm, about 20 μm to about 50 μm, about 25 μm to about 30 μm, about 25 μm to about 35 μm, about 25 μm to about 40 μm, about 25 μm to about 45 μm, about 25 μm to about 50 μm, about 30 μm to about 35 μm, about 30 μm to about 40 μm, about 30 μm to about 45 μm, about 30 μm to about 50 μm, about 35 μm to about 40 μm, about 35 μm to about 45 μm, about 35 μm to about 50 μm, about 40 μm to about 45 μm, about 40 μm to about 50 μm, or about 45 μm to about 50 μm, including increments therein. In some embodiments, the silver has a width, a length, or both of about 1 μm, about 2 μm, about 5 μm, about 10 μm, about 15 μm, about 20 μm, about 25 μm, or about 30 μm.

In some embodiments of one-part epoxy formulations, the Ag flakes comprise an amount of about 35% (wt.) to about 90% (wt.). In some embodiments of one-part epoxy formulations, the Ag flakes are comprised in an amount of about 35% (wt.) to about 38% (wt.), about 35% (wt.) to about 40% (wt.), about 35% (wt.) to about 50% (wt.), about 35% (wt.) to about 61% (wt.), about 35% (wt.) to about 73% (wt.), about 35% (wt.) to about 79% (wt.), about 35% (wt.) to about 84% (wt.), about 35% (wt.) to about 90% (wt.), about 35% (wt.) to about 93% (wt.), about 35% (wt.) to about 95.5% (wt.), about 35% (wt.) to about 99% (wt.), about 38% (wt.) to about 40% (wt.), about 38% (wt.) to about 50% (wt.), about 38% (wt.) to about 61% (wt.), about 38% (wt.) to about 73% (wt.), about 38% (wt.) to about 79% (wt.), about 38% (wt.) to about 84% (wt.), about 38% (wt.) to about 90% (wt.), about 38% (wt.) to about 93% (wt.), about 38% (wt.) to about 95.5% (wt.), about 38% (wt.) to about 99% (wt.), about 40% (wt.) to about 50% (wt.), about 40% (wt.) to about 61% (wt.), about 40% (wt.) to about 73% (wt.), about 40% (wt.) to about 79% (wt.), about 40% (wt.) to about 84% (wt.), about 40% (wt.) to about 90% (wt.), including increments therein. In some embodiments of one-part epoxy formulations, the Ag flakes are comprised in an amount of about 35% (wt.), about 38% (wt.), about 40% (wt.), about 50% (wt.), about 61% (wt.), about 73% (wt.), about 79% (wt.), about 84% (wt.), about 90% (wt.). In some embodiments of one-part epoxy formulations, the Ag flakes are comprised in an amount of at least about 35% (wt.), about 38% (wt.), about 40% (wt.), about 50% (wt.), about 61% (wt.), about 73% (wt.), about 79% (wt.), about 84% (wt.), about 90% (wt.), about 93% (wt.), or about 95.5% (wt.). In some embodiments of one-part epoxy formulations, the Ag flakes are comprised in an amount of at most about 38% (wt.), about 40% (wt.), about 50% (wt.), about 61% (wt.), about 73% (wt.), about 79% (wt.), about 84% (wt.), about 90% (wt.).

In some embodiments of one-part epoxy formulations, the Ag-Cu comprises in an amount of about 40% (wt.) to about 60% (wt.). In some embodiments of one-part epoxy formulations, the Ag-Cu is comprised in an amount of about 40% (wt.) to about 42.5% (wt.), about 40% (wt.) to about 45% (wt.), about 40% (wt.) to about 47% (wt.), about 40% (wt.) to about 47.8% (wt.), about 40% (wt.) to about 48% (wt.), about 40% (wt.) to about 50% (wt.), about 40% (wt.) to about 52.5% (wt.), about 40% (wt.) to about 55% (wt.), about 40% (wt.) to about 57.7% (wt.), about 40% (wt.) to about 60% (wt.), about 42.5% (wt.) to about 45% (wt.), about 42.5% (wt.) to about 47% (wt.), about 42.5% (wt.) to about 47.8% (wt.), about 42.5% (wt.) to about 48% (wt.), about 42.5% (wt.) to about 50% (wt.), about 42.5% (wt.) to about 52.5% (wt.), about 42.5% (wt.) to about 55% (wt.), about 42.5% (wt.) to about 57.7% (wt.), about 42.5% (wt.) to about 60% (wt.), about 45% (wt.) to about 47% (wt.), about 45% (wt.) to about 47.8% (wt.), about 45% (wt.) to about 48% (wt.), about 45% (wt.) to about 50% (wt.), about 45% (wt.) to about 52.5% (wt.), about 45% (wt.) to about 55% (wt.), about 45% (wt.) to about 57.7% (wt.), about 45% (wt.) to about 60% (wt.), about 47% (wt.) to about 47.8% (wt.), about 47% (wt.) to about 48% (wt.), about 47% (wt.) to about 50% (wt.), about 47% (wt.) to about 52.5% (wt.), about 47% (wt.) to about 55% (wt.), about 47% (wt.) to about 57.7% (wt.), about 47% (wt.) to about 60% (wt.), about 47.8% (wt.) to about 48% (wt.), about 47.8% (wt.) to about 50% (wt.), about 47.8% (wt.) to about 52.5% (wt.), about 47.8% (wt.) to about 55% (wt.), about 47.8% (wt.) to about 57.7% (wt.), about 47.8% (wt.) to about 60% (wt.), about 48% (wt.) to about 50% (wt.), about 48% (wt.) to about 52.5% (wt.), about 48% (wt.) to about 55% (wt.), about 48% (wt.) to about 57.7% (wt.), about 48% (wt.) to about 60% (wt.), about 50% (wt.) to about 52.5% (wt.), about 50% (wt.) to about 55% (wt.), about 50% (wt.) to about 57.7% (wt.), about 50% (wt.) to about 60% (wt.), about 52.5% (wt.) to about 55% (wt.), about 52.5% (wt.) to about 57.7% (wt.), about 52.5% (wt.) to about 60% (wt.), about 55% (wt.) to about 57.7% (wt.), about 55% (wt.) to about 60% (wt.), or about 57.7% (wt.) to about 60% (wt.), including increments therein. In some embodiments of one-part epoxy formulations, the Ag-Cu is comprised in an amount of about 40% (wt.), about 42.5% (wt.), about 45% (wt.), about 47% (wt.), about 47.8% (wt.), about 48% (wt.), about 50% (wt.), about 52.5% (wt.), about 55% (wt.), about 57.7% (wt.), or about 60% (wt.). In some embodiments of one-part epoxy formulations, the Ag-Cu is comprised in an amount of at least about 40% (wt.), about 42.5% (wt.), about 45% (wt.), about 47% (wt.), about 47.8% (wt.), about 48% (wt.), about 50% (wt.), about 52.5% (wt.), about 55% (wt.), or about 57.7% (wt.). In some embodiments of one-part epoxy formulations, the Ag-Cu is comprised in an amount of at most about 42.5% (wt.), about 45% (wt.), about 47% (wt.), about 47.8% (wt.), about 48% (wt.), about 50% (wt.), about 52.5% (wt.), about 55% (wt.), about 57.7% (wt.), or about 60% (wt.).

In some embodiments of two-part epoxy formulations, the Ag flakes are comprised in an amount of about 65% (wt.) to about 90% (wt.). In some embodiments of two-part epoxy formulations, the Ag flakes are comprised in an amount of about 65% (wt.) to about 70% (wt.), about 65% (wt.) to about 73% (wt.), about 65% (wt.) to about 75% (wt.), about 65% (wt.) to about 78% (wt.), about 65% (wt.) to about 79% (wt.), about 65% (wt.) to about 80% (wt.), about 65% (wt.) to about 81% (wt.), about 65% (wt.) to about 82.5% (wt.), about 65% (wt.) to about 85% (wt.), about 65% (wt.) to about 87.5% (wt.), about 65% (wt.) to about 90% (wt.), about 70% (wt.) to about 73% (wt.), about 70% (wt.) to about 75% (wt.), about 70% (wt.) to about 78% (wt.), about 70% (wt.) to about 79% (wt.), about 70% (wt.) to about 80% (wt.), about 70% (wt.) to about 81% (wt.), about 70% (wt.) to about 82.5% (wt.), about 70% (wt.) to about 85% (wt.), about 70% (wt.) to about 87.5% (wt.), about 70% (wt.) to about 90% (wt.), about 73% (wt.) to about 75% (wt.), about 73% (wt.) to about 78% (wt.), about 73% (wt.) to about 79% (wt.), about 73% (wt.) to about 80% (wt.), about 73% (wt.) to about 81% (wt.), about 73% (wt.) to about 82.5% (wt.), about 73% (wt.) to about 85% (wt.), about 73% (wt.) to about 87.5% (wt.), about 73% (wt.) to about 90% (wt.), about 75% (wt.) to about 78% (wt.), about 75% (wt.) to about 79% (wt.), about 75% (wt.) to about 80% (wt.), about 75% (wt.) to about 81% (wt.), about 75% (wt.) to about 82.5% (wt.), about 75% (wt.) to about 85% (wt.), about 75% (wt.) to about 87.5% (wt.), about 75% (wt.) to about 90% (wt.), about 78% (wt.) to about 79% (wt.), about 78% (wt.) to about 80% (wt.), about 78% (wt.) to about 81% (wt.), about 78% (wt.) to about 82.5% (wt.), about 78% (wt.) to about 85% (wt.), about 78% (wt.) to about 87.5% (wt.), about 78% (wt.) to about 90% (wt.), about 79% (wt.) to about 80% (wt.), about 79% (wt.) to about 81% (wt.), about 79% (wt.) to about 82.5% (wt.), about 79% (wt.) to about 85% (wt.), about 79% (wt.) to about 87.5% (wt.), about 79% (wt.) to about 90% (wt.), about 80% (wt.) to about 81% (wt.), about 80% (wt.) to about 82.5% (wt.), about 80% (wt.) to about 85% (wt.), about 80% (wt.) to about 87.5% (wt.), about 80% (wt.) to about 90% (wt.), about 81% (wt.) to about 82.5% (wt.), about 81% (wt.) to about 85% (wt.), about 81% (wt.) to about 87.5% (wt.), about 81% (wt.) to about 90% (wt.), about 82.5% (wt.) to about 85% (wt.), about 82.5% (wt.) to about 87.5% (wt.), about 82.5% (wt.) to about 90% (wt.), about 85% (wt.) to about 87.5% (wt.), about 85% (wt.) to about 90% (wt.), or about 87.5% (wt.) to about 90% (wt.), including increments therein. In some embodiments of two-part epoxy formulations, the Ag flakes are comprised in an amount of about 65% (wt.), about 70% (wt.), about 73% (wt.), about 75% (wt.), about 78% (wt.), about 79% (wt.), about 80% (wt.), about 81% (wt.), about 82.5% (wt.), about 85% (wt.), about 87.5% (wt.), or about 90% (wt.). In some embodiments of two-part epoxy formulations, the Ag flakes are comprised in an amount of at least about 65% (wt.), about 70% (wt.), about 73% (wt.), about 75% (wt.), about 78% (wt.), about 79% (wt.), about 80% (wt.), about 81% (wt.), about 82.5% (wt.), about 85% (wt.), or about 87.5% (wt.). In some embodiments of two-part epoxy formulations, the Ag flakes are comprised in an amount of at most about 70% (wt.), about 73% (wt.), about 75% (wt.), about 78% (wt.), about 79% (wt.), about 80% (wt.), about 81% (wt.), about 82.5% (wt.), about 85% (wt.), about 87.5% (wt.), or about 90% (wt.).

### Graphene

Graphene possesses unique strength and hardness as well as high thermal and electrical conductivity. The concentrations and use of graphene in the conductive epoxies herein enable sufficient coverage of the epoxy resin with a continuous electrically conductive network to improve adhesive strength and thermal shock resistance. Further, the concentrations and use of graphene in the conductive epoxies herein prevent the sedimentation/agglomeration of silver flakes therein. Further, the concentrations and use of graphene as a colloidal liquid lubricant dispersing agent in the conductive epoxies herein stabilizes the components within the polymer matrix therein to improve electrical, thermal, and mechanical properties. The size and morphology of the graphene herein enable its homogeneous distribution throughout the epoxies herein, while maintaining a viscosity and thixotropic index suitable for a broad range of application methods. The graphene and its concentrations enable the formation of dried epoxies with low resistivity and high thermal/electric conductivity.

In some embodiments, the thickness of graphene is about 1 nm to 10 nm. In some embodiments, a width, a length or both of graphene are about 1 μm to 10 μm. In some embodiments, the graphene has a thickness about 1 nm to about 2 nm, about 1 nm to about 3 nm, about 1 nm to about 4 nm, about 1 nm to about 5 nm, about 1 nm to about 6 nm, about 1 nm to about 7 nm, about 1 nm to about 8 nm, about 1 nm to about 9 nm, about 1 nm to about 10 nm, about 2 nm to about 3 nm, about 2 nm to about 4 nm, about 2 nm to about 5 nm, about 2 nm to about 6 nm, about 2 nm to about 7 nm, about 2 nm to about 8 nm, about 2 nm to about 9 nm, about 2 nm to about 10 nm, about 3 nm to about 4 nm, about 3 nm to about 5 nm, about 3 nm to about 6 nm, about 3 nm to about 7 nm, about 3 nm to about 8 nm, about 3 nm to about 9 nm, about 3 nm to about 10 nm, about 4 nm to about 5 nm, about 4 nm to about 6 nm, about 4 nm to about 7 nm, about 4 nm to about 8 nm, about 4 nm to about 9 nm, about 4 nm to about 10 nm, about 5 nm to about 6 nm, about 5 nm to about 7 nm, about 5 nm to about 8 nm, about 5 nm to about 9 nm, about 5 nm to about 10 nm, about 6 nm to about 7 nm, about 6 nm to about 8 nm, about 6 nm to about 9 nm, about 6 nm to about 10 nm, about 7 nm to about 8 nm, about 7 nm to about 9 nm, about 7 nm to about 10 nm, about 8 nm to about 9 nm, about 8 nm to about 10 nm, or about 9 nm to about 10 nm, including increments therein. In some embodiments, the graphene has a thickness of about 1 nm, about 2 nm, about 3 nm, about 4 nm, about 5 nm, about 6 nm, about 7 nm, about 8 nm, about 9 nm, or about 10 nm. In some embodiments, the graphene has a width, a length, or both of at least about 1 nm, about 2 nm, about 3 nm, about 4 nm, about 5 nm, about 6 nm, about 7 nm, about 8 nm, or about 9 nm. In some embodiments, the graphene has a width, a length, or both of at most about 2 nm, about 3 nm, about 4 nm, about 5 nm, about 6 nm, about 7 nm, about 8 nm, about 9 nm, or about 10 nm.

In some embodiments, the graphene has a surface area of about 400 m²/g to about 2,000 m²/g. In some embodiments, the graphene has a surface area of about 400 m²/g to about 600 m²/g, about 400 m²/g to about 800 m²/g, about 400 m²/g to about 1,000 m²/g, about 400 m²/g to about 1,200 m²/g, about 400 m²/g to about 1,400 m²/g, about 400 m²/g to about 1,800 m²/g, about 400 m²/g to about 2,000 m²/g, about 600 m²/g to about 800 m²/g, about 600 m²/g to about 1,000 m²/g, about 600 m²/g to about 1,200 m²/g, about 600 m²/g to about 1,400 m²/g, about 600 m²/g to about 1,800 m²/g, about 600 m²/g to about 2,000 m²/g, about 800 m²/g to about 1,000 m²/g, about 800 m²/g to about 1,200 m²/g, about 800 m²/g to about 1,400 m²/g, about 800 m²/g to about 1,800 m²/g, about 800 m²/g to about 2,000 m²/g, about 1,000 m²/g to about 1,200 m²/g, about 1,000 m²/g to about 1,400 m²/g, about 1,000 m²/g to about 1,800 m²/g, about 1,000 m²/g to about 2,000 m²/g, about 1,200 m²/g to about 1,400 m²/g, about 1,200 m²/g to about 1,800 m²/g, about 1,200 m²/g to about 2,000 m²/g, about 1,400 m²/g to about 1,800 m²/g, about 1,400 m²/g to about 2,000 m²/g, or about 1,800 m²/g to about 2,000 m²/g, including increments therein. In some embodiments, the graphene has a surface area of about 400 m²/g, about 600 m²/g, about 800 m²/g, about 1,000 m²/g, about 1,200 m²/g, about 1,400 m²/g, about 1,800 m²/g, or about 2,000 m²/g. In some embodiments, the graphene has a surface area of at least about 400 m²/g, about 600 m²/g, about 800 m²/g, about 1,000 m²/g, about 1,200 m²/g, about 1,400 m²/g, or about 1,800 m²/g. In some embodiments, the graphene has a surface area of at most about 600 m²/g, about 800 m²/g, about 1,000 m²/g, about 1,200 m²/g, about 1,400 m²/g, about 1,800 m²/g, or about 2,000 m²/g.

In some embodiments, the conductive epoxy 100 has a concentration by weight of the graphene 140 of less than about 0.3%, 0.275%, 0.25%, 0.225%, 0.2%, 0.175%, 0.15%, 0.125%, 0.1%, 0.09%, 0.08%, 0.07%, 0.06%, 0.05%, 0.04%, 0.03%, or 0.02%, including increments therein. In some cases, the conductive epoxies 100 herein contain the graphene 140 at concentrations below 0.3%, where the graphene 140 exhibits peak dispersing and reinforcing/strengthening capabilities.

In some embodiments of one-part epoxy formulations, the graphene or ultra-graphene is comprised in an amount of about 0.01% (wt.) to about 0.1% (wt.). In some embodiments of one-part epoxy formulations, the graphene or ultra-graphene is comprised in an amount of about 0.01% (wt.) to about 0.015% (wt.), about 0.01% (wt.) to about 0.017% (wt.), about 0.01% (wt.) to about 0.02% (wt.), about 0.01% (wt.) to about 0.025% (wt.), about 0.01% (wt.) to about 0.03% (wt.), about 0.01% (wt.) to about 0.035% (wt.), about 0.01% (wt.) to about 0.04% (wt.), about 0.01% (wt.) to about 0.05% (wt.), about 0.01% (wt.) to about 0.075% (wt.), about 0.01% (wt.) to about 0.09% (wt.), about 0.01% (wt.) to about 0.1% (wt.), about 0.015% (wt.) to about 0.017% (wt.), about 0.015% (wt.) to about 0.02% (wt.), about 0.015% (wt.) to about 0.025% (wt.), about 0.015% (wt.) to about 0.03% (wt.), about 0.015% (wt.) to about 0.035% (wt.), about 0.015% (wt.) to about 0.04% (wt.), about 0.015% (wt.) to about 0.05% (wt.), about 0.015% (wt.) to about 0.075% (wt.), about 0.015% (wt.) to about 0.09% (wt.), about 0.015% (wt.) to about 0.1% (wt.), about 0.017% (wt.) to about 0.02% (wt.), about 0.017% (wt.) to about 0.025% (wt.), about 0.017% (wt.) to about 0.03% (wt.), about 0.017% (wt.) to about 0.035% (wt.), about 0.017% (wt.) to about 0.04% (wt.), about 0.017% (wt.) to about 0.05% (wt.), about 0.017% (wt.) to about 0.075% (wt.), about 0.017% (wt.) to about 0.09% (wt.), about 0.017% (wt.) to about 0.1% (wt.), about 0.02% (wt.) to about 0.025% (wt.), about 0.02% (wt.) to about 0.03% (wt.), about 0.02% (wt.) to about 0.035% (wt.), about 0.02% (wt.) to about 0.04% (wt.), about 0.02% (wt.) to about 0.05% (wt.), about 0.02% (wt.) to about 0.075% (wt.), about 0.02% (wt.) to about 0.09% (wt.), about 0.02% (wt.) to about 0.1% (wt.), about 0.025% (wt.) to about 0.03% (wt.), about 0.025% (wt.) to about 0.035% (wt.), about 0.025% (wt.) to about 0.04% (wt.), about 0.025% (wt.) to about 0.05% (wt.), about 0.025% (wt.) to about 0.075% (wt.), about 0.025% (wt.) to about 0.09% (wt.), about 0.025% (wt.) to about 0.1% (wt.), about 0.03% (wt.) to about 0.035% (wt.), about 0.03% (wt.) to about 0.04% (wt.), about 0.03% (wt.) to about 0.05% (wt.), about 0.03% (wt.) to about 0.075% (wt.), about 0.03% (wt.) to about 0.09% (wt.), about 0.03% (wt.) to about 0.1% (wt.), about 0.035% (wt.) to about 0.04% (wt.), about 0.035% (wt.) to about 0.05% (wt.), about 0.035% (wt.) to about 0.075% (wt.), about 0.035% (wt.) to about 0.09% (wt.), about 0.035% (wt.) to about 0.1% (wt.), about 0.04% (wt.) to about 0.05% (wt.), about 0.04% (wt.) to about 0.075% (wt.), about 0.04% (wt.) to about 0.09% (wt.), about 0.04% (wt.) to about 0.1% (wt.), about 0.05% (wt.) to about 0.075% (wt.), about 0.05% (wt.) to about 0.09% (wt.), about 0.05% (wt.) to about 0.1% (wt.), about 0.075% (wt.) to about 0.09% (wt.), about 0.075% (wt.) to about 0.1% (wt.), or about 0.09% (wt.) to about 0.1% (wt.), including increments therein. In some embodiments of one-part epoxy formulations, the graphene or ultra-graphene is comprised in an amount of about 0.01% (wt.), about 0.015% (wt.), about 0.017% (wt.), about 0.02% (wt.), about 0.025% (wt.), about 0.03% (wt.), about 0.035% (wt.), about 0.04% (wt.), about 0.05% (wt.), about 0.075% (wt.), about 0.09% (wt.), or about 0.1% (wt.). In some embodiments of one-part epoxy formulations, the graphene or ultra-graphene is comprised in an amount of at least about 0.01% (wt.), about 0.015% (wt.), about 0.017% (wt.), about 0.02% (wt.), about 0.025% (wt.), about 0.03% (wt.), about 0.035% (wt.), about 0.04% (wt.), about 0.05% (wt.), about 0.075% (wt.), or about 0.09% (wt.). In some embodiments of one-part epoxy formulations, the graphene or ultra-graphene is comprised in an amount of at most about 0.015% (wt.), about 0.017% (wt.), about 0.02% (wt.), about 0.025% (wt.), about 0.03% (wt.), about 0.035% (wt.), about 0.04% (wt.), about 0.05% (wt.), about 0.075% (wt.), about 0.09% (wt.), or about 0.1% (wt.).

In some embodiments of two-part epoxy formulations, the graphene or ultra-graphene is comprised in an amount of about 0.01% (wt.) to about 0.5% (wt.). In some embodiments of two-part epoxy formulations, the graphene or ultra-graphene is comprised in an amount of about 0.01% (wt.) to about 0.025% (wt.), about 0.01% (wt.) to about 0.05% (wt.), about 0.01% (wt.) to about 0.075% (wt.), about 0.01% (wt.) to about 0.1% (wt.), about 0.01% (wt.) to about 0.2% (wt.), about 0.01% (wt.) to about 0.25% (wt.), about 0.01% (wt.) to about 0.3% (wt.), about 0.01% (wt.) to about 0.35% (wt.), about 0.01% (wt.) to about 0.4% (wt.), about 0.01% (wt.) to about 0.45% (wt.), about 0.01% (wt.) to about 0.5% (wt.), about 0.025% (wt.) to about 0.05% (wt.), about 0.025% (wt.) to about 0.075% (wt.), about 0.025% (wt.) to about 0.1% (wt.), about 0.025% (wt.) to about 0.2% (wt.), about 0.025% (wt.) to about 0.25% (wt.), about 0.025% (wt.) to about 0.3% (wt.), about 0.025% (wt.) to about 0.35% (wt.), about 0.025% (wt.) to about 0.4% (wt.), about 0.025% (wt.) to about 0.45% (wt.), about 0.025% (wt.) to about 0.5% (wt.), about 0.05% (wt.) to about 0.075% (wt.), about 0.05% (wt.) to about 0.1% (wt.), about 0.05% (wt.) to about 0.2% (wt.), about 0.05% (wt.) to about 0.25% (wt.), about 0.05% (wt.) to about 0.3% (wt.), about 0.05% (wt.) to about 0.35% (wt.), about 0.05% (wt.) to about 0.4% (wt.), about 0.05% (wt.) to about 0.45% (wt.), about 0.05% (wt.) to about 0.5% (wt.), about 0.075% (wt.) to about 0.1% (wt.), about 0.075% (wt.) to about 0.2% (wt.), about 0.075% (wt.) to about 0.25% (wt.), about 0.075% (wt.) to about 0.3% (wt.), about 0.075% (wt.) to about 0.35% (wt.), about 0.075% (wt.) to about 0.4% (wt.), about 0.075% (wt.) to about 0.45% (wt.), about 0.075% (wt.) to about 0.5% (wt.), about 0.1% (wt.) to about 0.2% (wt.), about 0.1% (wt.) to about 0.25% (wt.), about 0.1% (wt.) to about 0.3% (wt.), about 0.1% (wt.) to about 0.35% (wt.), about 0.1% (wt.) to about 0.4% (wt.), about 0.1% (wt.) to about 0.45% (wt.), about 0.1% (wt.) to about 0.5% (wt.), about 0.2% (wt.) to about 0.25% (wt.), about 0.2% (wt.) to about 0.3% (wt.), about 0.2% (wt.) to about 0.35% (wt.), about 0.2% (wt.) to about 0.4% (wt.), about 0.2% (wt.) to about 0.45% (wt.), about 0.2% (wt.) to about 0.5% (wt.), about 0.25% (wt.) to about 0.3% (wt.), about 0.25% (wt.) to about 0.35% (wt.), about 0.25% (wt.) to about 0.4% (wt.), about 0.25% (wt.) to about 0.45% (wt.), about 0.25% (wt.) to about 0.5% (wt.), about 0.3% (wt.) to about 0.35% (wt.), about 0.3% (wt.) to about 0.4% (wt.), about 0.3% (wt.) to about 0.45% (wt.), about 0.3% (wt.) to about 0.5% (wt.), about 0.35% (wt.) to about 0.4% (wt.), about 0.35% (wt.) to about 0.45% (wt.), about 0.35% (wt.) to about 0.5% (wt.), about 0.4% (wt.) to about 0.45% (wt.), about 0.4% (wt.) to about 0.5% (wt.), or about 0.45% (wt.) to about 0.5% (wt.), including increments therein. In some embodiments of two-part epoxy formulations, the graphene or ultra-graphene is comprised in an amount of about 0.01% (wt.), about 0.025% (wt.), about 0.05% (wt.), about 0.075% (wt.), about 0.1% (wt.), about 0.2% (wt.), about 0.25% (wt.), about 0.3% (wt.), about 0.35% (wt.), about 0.4% (wt.), about 0.45% (wt.), or about 0.5% (wt.). In some embodiments of two-part epoxy formulations, the graphene or ultra-graphene is comprised in an amount of at least about 0.01% (wt.), about 0.025% (wt.), about 0.05% (wt.), about 0.075% (wt.), about 0.1% (wt.), about 0.2% (wt.), about 0.25% (wt.), about 0.3% (wt.), about 0.35% (wt.), about 0.4% (wt.), or about 0.45% (wt.). In some embodiments of two-part epoxy formulations, the graphene or ultra-graphene is comprised in an amount of at most about 0.025% (wt.), about 0.05% (wt.), about 0.075% (wt.), about 0.1% (wt.), about 0.2% (wt.), about 0.25% (wt.), about 0.3% (wt.), about 0.35% (wt.), about 0.4% (wt.), about 0.45% (wt.), or about 0.5% (wt.).

### Solvent

In some embodiments, the solvent comprises methyl ethyl ketone, benzyl alcohol, or both. The solvents and their concentrations enable the homogeneous distribution of the graphene and silver throughout the epoxies herein, while maintaining a viscosity and thixotropic index suitable for a broad range of application methods.

In some embodiments of one-part epoxy formulations, the solvent is comprised in an amount of about 1% (wt.) to about 12% (wt.). In some embodiments of one-part epoxy formulations, the solvent is comprised in an amount of about 1% (wt.) to about 1.7% (wt.), about 1% (wt.) to about 2% (wt.), about 1% (wt.) to about 3% (wt.), about 1% (wt.) to about 4% (wt.), about 1% (wt.) to about 5% (wt.), about 1% (wt.) to about 6% (wt.), about 1% (wt.) to about 7% (wt.), about 1% (wt.) to about 8% (wt.), about 1% (wt.) to about 9% (wt.), about 1% (wt.) to about 10% (wt.), about 1% (wt.) to about 12% (wt.), about 1.7% (wt.) to about 2% (wt.), about 1.7% (wt.) to about 3% (wt.), about 1.7% (wt.) to about 4% (wt.), about 1.7% (wt.) to about 5% (wt.), about 1.7% (wt.) to about 6% (wt.), about 1.7% (wt.) to about 7% (wt.), about 1.7% (wt.) to about 8% (wt.), about 1.7% (wt.) to about 9% (wt.), about 1.7% (wt.) to about 10% (wt.), about 1.7% (wt.) to about 12% (wt.), about 2% (wt.) to about 3% (wt.), about 2% (wt.) to about 4% (wt.), about 2% (wt.) to about 5% (wt.), about 2% (wt.) to about 6% (wt.), about 2% (wt.) to about 7% (wt.), about 2% (wt.) to about 8% (wt.), about 2% (wt.) to about 9% (wt.), about 2% (wt.) to about 10% (wt.), about 2% (wt.) to about 12% (wt.), about 3% (wt.) to about 4% (wt.), about 3% (wt.) to about 5% (wt.), about 3% (wt.) to about 6% (wt.), about 3% (wt.) to about 7% (wt.), about 3% (wt.) to about 8% (wt.), about 3% (wt.) to about 9% (wt.), about 3% (wt.) to about 10% (wt.), about 3% (wt.) to about 12% (wt.), about 4% (wt.) to about 5% (wt.), about 4% (wt.) to about 6% (wt.), about 4% (wt.) to about 7% (wt.), about 4% (wt.) to about 8% (wt.), about 4% (wt.) to about 9% (wt.), about 4% (wt.) to about 10% (wt.), about 4% (wt.) to about 12% (wt.), about 5% (wt.) to about 6% (wt.), about 5% (wt.) to about 7% (wt.), about 5% (wt.) to about 8% (wt.), about 5% (wt.) to about 9% (wt.), about 5% (wt.) to about 10% (wt.), about 5% (wt.) to about 12% (wt.), about 6% (wt.) to about 7% (wt.), about 6% (wt.) to about 8% (wt.), about 6% (wt.) to about 9% (wt.), about 6% (wt.) to about 10% (wt.), about 6% (wt.) to about 12% (wt.), about 7% (wt.) to about 8% (wt.), about 7% (wt.) to about 9% (wt.), about 7% (wt.) to about 10% (wt.), about 7% (wt.) to about 12% (wt.), about 8% (wt.) to about 9% (wt.), about 8% (wt.) to about 10% (wt.), about 8% (wt.) to about 12% (wt.), about 9% (wt.) to about 10% (wt.), about 9% (wt.) to about 12% (wt.), or about 10% (wt.) to about 12% (wt.), including increments therein. In some embodiments of one-part epoxy formulations, the solvent is comprised in an amount of about 1% (wt.), about 1.7% (wt.), about 2% (wt.), about 3% (wt.), about 4% (wt.), about 5% (wt.), about 6% (wt.), about 7% (wt.), about 8% (wt.), about 9% (wt.), about 10% (wt.), or about 12% (wt.). In some embodiments of one-part epoxy formulations, the solvent is comprised in an amount of at least about 1% (wt.), about 1.7% (wt.), about 2% (wt.), about 3% (wt.), about 4% (wt.), about 5% (wt.), about 6% (wt.), about 7% (wt.), about 8% (wt.), about 9% (wt.), or about 10% (wt.). In some embodiments of one-part epoxy formulations, the solvent is comprised in an amount of at most about 1.7% (wt.), about 2% (wt.), about 3% (wt.), about 4% (wt.), about 5% (wt.), about 6% (wt.), about 7% (wt.), about 8% (wt.), about 9% (wt.), about 10% (wt.), or about 12% (wt.).

In some embodiments of two-part epoxy formulations, the solvent is comprised in an amount of about 1% (wt.) to about 10% (wt.). In some embodiments of two-part epoxy formulations, the solvent is comprised in an amount of about 1% (wt.) to about 2% (wt.), about 1% (wt.) to about 3% (wt.), about 1% (wt.) to about 4% (wt.), about 1% (wt.) to about 5% (wt.), about 1% (wt.) to about 5.9% (wt.), about 1% (wt.) to about 6% (wt.), about 1% (wt.) to about 7% (wt.), about 1% (wt.) to about 8% (wt.), about 1% (wt.) to about 9% (wt.), about 1% (wt.) to about 9.15% (wt.), about 1% (wt.) to about 10% (wt.), about 2% (wt.) to about 3% (wt.), about 2% (wt.) to about 4% (wt.), about 2% (wt.) to about 5% (wt.), about 2% (wt.) to about 5.9% (wt.), about 2% (wt.) to about 6% (wt.), about 2% (wt.) to about 7% (wt.), about 2% (wt.) to about 8% (wt.), about 2% (wt.) to about 9% (wt.), about 2% (wt.) to about 9.15% (wt.), about 2% (wt.) to about 10% (wt.), about 3% (wt.) to about 4% (wt.), about 3% (wt.) to about 5% (wt.), about 3% (wt.) to about 5.9% (wt.), about 3% (wt.) to about 6% (wt.), about 3% (wt.) to about 7% (wt.), about 3% (wt.) to about 8% (wt.), about 3% (wt.) to about 9% (wt.), about 3% (wt.) to about 9.15% (wt.), about 3% (wt.) to about 10% (wt.), about 4% (wt.) to about 5% (wt.), about 4% (wt.) to about 5.9% (wt.), about 4% (wt.) to about 6% (wt.), about 4% (wt.) to about 7% (wt.), about 4% (wt.) to about 8% (wt.), about 4% (wt.) to about 9% (wt.), about 4% (wt.) to about 9.15% (wt.), about 4% (wt.) to about 10% (wt.), about 5% (wt.) to about 5.9% (wt.), about 5% (wt.) to about 6% (wt.), about 5% (wt.) to about 7% (wt.), about 5% (wt.) to about 8% (wt.), about 5% (wt.) to about 9% (wt.), about 5% (wt.) to about 9.15% (wt.), about 5% (wt.) to about 10% (wt.), about 5.9% (wt.) to about 6% (wt.), about 5.9% (wt.) to about 7% (wt.), about 5.9% (wt.) to about 8% (wt.), about 5.9% (wt.) to about 9% (wt.), about 5.9% (wt.) to about 9.15% (wt.), about 5.9% (wt.) to about 10% (wt.), about 6% (wt.) to about 7% (wt.), about 6% (wt.) to about 8% (wt.), about 6% (wt.) to about 9% (wt.), about 6% (wt.) to about 9.15% (wt.), about 6% (wt.) to about 10% (wt.), about 7% (wt.) to about 8% (wt.), about 7% (wt.) to about 9% (wt.), about 7% (wt.) to about 9.15% (wt.), about 7% (wt.) to about 10% (wt.), about 8% (wt.) to about 9% (wt.), about 8% (wt.) to about 9.15% (wt.), about 8% (wt.) to about 10% (wt.), about 9% (wt.) to about 9.15% (wt.), about 9% (wt.) to about 10% (wt.), or about 9.15% (wt.) to about 10% (wt.), including increments therein. In some embodiments of two-part epoxy formulations, the solvent is comprised in an amount of about 1% (wt.), about 2% (wt.), about 3% (wt.), about 4% (wt.), about 5% (wt.), about 5.9% (wt.), about 6% (wt.), about 7% (wt.), about 8% (wt.), about 9% (wt.), about 9.15% (wt.), or about 10% (wt.). In some embodiments of two-part epoxy formulations, the solvent is comprised in an amount of at least about 1% (wt.), about 2% (wt.), about 3% (wt.), about 4% (wt.), about 5% (wt.), about 5.9% (wt.), about 6% (wt.), about 7% (wt.), about 8% (wt.), about 9% (wt.), or about 9.15% (wt.). In some embodiments of two-part epoxy formulations, the solvent is comprised in an amount of at most about 2% (wt.), about 3% (wt.), about 4% (wt.), about 5% (wt.), about 5.9% (wt.), about 6% (wt.), about 7% (wt.), about 8% (wt.), about 9% (wt.), about 9.15% (wt.), or about 10% (wt.).

### Ionic Liquid

Ionic liquids are useful for the dispersion of carbon nanomaterials (like graphene, carbon nanotubes) in epoxy and may further act as a latent curing agent in the conductive epoxy formulation. Additionally, ionic liquids are an efficient additive to improve the physical properties of epoxy/amine networks such as wear and scratch resistance and thermo-mechanical properties. In some embodiments, the ionic liquid comprises a phosphonium ionic liquid. In some embodiments, the ionic liquid comprises tributyl(ethyl) phosphonium diethyl phosphate, trihexyl (tetradecyl) phosphonium bis 2,4,4-(trimethyl pentyl)-phosphinate, or both. The ionic liquid may act as a latent curing agent, a dispersing agent, or both for the epoxy. The ionic liquids and their concentrations enable the homogeneous distribution of the graphene and silver throughout the epoxies herein, while maintaining a viscosity and thixotropic index suitable for a broad range of application methods of forming cured products with high lap shear stress and storage modulus. The ionic liquids and their concentration in the conductive epoxies herein reduce viscosity to enable the epoxy's application to electronic components by additional means, such as, for example, screen printing. The ionic liquids and their concentration in the conductive epoxies herein improve the hardness, toughness, and temperature resistance of the conductive epoxies.

In some embodiments of one-part epoxy formulations, the ionic liquid is comprised in an amount of about 0.5% (wt.) to about 2.5% (wt.). In some embodiments of one-part epoxy formulations, the ionic liquid is comprised in an amount of about 0.5% (wt.) to about 0.6% (wt.), about 0.5% (wt.) to about 0.7% (wt.), about 0.5% (wt.) to about 0.8% (wt.), about 0.5% (wt.) to about 0.9% (wt.), about 0.5% (wt.) to about 1% (wt.), about 0.5% (wt.) to about 1.25% (wt.), about 0.5% (wt.) to about 1.5% (wt.), about 0.5% (wt.) to about 1.75% (wt.), about 0.5% (wt.) to about 2% (wt.), about 0.5% (wt.) to about 2.1% (wt.), about 0.5% (wt.) to about 2.5% (wt.), about 0.6% (wt.) to about 0.7% (wt.), about 0.6% (wt.) to about 0.8% (wt.), about 0.6% (wt.) to about 0.9% (wt.), about 0.6% (wt.) to about 1% (wt.), about 0.6% (wt.) to about 1.25% (wt.), about 0.6% (wt.) to about 1.5% (wt.), about 0.6% (wt.) to about 1.75% (wt.), about 0.6% (wt.) to about 2% (wt.), about 0.6% (wt.) to about 2.1% (wt.), about 0.6% (wt.) to about 2.5% (wt.), about 0.7% (wt.) to about 0.8% (wt.), about 0.7% (wt.) to about 0.9% (wt.), about 0.7% (wt.) to about 1% (wt.), about 0.7% (wt.) to about 1.25% (wt.), about 0.7% (wt.) to about 1.5% (wt.), about 0.7% (wt.) to about 1.75% (wt.), about 0.7% (wt.) to about 2% (wt.), about 0.7% (wt.) to about 2.1% (wt.), about 0.7% (wt.) to about 2.5% (wt.), about 0.8% (wt.) to about 0.9% (wt.), about 0.8% (wt.) to about 1% (wt.), about 0.8% (wt.) to about 1.25% (wt.), about 0.8% (wt.) to about 1.5% (wt.), about 0.8% (wt.) to about 1.75% (wt.), about 0.8% (wt.) to about 2% (wt.), about 0.8% (wt.) to about 2.1% (wt.), about 0.8% (wt.) to about 2.5% (wt.), about 0.9% (wt.) to about 1% (wt.), about 0.9% (wt.) to about 1.25% (wt.), about 0.9% (wt.) to about 1.5% (wt.), about 0.9% (wt.) to about 1.75% (wt.), about 0.9% (wt.) to about 2% (wt.), about 0.9% (wt.) to about 2.1% (wt.), about 0.9% (wt.) to about 2.5% (wt.), about 1% (wt.) to about 1.25% (wt.), about 1% (wt.) to about 1.5% (wt.), about 1% (wt.) to about 1.75% (wt.), about 1% (wt.) to about 2% (wt.), about 1% (wt.) to about 2.1% (wt.), about 1% (wt.) to about 2.5% (wt.), about 1.25% (wt.) to about 1.5% (wt.), about 1.25% (wt.) to about 1.75% (wt.), about 1.25% (wt.) to about 2% (wt.), about 1.25% (wt.) to about 2.1% (wt.), about 1.25% (wt.) to about 2.5% (wt.), about 1.5% (wt.) to about 1.75% (wt.), about 1.5% (wt.) to about 2% (wt.), about 1.5% (wt.) to about 2.1% (wt.), about 1.5% (wt.) to about 2.5% (wt.), about 1.75% (wt.) to about 2% (wt.), about 1.75% (wt.) to about 2.1% (wt.), about 1.75% (wt.) to about 2.5% (wt.), about 2% (wt.) to about 2.1% (wt.), about 2% (wt.) to about 2.5% (wt.), or about 2.1% (wt.) to about 2.5% (wt.), including increments therein. In some embodiments of one-part epoxy formulations, the ionic liquid is comprised in an amount of about 0.5% (wt.), about 0.6% (wt.), about 0.7% (wt.), about 0.8% (wt.), about 0.9% (wt.), about 1% (wt.), about 1.25% (wt.), about 1.5% (wt.), about 1.75% (wt.), about 2% (wt.), about 2.1% (wt.), or about 2.5% (wt.). In some embodiments of one-part epoxy formulations, the ionic liquid is comprised in an amount of at least about 0.5% (wt.), about 0.6% (wt.), about 0.7% (wt.), about 0.8% (wt.), about 0.9% (wt.), about 1% (wt.), about 1.25% (wt.), about 1.5% (wt.), about 1.75% (wt.), about 2% (wt.), or about 2.1% (wt.). In some embodiments of one-part epoxy formulations, the ionic liquid is comprised in an amount of at most about 0.6% (wt.), about 0.7% (wt.), about 0.8% (wt.), about 0.9% (wt.), about 1% (wt.), about 1.25% (wt.), about 1.5% (wt.), about 1.75% (wt.), about 2% (wt.), about 2.1% (wt.), or about 2.5% (wt.).

### Curing Agent

In some embodiments, the curing agent comprises dicyandiamide, modified polyamine, boron trifluoride amine complex, organic acid hydrazide, tertiary amine imidazole, or any combination thereof. In some embodiments, the curing agent comprises the modified amine, wherein the modified amine comprises a modified polyamine, modified cycloaliphatic polyamine, modified aliphatic amine, a boron trifluoride amine complex, phenalkamine-based modified polyamine, or any combination thereof. In some embodiments, the curing agent comprises boron trifluoride amine complexes, dicyandiamide, organic acid hydrazide, modified polyamine, tertiary amine imidazole, or any combination thereof. The curing agents and their concentrations enable the homogeneous distribution of the graphene and silver throughout the epoxies herein, while maintaining a viscosity and thixotropic index suitable for a broad range of application methods of forming cured products with high lap shear stress and storage modulus.

In some embodiments of one-part epoxy formulations, the curing agent may be comprised in an amount of about 0.1% (wt.) to about 2% (wt.). In some embodiments of one-part epoxy formulations, the curing agent is comprised in an amount of about 0.1% (wt.) to about 0.2% (wt.), about 0.1% (wt.) to about 0.24% (wt.), about 0.1% (wt.) to about 0.5% (wt.), about 0.1% (wt.) to about 0.75% (wt.), about 0.1% (wt.) to about 1% (wt.), about 0.1% (wt.) to about 1.25% (wt.), about 0.1% (wt.) to about 1.5% (wt.), about 0.1% (wt.) to about 1.75% (wt.), about 0.1% (wt.) to about 2% (wt.), about 0.2% (wt.) to about 0.24% (wt.), about 0.2% (wt.) to about 0.5% (wt.), about 0.2% (wt.) to about 0.75% (wt.), about 0.2% (wt.) to about 1% (wt.), about 0.2% (wt.) to about 1.25% (wt.), about 0.2% (wt.) to about 1.5% (wt.), about 0.2% (wt.) to about 1.75% (wt.), about 0.2% (wt.) to about 2% (wt.), about 0.24% (wt.) to about 0.5% (wt.), about 0.24% (wt.) to about 0.75% (wt.), about 0.24% (wt.) to about 1% (wt.), about 0.24% (wt.) to about 1.25% (wt.), about 0.24% (wt.) to about 1.5% (wt.), about 0.24% (wt.) to about 1.75% (wt.), about 0.24% (wt.) to about 2% (wt.), about 0.5% (wt.) to about 0.75% (wt.), about 0.5% (wt.) to about 1% (wt.), about 0.5% (wt.) to about 1.25% (wt.), about 0.5% (wt.) to about 1.5% (wt.), about 0.5% (wt.) to about 1.75% (wt.), about 0.5% (wt.) to about 2% (wt.), about 0.75% (wt.) to about 1% (wt.), about 0.75% (wt.) to about 1.25% (wt.), about 0.75% (wt.) to about 1.5% (wt.), about 0.75% (wt.) to about 1.75% (wt.), about 0.75% (wt.) to about 2% (wt.), about 1% (wt.) to about 1.25% (wt.), about 1% (wt.) to about 1.5% (wt.), about 1% (wt.) to about 1.75% (wt.), about 1% (wt.) to about 2% (wt.), about 1.25% (wt.) to about 1.5% (wt.), about 1.25% (wt.) to about 1.75% (wt.), about 1.25% (wt.) to about 2% (wt.), about 1.5% (wt.) to about 1.75% (wt.), about 1.5% (wt.) to about 2% (wt.), or about 1.75% (wt.) to about 2% (wt.), including increments therein. In some embodiments of one-part epoxy formulations, the curing agent is comprised in an amount of about 0.1% (wt.), about 0.2% (wt.), about 0.24% (wt.), about 0.5% (wt.), about 0.75% (wt.), about 1% (wt.), about 1.25% (wt.), about 1.5% (wt.), about 1.75% (wt.), or about 2% (wt.). In some embodiments of one-part epoxy formulations, the curing agent is comprised in an amount of at least about 0.1% (wt.), about 0.2% (wt.), about 0.24% (wt.), about 0.5% (wt.), about 0.75% (wt.), about 1% (wt.), about 1.25% (wt.), about 1.5% (wt.), or about 1.75% (wt.). In some embodiments of one-part epoxy formulations, the curing agent is comprised in an amount of at most about 0.2% (wt.), about 0.24% (wt.), about 0.5% (wt.), about 0.75% (wt.), about 1% (wt.), about 1.25% (wt.), about 1.5% (wt.), about 1.75% (wt.), or about 2% (wt.).

In some embodiments, the curing agent for 2-part conductive adhesive formulation comprises the modified amine, wherein the modified amine comprises a modified polyamine, modified cycloaliphatic polyamine, modified aliphatic amine, phenalkamine-based modified polyamine, or any combination thereof.

In some embodiments of two-part epoxy formulations, the curing agent is comprised in an amount of about 0% (wt.) to about 20% (wt.). In some embodiments of two-part epoxy formulations, the curing agent is comprised in an amount of about 0% (wt.) to about 2% (wt.), about 0% (wt.) to about 4% (wt.), about 0% (wt.) to about 6% (wt.), about 0% (wt.) to about 8% (wt.), about 0% (wt.) to about 10% (wt.), about 0% (wt.) to about 12% (wt.), about 0% (wt.) to about 14% (wt.), about 0% (wt.) to about 16% (wt.), about 0% (wt.) to about 18% (wt.), about 0% (wt.) to about 20% (wt.), about 2% (wt.) to about 4% (wt.), about 2% (wt.) to about 6% (wt.), about 2% (wt.) to about 8% (wt.), about 2% (wt.) to about 10% (wt.), about 2% (wt.) to about 12% (wt.), about 2% (wt.) to about 14% (wt.), about 2% (wt.) to about 16% (wt.), about 2% (wt.) to about 18% (wt.), about 2% (wt.) to about 20% (wt.), about 4% (wt.) to about 6% (wt.), about 4% (wt.) to about 8% (wt.), about 4% (wt.) to about 10% (wt.), about 4% (wt.) to about 12% (wt.), about 4% (wt.) to about 14% (wt.), about 4% (wt.) to about 16% (wt.), about 4% (wt.) to about 18% (wt.), about 4% (wt.) to about 20% (wt.), about 6% (wt.) to about 8% (wt.), about 6% (wt.) to about 10% (wt.), about 6% (wt.) to about 12% (wt.), about 6% (wt.) to about 14% (wt.), about 6% (wt.) to about 16% (wt.), about 6% (wt.) to about 18% (wt.), about 6% (wt.) to about 20% (wt.), about 8% (wt.) to about 10% (wt.), about 8% (wt.) to about 12% (wt.), about 8% (wt.) to about 14% (wt.), about 8% (wt.) to about 16% (wt.), about 8% (wt.) to about 18% (wt.), about 8% (wt.) to about 20% (wt.), about 10% (wt.) to about 12% (wt.), about 10% (wt.) to about 14% (wt.), about 10% (wt.) to about 16% (wt.), about 10% (wt.) to about 18% (wt.), about 10% (wt.) to about 20% (wt.), about 12% (wt.) to about 14% (wt.), about 12% (wt.) to about 16% (wt.), about 12% (wt.) to about 18% (wt.), about 12% (wt.) to about 20% (wt.), about 14% (wt.) to about 16% (wt.), about 14% (wt.) to about 18% (wt.), about 14% (wt.) to about 20% (wt.), about 16% (wt.) to about 18% (wt.), about 16% (wt.) to about 20% (wt.), or about 18% (wt.) to about 20% (wt.), including increments therein. In some embodiments of two-part epoxy formulations, the curing agent is comprised in an amount of about 0% (wt.), about 2% (wt.), about 4% (wt.), about 6% (wt.), about 8% (wt.), about 10% (wt.), about 12% (wt.), about 14% (wt.), about 16% (wt.), about 18% (wt.), or about 20% (wt.). In some embodiments of two-part epoxy formulations, the curing agent is comprised in an amount of at least about 0% (wt.), about 2% (wt.), about 4% (wt.), about 6% (wt.), about 8% (wt.), about 10% (wt.), about 12% (wt.), about 14% (wt.), about 16% (wt.), or about 18% (wt.). In some embodiments of two-part epoxy formulations, the curing agent is comprised in an amount of at most about 2% (wt.), about 4% (wt.), about 6% (wt.), about 8% (wt.), about 10% (wt.), about 12% (wt.), about 14% (wt.), about 16% (wt.), about 18% (wt.), or about 20% (wt.).

### Strength Additive

In some embodiments, the strength additive comprises neopentyl glycol, butadiene-acrylonitrile, or both. In some embodiments, the strength additive comprises the neopentyl glycol, and wherein the neopentyl glycol comprises an epoxidized neopentyl glycol adduct. In some embodiments, the strength additive comprises the butadiene-acrylonitrile, wherein the butadiene-acrylonitrile comprises an amine-terminated butadiene-acrylonitrile copolymer. The strength additive and its concentration in the conductive epoxies form cured bonds with increased flexibility, crack, fatigue resistance, peel resistance, and adhesive properties. The strength additives and their concentrations enable a viscosity and thixotropic index suitable for a broad range of application methods of forming cured products with high lap shear stress and storage modulus.

In some embodiments of two-part epoxy formulations, the strength additive comprises CTBN-Toughened Epoxidized Neopentyl Glycol Adduct. In some embodiments of one-part epoxy formulations, the strength additive is comprised in an amount of about 1% (wt.) to about 7.5% (wt.). In some embodiments of one-part epoxy formulations, the strength additive is comprised in an amount of about 1% (wt.) to about 1.5% (wt.), about 1% (wt.) to about 2% (wt.), about 1% (wt.) to about 2.5% (wt.), about 1% (wt.) to about 3% (wt.), about 1% (wt.) to about 3.5% (wt.), about 1% (wt.) to about 4% (wt.), about 1% (wt.) to about 4.5% (wt.), about 1% (wt.) to about 5% (wt.), about 1% (wt.) to about 6% (wt.), about 1% (wt.) to about 7% (wt.), about 1% (wt.) to about 7.5% (wt.), about 1.5% (wt.) to about 2% (wt.), about 1.5% (wt.) to about 2.5% (wt.), about 1.5% (wt.) to about 3% (wt.), about 1.5% (wt.) to about 3.5% (wt.), about 1.5% (wt.) to about 4% (wt.), about 1.5% (wt.) to about 4.5% (wt.), about 1.5% (wt.) to about 5% (wt.), about 1.5% (wt.) to about 6% (wt.), about 1.5% (wt.) to about 7% (wt.), about 1.5% (wt.) to about 7.5% (wt.), about 2% (wt.) to about 2.5% (wt.), about 2% (wt.) to about 3% (wt.), about 2% (wt.) to about 3.5% (wt.), about 2% (wt.) to about 4% (wt.), about 2% (wt.) to about 4.5% (wt.), about 2% (wt.) to about 5% (wt.), about 2% (wt.) to about 6% (wt.), about 2% (wt.) to about 7% (wt.), about 2% (wt.) to about 7.5% (wt.), about 2.5% (wt.) to about 3% (wt.), about 2.5% (wt.) to about 3.5% (wt.), about 2.5% (wt.) to about 4% (wt.), about 2.5% (wt.) to about 4.5% (wt.), about 2.5% (wt.) to about 5% (wt.), about 2.5% (wt.) to about 6% (wt.), about 2.5% (wt.) to about 7% (wt.), about 2.5% (wt.) to about 7.5% (wt.), about 3% (wt.) to about 3.5% (wt.), about 3% (wt.) to about 4% (wt.), about 3% (wt.) to about 4.5% (wt.), about 3% (wt.) to about 5% (wt.), about 3% (wt.) to about 6% (wt.), about 3% (wt.) to about 7% (wt.), about 3% (wt.) to about 7.5% (wt.), about 3.5% (wt.) to about 4% (wt.), about 3.5% (wt.) to about 4.5% (wt.), about 3.5% (wt.) to about 5% (wt.), about 3.5% (wt.) to about 6% (wt.), about 3.5% (wt.) to about 7% (wt.), about 3.5% (wt.) to about 7.5% (wt.), about 4% (wt.) to about 4.5% (wt.), about 4% (wt.) to about 5% (wt.), about 4% (wt.) to about 6% (wt.), about 4% (wt.) to about 7% (wt.), about 4% (wt.) to about 7.5% (wt.), about 4.5% (wt.) to about 5% (wt.), about 4.5% (wt.) to about 6% (wt.), about 4.5% (wt.) to about 7% (wt.), about 4.5% (wt.) to about 7.5% (wt.), about 5% (wt.) to about 6% (wt.), about 5% (wt.) to about 7% (wt.), about 5% (wt.) to about 7.5% (wt.), about 6% (wt.) to about 7% (wt.), about 6% (wt.) to about 7.5% (wt.), or about 7% (wt.) to about 7.5% (wt.), including increments therein. In some embodiments of one-part epoxy formulations, the strength additive is comprised in an amount of about 1% (wt.), about 1.5% (wt.), about 2% (wt.), about 2.5% (wt.), about 3% (wt.), about 3.5% (wt.), about 4% (wt.), about 4.5% (wt.), about 5% (wt.), about 6% (wt.), about 7% (wt.), or about 7.5% (wt.). In some embodiments of one-part epoxy formulations, the strength additive is comprised in an amount of at least about 1% (wt.), about 1.5% (wt.), about 2% (wt.), about 2.5% (wt.), about 3% (wt.), about 3.5% (wt.), about 4% (wt.), about 4.5% (wt.), about 5% (wt.), about 6% (wt.), or about 7% (wt.). In some embodiments of one-part epoxy formulations, the strength additive is comprised in an amount of at most about 1.5% (wt.), about 2% (wt.), about 2.5% (wt.), about 3% (wt.), about 3.5% (wt.), about 4% (wt.), about 4.5% (wt.), about 5% (wt.), about 6% (wt.), about 7% (wt.), or about 7.5% (wt.).

In some embodiments of two-part epoxy formulations, the strength additive comprises Amine-terminated butadiene-acrylonitrile copolymer, or CTBN-Toughened Epoxidized Neopentyl Glycol Adduct. In some embodiments of two-part epoxy formulations, the strength additive is comprised in an amount of about 1% (wt.) to about 7.5% (wt.). In some embodiments of two-part epoxy formulations, the strength additive is comprised in an amount of about 1% (wt.) to about 1.5% (wt.), about 1% (wt.) to about 2% (wt.), about 1% (wt.) to about 2.5% (wt.), about 1% (wt.) to about 3% (wt.), about 1% (wt.) to about 3.5% (wt.), about 1% (wt.) to about 4% (wt.), about 1% (wt.) to about 4.5% (wt.), about 1% (wt.) to about 5% (wt.), about 1% (wt.) to about 6% (wt.), about 1% (wt.) to about 7% (wt.), about 1% (wt.) to about 7.5% (wt.), about 1.5% (wt.) to about 2% (wt.), about 1.5% (wt.) to about 2.5% (wt.), about 1.5% (wt.) to about 3% (wt.), about 1.5% (wt.) to about 3.5% (wt.), about 1.5% (wt.) to about 4% (wt.), about 1.5% (wt.) to about 4.5% (wt.), about 1.5% (wt.) to about 5% (wt.), about 1.5% (wt.) to about 6% (wt.), about 1.5% (wt.) to about 7% (wt.), about 1.5% (wt.) to about 7.5% (wt.), about 2% (wt.) to about 2.5% (wt.), about 2% (wt.) to about 3% (wt.), about 2% (wt.) to about 3.5% (wt.), about 2% (wt.) to about 4% (wt.), about 2% (wt.) to about 4.5% (wt.), about 2% (wt.) to about 5% (wt.), about 2% (wt.) to about 6% (wt.), about 2% (wt.) to about 7% (wt.), about 2% (wt.) to about 7.5% (wt.), about 2.5% (wt.) to about 3% (wt.), about 2.5% (wt.) to about 3.5% (wt.), about 2.5% (wt.) to about 4% (wt.), about 2.5% (wt.) to about 4.5% (wt.), about 2.5% (wt.) to about 5% (wt.), about 2.5% (wt.) to about 6% (wt.), about 2.5% (wt.) to about 7% (wt.), about 2.5% (wt.) to about 7.5% (wt.), about 3% (wt.) to about 3.5% (wt.), about 3% (wt.) to about 4% (wt.), about 3% (wt.) to about 4.5% (wt.), about 3% (wt.) to about 5% (wt.), about 3% (wt.) to about 6% (wt.), about 3% (wt.) to about 7% (wt.), about 3% (wt.) to about 7.5% (wt.), about 3.5% (wt.) to about 4% (wt.), about 3.5% (wt.) to about 4.5% (wt.), about 3.5% (wt.) to about 5% (wt.), about 3.5% (wt.) to about 6% (wt.), about 3.5% (wt.) to about 7% (wt.), about 3.5% (wt.) to about 7.5% (wt.), about 4% (wt.) to about 4.5% (wt.), about 4% (wt.) to about 5% (wt.), about 4% (wt.) to about 6% (wt.), about 4% (wt.) to about 7% (wt.), about 4% (wt.) to about 7.5% (wt.), about 4.5% (wt.) to about 5% (wt.), about 4.5% (wt.) to about 6% (wt.), about 4.5% (wt.) to about 7% (wt.), about 4.5% (wt.) to about 7.5% (wt.), about 5% (wt.) to about 6% (wt.), about 5% (wt.) to about 7% (wt.), about 5% (wt.) to about 7.5% (wt.), about 6% (wt.) to about 7% (wt.), about 6% (wt.) to about 7.5% (wt.), or about 7% (wt.) to about 7.5% (wt.), including increments therein. In some embodiments of two-part epoxy formulations, the strength additive is comprised in an amount of about 1% (wt.), about 1.5% (wt.), about 2% (wt.), about 2.5% (wt.), about 3% (wt.), about 3.5% (wt.), about 4% (wt.), about 4.5% (wt.), about 5% (wt.), about 6% (wt.), about 7% (wt.), or about 7.5% (wt.). In some embodiments of two-part epoxy formulations, the strength additive is comprised in an amount of at least about 1% (wt.), about 1.5% (wt.), about 2% (wt.), about 2.5% (wt.), about 3% (wt.), about 3.5% (wt.), about 4% (wt.), about 4.5% (wt.), about 5% (wt.), about 6% (wt.), or about 7% (wt.). In some embodiments of two-part epoxy formulations, the strength additive is comprised in an amount of at most about 1.5% (wt.), about 2% (wt.), about 2.5% (wt.), about 3% (wt.), about 3.5% (wt.), about 4% (wt.), about 4.5% (wt.), about 5% (wt.), about 6% (wt.), about 7% (wt.), or about 7.5% (wt.).

### Methods of Forming Conductive Epoxies

Another aspect provided herein is a method of forming a conductive epoxy, the method comprising: (a) forming a first compound comprising: (i) an epoxy resin; (ii) a diluent; and (iii) graphene; (b) mixing the first compound; (c) adding silver to the first compound; and (d) mixing the first compound. In some embodiments, the method further comprises: (e) forming a second compound comprising: (i) the epoxy resin; (ii) the diluent; and (iii) graphene; (f) mixing the second compound; (g) adding silver to the second compound; and (h) mixing the second compound.

In some embodiments, the first compound further comprises: (a) a solvent; (b) an ionic liquid; (c) a curing agent; (d) a strength additive; or (e) any combination thereof. In some embodiments, the second compound further comprises: (a) a solvent; (b) an ionic liquid; (c) a curing agent; (d) a strength additive; or (e) any combination thereof.

In some embodiments, the first compound further comprises: (a) a solvent; (b) an ionic liquid; (c) a curing agent; (d) a strength additive; or (e) any combination thereof. In some embodiments, the second compound further comprises: (a) a solvent; (b) an ionic liquid; (c) a curing agent; (d) a strength additive; or (e) a combination of (a)-(d) thereof.

In some embodiments, at least a portion of step (b) is performed at a mixer speed of about 5,000 rpm to about 20,000 rpm. In some embodiments, at least a portion of step (b) is performed by ultrasonification, high shear mixing, ball mixing, roll mixing, planetary mixing, or any combination thereof. In some embodiments, step (b) is performed for about 10 minutes to about 200 minutes. In some embodiments, step (c) is performed over a time period of about 5 minutes to about 60 minutes. In some embodiments, step (d) is performed over a time period of about 30 minutes to about 120 minutes. In some embodiments, at least a portion of step (d) is performed under vacuum. In some embodiments, at least a portion of step (d) is performed below 25° C.

Step (b) of the methods provided herein mills, grounds, and exfoliates the graphene to a thickness of about 1 nm to about 10 nm. Step (b) further enables the formation of graphene comprising 1-10 graphene layers and with a surface area of about 400 m²/g to about 2,000 m²/g. Mixing the graphene with the epoxy resin in step (b) enables the homogeneous chemisorption of the epoxy resin into the surfaces of the graphene and prevents aggregation/agglomeration of the exfoliated graphene sheets.

In some embodiments, high shear mixing for the preparation of the ultra-graphene powder dispersion occurs in liquid hydrocarbon resin as a non-reactive diluent added in a falcon tube to fit closely with a probe. Shear mixing time can also vary but periods from 0.5 to 2 hours at 10,000 rpm may be utilized. During this process, the graphene powder is exfoliated into sheets of 1 nm to 5 nm thickness, its average particle size 1-5 micron. High shear mixing of ultra-graphene in a non-reactive diluent finally gives a stable homogeneous dispersion.

Diluent chemisorbed on the surfaces of the graphene and prevent aggregation/agglomeration of exfoliated single layer or few layer graphene sheets. Instead of high shear mixing of ultra-graphene in diluents at 10,000 rpm, ultra-sonication can also employ which also gives similar level of exfoliation of graphene in diluent.

Next, graphene dispersion in diluent is mixed with epoxy resin along with other additives using overhead mixer/planetary mixer under vacuum. The high surface area of the graphene is utilized to cover the uncured epoxy resin before the loading of the metal particles. At this point, ultra-graphene not only acts as a conductive filler but also as a dispersing agent for the loading of metal particles. At least approximately 0.03% by weight of ultra-graphene as a dispersing agent may be utilized based on the total weight of the conductive adhesive for the formation of a stable dispersion of fillers in the polymer matrix. For example, 0.03-0.1% by weight of ultra-graphene as a dispersing agent and conductive nanofiller in epoxy resin may be utilized, which helps to improve electrical, thermal, and mechanical properties. Above 0.3%, there is unlikely to be additional beneficial effects as a dispersing agent or reinforcing filler. For example, a large increase in the viscosity and difficulties with sufficient silver flake loading while maintaining adequate conductivity may be experienced. In some cases, a significant decrease in the mechanical properties of the adhesive above 0.3 wt % loading of ultra-graphene along with silver flakes in polymer matrix, may be experienced or encountered. Ultra-graphene as a dispersing agent in a concentration of about 0.03%-0.05% by weight may be used in some cases.

In some embodiments, the mixture comprising graphene in diluent/plasticizer may be introduced to high shear mixing/ultra-sonication prior to the overhead mixing procedure for the generation of a single layer or below 5-layered graphene sheets in the epoxy matrix. Here, this non-reactive diluent may prevent agglomeration of graphene by chemisorption on the surfaces of the graphene while being compatible with epoxy resin and hardener. It may also help to load more metal nano/microparticles as a conductive filler. Furthermore, this non-reactive diluent gives good texture of the final formula of conductive epoxy adhesive. The non-reactive diluent can provide a lubricating effect that does not significantly impact the mechanical properties of the adhesive.

The specific method steps, components, and their concentrations herein impart shear force on the graphene to enable homogeneous distribution of the metal additives and the epoxy resins in the conductive epoxies herein. The method steps and component concentrations described herein may form a crosslink network during curing to form conductive epoxies with improved strength and electrochemical properties.

### Characterization of Conductive Epoxies

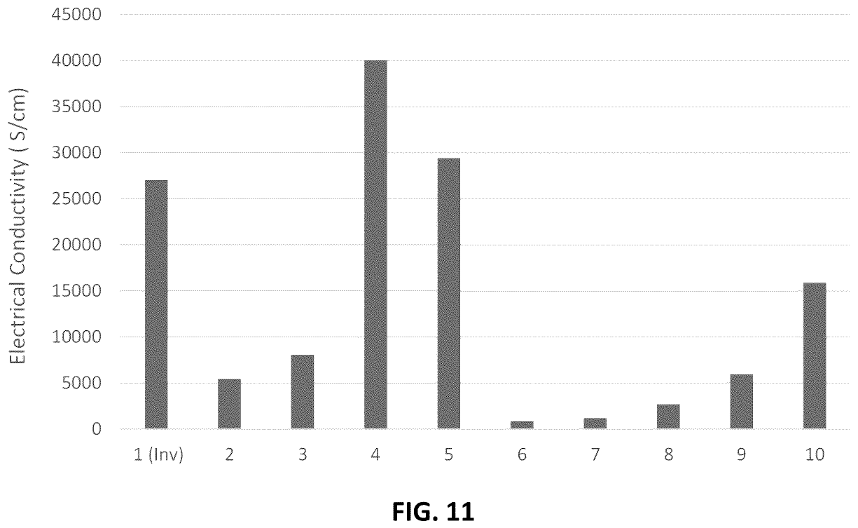

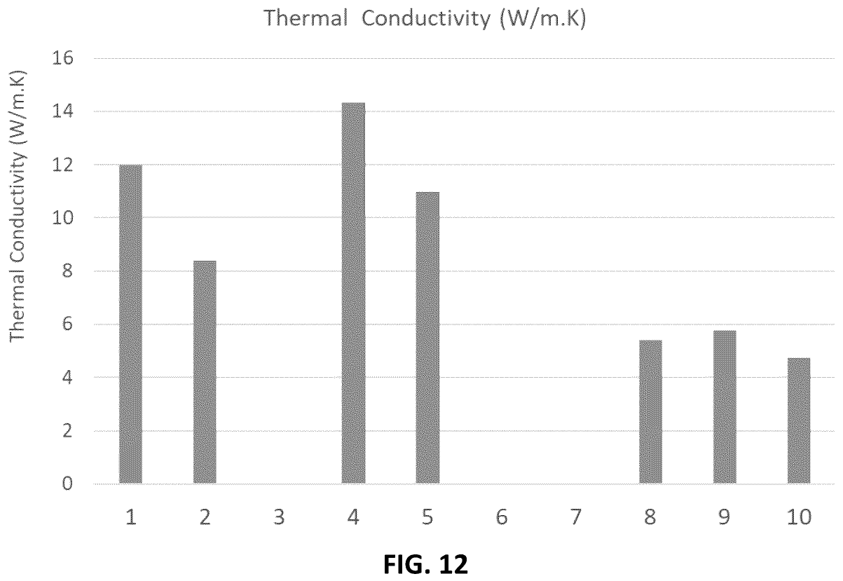

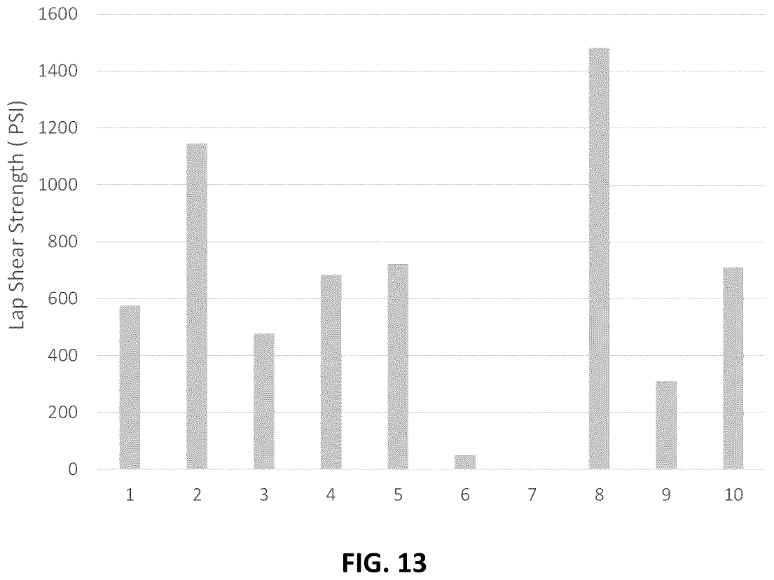

Exemplary epoxies were formed per Table 1 below (see Examples section). The electromechanical properties of the exemplary conductive epoxies formed in Table 1 is shown in Table 2, wherein the electrical conductivity, thermal conductivity, and lap shear strength are compared in FIGS. 11-13.

Graphene possesses unique friction and wear properties in addition to its well-established thermal, electrical, optical, and mechanical properties. Ultra-graphene has a relatively lower electrical conductivity than silver flakes and does not provide a direct contribution to enhance the electrical conductivity of the adhesive. However, the large surface area of the graphene may provide the epoxy resin with continuous electrically conductive network and prevent the sedimentation/aggregation of silver flakes as a result it showed synergistic effect with the silver flakes as well as other forms of silver such as colloidal silver nanoparticles, silver nanowires, spherical silver microparticles, silver-coated copper, silver-coated glass powder and silver-coated ceramic powder for the improvement on the electrical, thermal, and mechanical properties.

In some embodiments, the high surface area graphene, epoxies, and strength additives herein enable increased thermal shock resistance and mechanical strength of bonds formed therefrom. In some embodiments the epoxies herein can be stored at room temperature without performance degradation.

Thixotropy is a measure of time-dependent viscosity change in response to a shear. The thixotropic index (viscosity ratio at low-shear rate and high shear rate by a factor of 10) is an important parameter to maintain the position of the adhesive for a particular application or the ability of the adhesive to grab and maintain contact with the substrate during the curing process. Viscoelastic properties, such as G′, G″, and Tan delta (tan D) of adhesive, give an indication about handling and appearance properties, lubricity, film formation, and potential pumping issues, stringing and tailing properties. Thixotropic loop area is a measure of the destruction and subsequent rebuilding of a material during and after exposure to shear forces. Decreased viscosity or thixotropy often indicates phase separation of the material. The thixotropic index correlates to a liquid's ability to adhere and maintain its initial shape and/or location while curing. As such, fluids with a higher thixotropic index are advantageously easier to handle and dispense, and form stable films without stringing and tailing properties. Thixotropic loop area is a measure of the destruction and subsequent rebuilding of a material during and after exposure to shear forces. A decreased viscosity or thixotropy may indicate the phase separation of the material. An exemplary one-part epoxy formulation disclosed herein showed a thixotropic index value from 3.0 to 6.

In some embodiments, the conductive epoxy has a viscosity of about 10 Pas at shear rate 1 (1/s) to about 510 Pa*s at shear rate 1 Hz (1/s). In some embodiments, the conductive epoxy has a viscosity of about 10 Pa*s at shear rate 1 (1/s) to about 15 Pa*s at shear rate 1 (1/s), about 10 Pa*s at shear rate 1 (1/s) to about 25 Pa*s at shear rate 1 (1/s), about 10 Pa*s at shear rate 1 (1/s) to about 50 Pa*s at shear rate 1 (1/s), about 10 Pa*s at shear rate 1 (1/s) to about 75 Pa*s at shear rate 1 (1/s), about 10 Pa*s at shear rate 1 (1/s) to about 100 Pa*s at shear rate 1 (1/s), about 10 Pa*s at shear rate 1 (1/s) to about 200 Pa*s at shear rate 1 (1/s), about 10 Pa*s at shear rate 1 (1/s) to about 300 Pa*s at shear rate 1 (1/s), about 10 Pa*s at shear rate 1 (1/s) to about 400 Pa*s at shear rate 1 (1/s), about 10 Pa*s at shear rate 1 (1/s) to about 450 Pa*s at shear rate 1 (1/s), about 10 Pa*s at shear rate 1 (1/s) to about 500 Pa*s at shear rate 1 (1/s), about 10 Pas at shear rate 1 (1/s) to about 510 Pa*s at shear rate 1 (1/s), about 15 Pa*s at shear rate 1 (1/s) to about 25 Pa*s at shear rate 1 (1/s), about 15 Pa*s at shear rate 1 (1/s) to about 50 Pa*s at shear rate 1 (1/s), about 15 Pa*s at shear rate 1 (1/s) to about 75 Pa*s at shear rate 1 (1/s), about 15 Pa*s at shear rate 1 (1/s) to about 100 Pa*s at shear rate 1 (1/s), about 15 Pa*s at shear rate 1 (1/s) to about 200 Pa*s at shear rate 1 (1/s), about 15 Pa*s at shear rate 1 (1/s) to about 300 Pa*s at shear rate 1 (1/s), about 15 Pa*s at shear rate 1 (1/s) to about 400 Pa*s at shear rate 1 (1/s), about 15 Pa*s at shear rate 1 (1/s) to about 450 Pa*s at shear rate 1 (1/s), about 15 Pa*s at shear rate 1 (1/s) to about 500 Pa*s at shear rate 1 (1/s), about 15 Pa*s at shear rate 1 (1/s) to about 510 Pa*s at shear rate 1 (1/s), about 25 Pa*s at shear rate 1 (1/s) to about 50 Pa*s at shear rate 1 (1/s), about 25 Pa*s at shear rate 1 (1/s) to about 75 Pa*s at shear rate 1 (1/s), about 25 Pa*s at shear rate 1 (1/s) to about 100 Pa*s at shear rate 1 (1/s), about 25 Pa*s at shear rate 1 (1/s) to about 200 Pa*s at shear rate 1 (1/s), about 25 Pa*s at shear rate 1 (1/s) to about 300 Pa*s at shear rate 1 (1/s), about 25 Pa*s at shear rate 1 (1/s) to about 400 Pa*s at shear rate 1 (1/s), about 25 Pa*s at shear rate 1 (1/s) to about 450 Pa*s at shear rate 1 (1/s), about 25 Pa*s at shear rate 1 (1/s) to about 500 Pa*s at shear rate 1 (1/s), about 25 Pa*s at shear rate 1 (1/s) to about 510 Pa*s at shear rate 1 (1/s), about 50 Pa*s at shear rate 1 (1/s) to about 75 Pa*s at shear rate 1 (1/s), about 50 Pa*s at shear rate 1 (1/s) to about 100 Pas at shear rate 1 (1/s), about 50 Pa*s at shear rate 1 (1/s) to about 200 Pa*s at shear rate 1 (1/s), about 50 Pa*s at shear rate 1 (1/s) to about 300 Pa*s at shear rate 1 (1/s), about 50 Pa*s at shear rate 1 (1/s) to about 400 Pa*s at shear rate 1 (1/s), about 50 Pa*s at shear rate 1 (1/s) to about 450 Pa*s at shear rate 1 (1/s), about 50 Pa*s at shear rate 1 (1/s) to about 500 Pa*s at shear rate 1 (1/s), about 50 Pa*s at shear rate 1 (1/s) to about 510 Pa*s at shear rate 1 (1/s), about 75 Pa*s at shear rate 1 (1/s) to about 100 Pa*s at shear rate 1 (1/s), about 75 Pa*s at shear rate 1 (1/s) to about 200 Pa*s at shear rate 1 (1/s), about 75 Pa*s at shear rate 1 (1/s) to about 300 Pa*s at shear rate 1 (1/s), about 75 Pa*s at shear rate 1 (1/s) to about 400 Pa*s at shear rate 1 (1/s), about 75 Pa*s at shear rate 1 (1/s) to about 450 Pa*s at shear rate 1 (1/s), about 75 Pa*s at shear rate 1 (1/s) to about 500 Pa*s at shear rate 1 (1/s), about 75 Pa*s at shear rate 1 (1/s) to about 510 Pa*s at shear rate 1 (1/s), about 100 Pa*s at shear rate 1 (1/s) to about 200 Pas at shear rate 1 (1/s), about 100 Pa*s at shear rate 1 (1/s) to about 300 Pa*s at shear rate 1 (1/s), about 100 Pa*s at shear rate 1 (1/s) to about 400 Pa*s at shear rate 1 (1/s), about 100 Pa*s at shear rate 1 (1/s) to about 450 Pa*s at shear rate 1 (1/s), about 100 Pa*s at shear rate 1 (1/s) to about 500 Pa*s at shear rate 1 (1/s), about 100 Pa*s at shear rate 1 (1/s) to about 510 Pa*s at shear rate 1 (1/s), about 200 Pa*s at shear rate 1 (1/s) to about 300 Pa*s at shear rate 1 (1/s), about 200 Pa*s at shear rate 1 (1/s) to about 400 Pa*s at shear rate 1 (1/s), about 200 Pa*s at shear rate 1 (1/s) to about 450 Pa*s at shear rate 1 (1/s), about 200 Pa*s at shear rate 1 (1/s) to about 500 Pa*s at shear rate 1 (1/s), about 200 Pa*s at shear rate 1 (1/s) to about 510 Pa*s at shear rate 1 (1/s), about 300 Pa*s at shear rate 1 (1/s) to about 400 Pa*s at shear rate 1 (1/s), about 300 Pa*s at shear rate 1 (1/s) to about 450 Pa*s at shear rate 1 (1/s), about 300 Pa*s at shear rate 1 (1/s) to about 500 Pa*s at shear rate 1 (1/s), about 300 Pa*s at shear rate 1 (1/s) to about 510 Pa*s at shear rate 1 (1/s), about 400 Pa*s at shear rate 1 (1/s) to about 450 Pa*s at shear rate 1 (1/s), about 400 Pa*s at shear rate 1 (1/s) to about 500 Pa*s at shear rate 1 (1/s), about 400 Pa*s at shear rate 1 (1/s) to about 510 Pa*s at shear rate 1 (1/s), about 450 Pa*s at shear rate 1 (1/s) to about 500 Pa*s at shear rate 1 (1/s), about 450 Pa*s at shear rate 1 (1/s) to about 510 Pa*s at shear rate 1 (1/s), or about 500 Pa*s at shear rate 1 (1/s) to about 510 Pa*s at shear rate 1 (1/s), including increments therein. In some embodiments, the conductive epoxy has a viscosity of about 10 Pa*s at shear rate 1 (1/s), about 15 Pa*s at shear rate 1 (1/s), about 25 Pa*s at shear rate 1 (1/s), about 50 Pa*s at shear rate 1 (1/s), about 75 Pa*s at shear rate 1 (1/s), about 100 Pas at shear rate 1 (1/s), about 200 Pa*s at shear rate 1 (1/s), about 300 Pa*s at shear rate 1 (1/s), about 400 Pa*s at shear rate 1 (1/s), about 450 Pa*s at shear rate 1 (1/s), about 500 Pa*s at shear rate 1 (1/s), or about 510 Pa*s at shear rate 1 (1/s). In some embodiments, the conductive epoxy has a viscosity of at least about 10 Pa*s at shear rate 1 (1/s), about 15 Pa*s at shear rate 1 (1/s), about 25 Pa*s at shear rate 1 (1/s), about 50 Pa*s at shear rate 1 (1/s), about 75 Pa*s at shear rate 1 (1/s), about 100 Pa*s at shear rate 1 (1/s), about 200 Pa*s at shear rate 1 (1/s), about 300 Pa*s at shear rate 1 (1/s), about 400 Pa*s at shear rate 1 (1/s), about 450 Pa*s at shear rate 1 (1/s), or about 500 Pa*s at shear rate 1 (1/s). In some embodiments, the conductive epoxy has a viscosity of at most about 15 Pa*s at shear rate 1 (1/s), about 25 Pa*s at shear rate 1 (1/s), about 50 Pa*s at shear rate 1 (1/s), about 75 Pa*s at shear rate 1 (1/s), about 100 Pa*s at shear rate 1 (1/s), about 200 Pa*s at shear rate 1 (1/s), about 300 Pa*s at shear rate 1 (1/s), about 400 Pa*s at shear rate 1 (1/s), about 450 Pa*s at shear rate 1 (1/s), about 500 Pa*s at shear rate 1 (1/s), or about 510 Pa*s at shear rate 1 (1/s). Viscosity measurements taken herein may represent measurements taken at room temperature at 1 Hz.

In some embodiments, the conductive epoxy has a Thixotropic index of about 2 to about 10. In some embodiments, the conductive epoxy has a Thixotropic index of about 2 to about 3, about 2 to about 4, about 2 to about 5, about 2 to about 6, about 2 to about 7, about 2 to about 8, about 2 to about 9, about 2 to about 10, about 3 to about 4, about 3 to about 5, about 3 to about 6, about 3 to about 7, about 3 to about 8, about 3 to about 9, about 3 to about 10, about 4 to about 5, about 4 to about 6, about 4 to about 7, about 4 to about 8, about 4 to about 9, about 4 to about 10, about 5 to about 6, about 5 to about 7, about 5 to about 8, about 5 to about 9, about 5 to about 10, about 6 to about 7, about 6 to about 8, about 6 to about 9, about 6 to about 10, about 7 to about 8, about 7 to about 9, about 7 to about 10, about 8 to about 9, about 8 to about 10, or about 9 to about 10, including increments therein. In some embodiments, the conductive epoxy has a Thixotropic index of about 2, about 3, about 4, about 5, about 6, about 7, about 8, about 9, or about 10. In some embodiments, the conductive epoxy has a Thixotropic index of at least about 2, about 3, about 4, about 5, about 6, about 7, about 8, or about 9. In some embodiments, the conductive epoxy has a Thixotropic index of at most about 3, about 4, about 5, about 6, about 7, about 8, about 9, or about 10. Thixotropic index measurements taken herein may represent measurements taken at room temperature at 1 Hz.

In some embodiments, the conductive epoxy has a volume resistivity when cured of at most about 15 mΩ*m, 14 mΩ*m, 13 mΩ*m, 12 mΩ*m, 11 mΩ*m, 10 mΩ*m, 9 mΩ*m, 8 mΩ*m, 7 mΩ*m, 6 mΩ*m, 5 mΩ*m, 4 mΩ*m, 3 mΩ*m, 2 mΩ*m, or 1 mΩ*m, including increments therein.

In some embodiments, the conductive epoxy has an electrical conductivity when cured of at least about 100 S/cm, 200 S/cm, 400 S/cm, 600 S/cm, 800 S/cm, 1,000 S/cm, 2,000 S/cm, 4,000 S/cm, 6,000 S/cm, 8,000 S/cm, 10,000 S/cm, 20,000 S/cm, or more, including increments therein.

In some embodiments, the conductive epoxy has a thermal conductivity when cured of about 1 W/mk to about 20 W/mK. In some embodiments, the conductive epoxy has a thermal conductivity when cured of about 1 W/mK to about 2 W/mK, about 1 W/mK to about 4 W/mK, about 1 W/mK to about 6 W/mK, about 1 W/mK to about 8 W/mK, about 1 W/mK to about 10 W/mK, about 1 W/mK to about 12 W/mK, about 1 W/mK to about 14 W/mK, about 1 W/mK to about 16 W/mK, about 1 W/mK to about 18 W/mk, about 1 W/mK to about 20 W/mK, about 2 W/mK to about 4 W/mK, about 2 W/mK to about 6 W/mk, about 2 W/mK to about 8 W/mK, about 2 W/mK to about 10 W/mK, about 2 W/mK to about 12 W/mk, about 2 W/mK to about 14 W/mK, about 2 W/mK to about 16 W/mK, about 2 W/mK to about 18 W/mK, about 2 W/mK to about 20 W/mK, about 4 W/mK to about 6 W/mK, about 4 W/mK to about 8 W/mK, about 4 W/mK to about 10 W/mK, about 4 W/mK to about 12 W/mK, about 4 W/mK to about 14 W/mK, about 4 W/mK to about 16 W/mK, about 4 W/mK to about 18 W/mK, about 4 W/mK to about 20 W/mK, about 6 W/mK to about 8 W/mK, about 6 W/mK to about 10 W/mK, about 6 W/mK to about 12 W/mK, about 6 W/mK to about 14 W/mK, about 6 W/mK to about 16 W/mK, about 6 W/mK to about 18 W/mK, about 6 W/mK to about 20 W/mK, about 8 W/mK to about 10 W/mK, about 8 W/mK to about 12 W/mK, about 8 W/mK to about 14 W/mK, about 8 W/mK to about 16 W/mK, about 8 W/mK to about 18 W/mK, about 8 W/mK to about 20 W/mK, about 10 W/mK to about 12 W/mK, about 10 W/mK to about 14 W/mK, about 10 W/mK to about 16 W/mK, about 10 W/mK to about 18 W/mK, about 10 W/mK to about 20 W/mK, about 12 W/mK to about 14 W/mK, about 12 W/mK to about 16 W/mK, about 12 W/mK to about 18 W/mK, about 12 W/mK to about 20 W/mK, about 14 W/mK to about 16 W/mK, about 14 W/mk to about 18 W/mK, about 14 W/mK to about 20 W/mK, about 16 W/mK to about 18 W/mK, about 16 W/mK to about 20 W/mk, or about 18 W/mK to about 20 W/mK, including increments therein. In some embodiments, the conductive epoxy has a thermal conductivity when cured of about 1 W/mk, about 2 W/mK, about 4 W/mK, about 6 W/mK, about 8 W/mK, about 10 W/mK, about 12 W/mK, about 14 W/mK, about 16 W/mK, about 18 W/mK, or about 20 W/mK. In some embodiments, the conductive epoxy has a thermal conductivity when cured of at least about 1 W/mK, about 2 W/mK, about 4 W/mk, about 6 W/mK, about 8 W/mK, about 10 W/mK, about 12 W/mK, about 14 W/mK, about 16 W/mK, or about 18 W/mK. In some embodiments, the conductive epoxy has a thermal conductivity when cured of at most about 2 W/mK, about 4 W/mK, about 6 W/mK, about 8 W/mK, about 10 W/mK, about 12 W/mK, about 14 W/mK, about 16 W/mK, about 18 W/mK, or about 20 W/mK. In some embodiments, the thermal conductivity is measured at room temperature.

In some embodiments, the conductive epoxy has a lap shear stress when cured of about 40 psi to about 3,000 psi. In some embodiments, the conductive epoxy has a lap shear stress when cured of about 40 psi to about 60 psi, about 40 psi to about 80 psi, about 40 psi to about 100 psi, about 40 psi to about 250 psi, about 40 psi to about 500 psi, about 40 psi to about 750 psi, about 40 psi to about 1,000 psi, about 40 psi to about 2,000 psi, about 40 psi to about 3,000 psi, about 60 psi to about 80 psi, about 60 psi to about 100 psi, about 60 psi to about 250 psi, about 60 psi to about 500 psi, about 60 psi to about 750 psi, about 60 psi to about 1,000 psi, about 60 psi to about 2,000 psi, about 60 psi to about 3,000 psi, about 80 psi to about 100 psi, about 80 psi to about 250 psi, about 80 psi to about 500 psi, about 80 psi to about 750 psi, about 80 psi to about 1,000 psi, about 80 psi to about 2,000 psi, about 80 psi to about 3,000 psi, about 100 psi to about 250 psi, about 100 psi to about 500 psi, about 100 psi to about 750 psi, about 100 psi to about 1,000 psi, about 100 psi to about 2,000 psi, about 100 psi to about 3,000 psi, about 250 psi to about 500 psi, about 250 psi to about 750 psi, about 250 psi to about 1,000 psi, about 250 psi to about 2,000 psi, about 250 psi to about 3,000 psi, about 500 psi to about 750 psi, about 500 psi to about 1,000 psi, about 500 psi to about 2,000 psi, about 500 psi to about 3,000 psi, about 750 psi to about 1,000 psi, about 750 psi to about 2,000 psi, about 750 psi to about 3,000 psi, about 1,000 psi to about 2,000 psi, about 1,000 psi to about 3,000 psi, or about 2,000 psi to about 3,000 psi, including increments therein. In some embodiments, the conductive epoxy has a lap shear stress when cured of about 40 psi, about 60 psi, about 80 psi, about 100 psi, about 250 psi, about 500 psi, about 750 psi, about 1,000 psi, about 2,000 psi, or about 3,000 psi. In some embodiments, the conductive epoxy has a lap shear stress when cured of at least about 40 psi, about 60 psi, about 80 psi, about 100 psi, about 250 psi, about 500 psi, about 750 psi, about 1,000 psi, or about 2,000 psi. In some embodiments, the conductive epoxy has a lap shear stress when cured of at most about 60 psi, about 80 psi, about 100 psi, about 250 psi, about 500 psi, about 750 psi, about 1,000 psi, about 2,000 psi, or about 3,000 psi.

In some embodiments, the conductive epoxy has a storage modulus when cured of about 200 MPa to about 3,000 MPa. In some embodiments, the conductive epoxy has a storage modulus when cured of about 200 MPa to about 400 MPa, about 200 MPa to about 600 MPa, about 200 MPa to about 800 MPa, about 200 MPa to about 1,000 MPa, about 200 MPa to about 1,500 MPa, about 200 MPa to about 2,000 MPa, about 200 MPa to about 2,500 MPa, about 200 MPa to about 3,000 MPa, about 400 MPa to about 600 MPa, about 400 MPa to about 800 MPa, about 400 MPa to about 1,000 MPa, about 400 MPa to about 1,500 MPa, about 400 MPa to about 2,000 MPa, about 400 MPa to about 2,500 MPa, about 400 MPa to about 3,000 MPa, about 600 MPa to about 800 MPa, about 600 MPa to about 1,000 MPa, about 600 MPa to about 1,500 MPa, about 600 MPa to about 2,000 MPa, about 600 MPa to about 2,500 MPa, about 600 MPa to about 3,000 MPa, about 800 MPa to about 1,000 MPa, about 800 MPa to about 1,500 MPa, about 800 MPa to about 2,000 MPa, about 800 MPa to about 2,500 MPa, about 800 MPa to about 3,000 MPa, about 1,000 MPa to about 1,500 MPa, about 1,000 MPa to about 2,000 MPa, about 1,000 MPa to about 2,500 MPa, about 1,000 MPa to about 3,000 MPa, about 1,500 MPa to about 2,000 MPa, about 1,500 MPa to about 2,500 MPa, about 1,500 MPa to about 3,000 MPa, about 2,000 MPa to about 2,500 MPa, about 2,000 MPa to about 3,000 MPa, or about 2,500 MPa to about 3,000 MPa, including increments therein. In some embodiments, the conductive epoxy has a storage modulus when cured of about 200 MPa, about 400 MPa, about 600 MPa, about 800 MPa, about 1,000 MPa, about 1,500 MPa, about 2,000 MPa, about 2,500 MPa, or about 3,000 MPa. In some embodiments, the conductive epoxy has a storage modulus when cured at least about 200 MPa, about 400 MPa, about 600 MPa, about 800 MPa, about 1,000 MPa, about 1,500 MPa, about 2,000 MPa, or about 2,500 MPa. In some embodiments, the conductive epoxy has a storage modulus when cured at most about 400 MPa, about 600 MPa, about 800 MPa, about 1,000 MPa, about 1,500 MPa, about 2,000 MPa, about 2,500 MPa, or about 3,000 MPa.

### Integrated Circuits and Methods of Forming Thereof

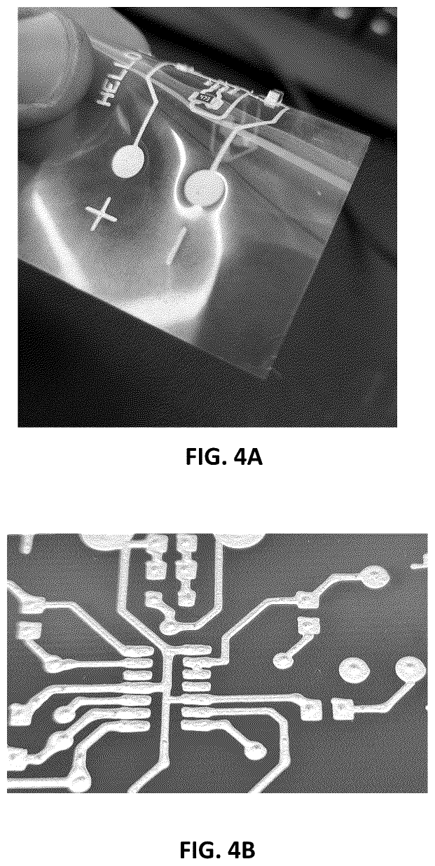

Another aspect provided herein is an integrated circuit comprising: (a) a first electronics component; (b) a second electronics component; and (c) the conductive epoxy herein conductively coupling at least a portion of the first electronics component to at least a portion of the second electronics component. FIGS. 4A-4B show images of an exemplary conductive epoxy forming an integrated circuit on a flexible substrate and on a printed circuit board (PCB) substrate, respectively.

Another aspect provided method of forming an integrated circuit, the method comprising: (a) receiving a first electronics component and a second electronics component; (b) applying the conductive epoxy herein to at least a first portion of the first electronics component, at least a second portion of the second electronics component, or both; (c) adjoining the first electronics component and the second electronics component at the first portion, the second portion, or both; and (d) curing the conductive epoxy. In some embodiments, step (d) is performed at room temperature. And suitable for bonding application of heat-sensitive devices. However, curing at high temperatures of two-part epoxy can speed up curing time and increase bonding performance, thermal properties, and electrical conductivity. In some embodiments, the method further comprises mixing a first part and a second part of the conductive epoxy before step (b).

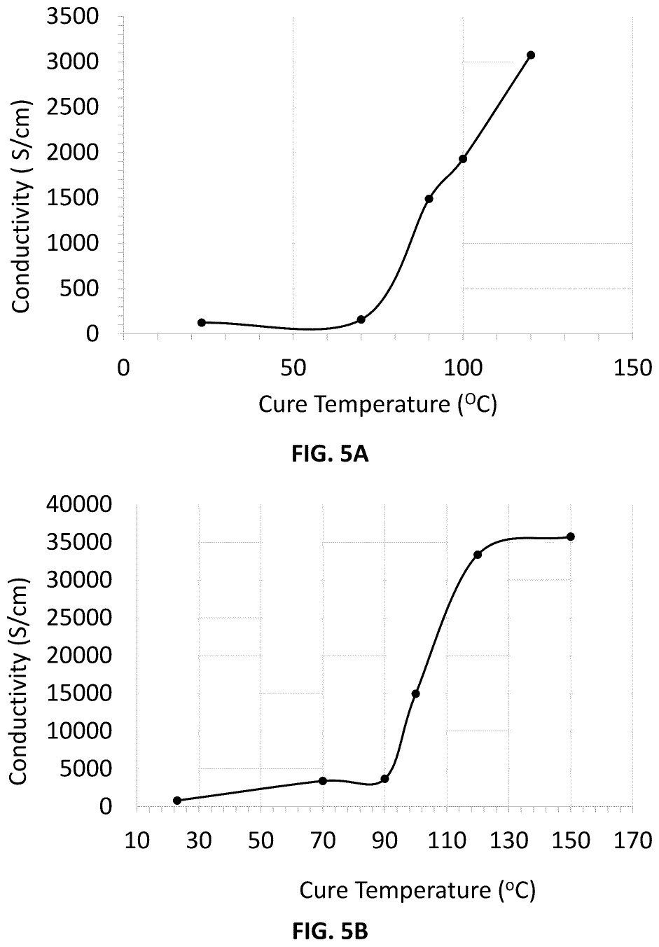

FIGS. 5A-5B show charts of cure conductivity vs. temperature for exemplary first and fifth conductive epoxy cured for two hours, respectively. As shown therein, a maximum conductivity of the exemplary cured epoxies is about 3,000 S/cm at curing temperatures of about 110° C. These cure temperatures are optimally below the threshold beyond which electronic components risk damage or degradation.

In some embodiments, step (d) is performed at a temperature of about 100° C. to about 200° C. In some embodiments, step (d) is performed at a temperature of about 100° C. to about 110° C., about 100° C. to about 120° C., about 100° C. to about 130° C., about 100° C. to about 140° C., about 100° C. to about 150° C., about 100° C. to about 160° C., about 100° C. to about 170° C., about 100° C. to about 180° C., about 100° C. to about 190° C., about 100° C. to about 200° C., about 110° C. to about 120° C., about 110° C. to about 130° C., about 110° C. to about 140° C., about 110° C. to about 150° C., about 110° C. to about 160° C., about 110° C. to about 170° C., about 110° C. to about 180° C., about 110° C. to about 190° C., about 110° C. to about 200° C., about 120° C. to about 130° C., about 120° C. to about 140° C., about 120° C. to about 150° C., about 120° C. to about 160° C., about 120° C. to about 170° C., about 120° C. to about 180° C., about 120° C. to about 190° C., about 120° C. to about 200° C., about 130° C. to about 140° C., about 130° C. to about 150° C., about 130° C. to about 160° C., about 130° C. to about 170° C., about 130° C. to about 180° C., about 130° C. to about 190° C., about 130° C. to about 200° C., about 140° C. to about 150° C., about 140° C. to about 160° C., about 140° C. to about 170° C., about 140° C. to about 180° C., about 140° C. to about 190° C., about 140° C. to about 200° C., about 150° C. to about 160° C., about 150° C. to about 170° C., about 150° C. to about 180° C., about 150° C. to about 190° C., about 150° C. to about 200° C., about 160° C. to about 170° C., about 160° C. to about 180° C., about 160° C. to about 190° C., about 160° C. to about 200° C., about 170° C. to about 180° C., about 170° C. to about 190° C., about 170° C. to about 200° C., about 180° C. to about 190° C., about 180° C. to about 200° C., or about 190° C. to about 200° C., including increments therein. In some embodiments, step (d) is performed at a temperature of about 100° C., about 110° C., about 120° C., about 130° C., about 140° C., about 150° C., about 160° C., about 170° C., about 180° C., about 190° C., or about 200° C. In some embodiments, step (d) is performed at a temperature of at least about 100° C., about 110° C., about 120° C., about 130° C., about 140° C., about 150° C., about 160° C., about 170° C., about 180° C., or about 190° C. In some embodiments, step (d) is performed at a temperature of at most about 110° C., about 120° C., about 130° C., about 140° C., about 150° C., about 160° C., about 170° C., about 180° C., about 190° C., or about 200° C.

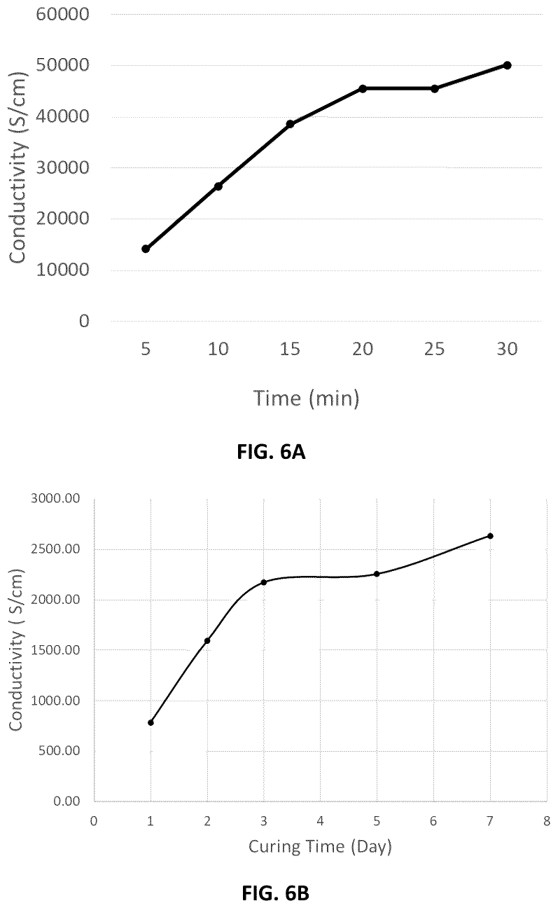

FIGS. 6A-6B show charts of conductivity vs. cure time for exemplary first and fifth conductive 2-part epoxies cured at a temperature of about 150° C. and about 23° C., respectively.

In some embodiments, step (d) is performed for a period of time of about 1 minute to about 60 minutes. In some embodiments, step (d) is performed for a period of time of about 1 minute to about 2 minutes, about 1 minute to about 5 minutes, about 1 minute to about 10 minutes, about 1 minute to about 20 minutes, about 1 minute to about 30 minutes, about 1 minute to about 40 minutes, about 1 minute to about 50 minutes, about 1 minute to about 60 minutes, about 2 minutes to about 5 minutes, about 2 minutes to about 10 minutes, about 2 minutes to about 20 minutes, about 2 minutes to about 30 minutes, about 2 minutes to about 40 minutes, about 2 minutes to about 50 minutes, about 2 minutes to about 60 minutes, about 5 minutes to about 10 minutes, about 5 minutes to about 20 minutes, about 5 minutes to about 30 minutes, about 5 minutes to about 40 minutes, about 5 minutes to about 50 minutes, about 5 minutes to about 60 minutes, about 10 minutes to about 20 minutes, about 10 minutes to about 30 minutes, about 10 minutes to about 40 minutes, about 10 minutes to about 50 minutes, about 10 minutes to about 60 minutes, about 20 minutes to about 30 minutes, about 20 minutes to about 40 minutes, about 20 minutes to about 50 minutes, about 20 minutes to about 60 minutes, about 30 minutes to about 40 minutes, about 30 minutes to about 50 minutes, about 30 minutes to about 60 minutes, about 40 minutes to about 50 minutes, about 40 minutes to about 60 minutes, or about 50 minutes to about 60 minutes, including increments therein. In some embodiments, step (d) is performed for a period of time of about 1 minute, about 2 minutes, about 5 minutes, about 10 minutes, about 20 minutes, about 30 minutes, about 40 minutes, about 50 minutes, or about 60 minutes. In some embodiments, step (d) is performed for a period of time of at least about 1 minute, about 2 minutes, about 5 minutes, about 10 minutes, about 20 minutes, about 30 minutes, about 40 minutes, or about 50 minutes. In some embodiments, step (d) is performed for a period of time of at most about 2 minutes, about 5 minutes, about 10 minutes, about 20 minutes, about 30 minutes, about 40 minutes, about 50 minutes, or about 60 minutes.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about,” “substantially,” or “approximately” in reference to an amount indicates that the amount can be greater or less than the stated amount by 10%, 5%, or 1%, including increments therein, relative to the amount and includes the amount itself.

As used herein, the term “including increments therein” refers to the addition of values between two listed amounts in 1%, 2%, 3%, 4%, 5%, or 10% increments.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

As used herein, the term “non-reactive” refers to a component having a boiling temperature of less than about 200° C., 180° C., 160° C., 140° C., 120° C., 100° C., or 90° C., including increments therein.

As used herein, the term “reactive” refers to a component having a boiling temperature of more than about 200° C., 180° C., 160° C., 140° C., 120° C., 100° C., or 90° C., including increments therein.

As used herein, the terms “inert” and “non-reactive” are used interchangeably. The component that is inert or non-reactive may not react (i.e., 0% of the component) with other components, or is minimally reactive (e.g., about 1%, about 2%, about 3%, about 4%, or about 5% by concentration of the component).

### EXAMPLES

The following illustrative examples are representative of embodiments of the systems and methods described herein and are not meant to be limiting in any way.

Exemplary one-part epoxies 1-10 were formed per Table 1 below, wherein the values represent mass percentages.

TABLE 1
Formulation Mass Percentages (wt %)

| | | | | | | | | | | | Working |
|---|---|---|---|---|---|---|---|---|---|---|---|
| | | | | | | | | | | | Range |
| Raw Materials | 1 | 2 | 3 | 4 | 5 | 6 | 7 | 8 | 9 | 10 | (wt %) |
| resorcinol | 9.60% | 9.60% | 9.60% | 9.60% | 9.60% | 9.60% | 0.00% | 0.00% | 0.00% | 0.00% | 8-11% |
| diglycidyl | | | | | | | | | | | |
| diglycidyl | | | | | | | | | | | |
| ether + latent | | | | | | | | | | | |
| curing agent | | | | | | | | | | | |
| diglycidyl | 0.00% | 0.00% | 0.00% | 0.00% | 0.00% | 0.00% | 9.60% | 0.00% | 0.00% | 0.00% | 8-11% |
| ether of | | | | | | | | | | | |
| Bisphenol | | | | | | | | | | | |
| A/F + 2- | | | | | | | | | | | |
| ethylhexyl | | | | | | | | | | | |
| glycidyl ether | | | | | | | | | | | |
| diglycidyl | 0.00% | 0.00% | 0.00% | 0.00% | 0.00% | 0.00% | 0.00% | 4.80% | 4.80% | 4.80% | 4-6% |
| ether of | | | | | | | | | | | |
| Bisphenol F | | | | | | | | | | | |
| diglycidyl | 0.00% | 0.00% | 0.00% | 0.00% | 0.00% | 0.00% | 0.00% | 4.80% | 4.80% | 4.80% | 4-6% |
| ether of | | | | | | | | | | | |
| Bisphenol A | | | | | | | | | | | |
| Liquid | 11.86% | 0.00% | 2.82% | 9.04% | 9.04% | 5.08% | 9.71% | 11.86% | 11.86% | 11.86% | 1-15% |
| Hydrocarbon | | | | | | | | | | | |
| Resin | | | | | | | | | | | |
| methyl ethyl | 0.00% | 6.59% | 5.48% | 0.00% | 0.00% | 0.00% | 0.00% | 0.00% | 0.00% | 0.00% | 4-7% |
| ketone | | | | | | | | | | | |
| Benzyl alcohol | 0.00% | 0.00% | 0.00% | 0.00% | 0.00% | 11.86% | 0.00% | 1.69% | 7.91% | 3.46% | 0.5-15% |
| Silver Flakes | 78.51% | 38.41% | 60.72% | 78.51% | 78.51% | 0.00% | 73.42% | 84.16% | 95.45% | 95.45% | 30-99% |
| Silver-Cu | 0.00% | 0.00% | 0.00% | 0.00% | 0.00% | 47.84% | 0.00% | 0.00% | 0.00% | 0.00% | 40-60% |
| Ultra-Graphene | 0.03% | 0.00% | 0.02% | 0.03% | 0.03% | 0.04% | 0.04% | 0.03% | 0.03% | 0.02% | 0.01-0.1% |
| tributyl(ethyl) | 0.00% | 0.00% | 0.00% | 1.03% | 2.06% | 0.00% | 0.00% | 0.00% | 0.00% | 0.62% | 0.1-2% |
| phosphonium | | | | | | | | | | | |
| diethyl | | | | | | | | | | | |
| phosphate | | | | | | | | | | | |
| Modified | 0.00% | 0.00% | 0.00% | 0.00% | 0.00% | 0.00% | 0.96% | 0.24% | 0.24% | 0.24% | 0.1-2% |
| Polyamine | | | | | | | | | | | |
| Dicyandiamide | 0.00% | 0.00% | 0.00% | 0.00% | 0.00% | 0.00% | 0.00% | 0.72% | 0.72% | 0.72% | 0.1-2% |
| CTBN- | 0.00% | 0.00% | 0.00% | 4.52% | 4.52% | 0.00% | 0.00% | 0.00% | 0.00% | 2.49% | 1-7.5% |
| Toughened | | | | | | | | | | | |
| Epoxidized | | | | | | | | | | | |
| Neopentyl | | | | | | | | | | | |
| Glycol Adduct | | | | | | | | | | | |

The electromechanical properties of the exemplary one-part conductive epoxies per Table 1 above are shown in Table 2. Additionally, the electrical conductivity, thermal conductivity and lap shear strength are shown in FIGS. 11-13.

TABLE 2
Formulation Properties

| Property | Units | 1 | 2 | 3 | 4 | 5 |
|---|---|---|---|---|---|---|
| Viscosity | s−1 | 369.10 | | | | |
| Volume | Ohm*m | 0.003700 | 0.023275 | 0.012400 | 0.002500 | 0.003400 |
| Resistivity | | | | | | |
| Electrical | S/cm | 27027.00 | 5427.50 | 8064.50 | 40000.00 | 29411.80 |
| Conductivity | | | | | | |
| Thermal | W/mK | 11.96 | 8.40 | | 14.31 | 10.96 |
| Conductivity | | | | | | |
| Lap Shear | psi | 575.80 | 1146.40 | 477.20 | 684.60 | 722.20 |
| Strength | | | | | | |
| Thixotropic | N/A | 4.13 | 3.03 | | 6.01 | 5.42 |
| Index | | | | | | |

| | | | | | | Working |
|---|---|---|---|---|---|---|
| Property | 6 | 7 | 8 | 9 | 10 | Range |
| Viscosity | | | 507.89 | 154.43 | | 300-600 |
| Volume | 0.118600 | 0.084100 | 0.037000 | 0.016800 | 0.006300 | 0.002-.02 |
| Resistivity | | | | | | |
| Electrical | 843.20 | 1189.06 | 2702.70 | 5952.38 | 15873.02 | 800-45000 |
| Conductivity | | | | | | |
| Thermal | | | 5.41 | 5.77 | | 5-15 |
| Conductivity | | | | | | |
| Lap Shear | 50.00 | | 1482.29 | 310.00 | 710.68 | 30-1750 |
| Strength | | | | | | |
| Thixotropic | | | 4.87 | 4.56 | 5.68 | 2-7 |
| Index | | | | | | |

Exemplary two-part epoxies 1-4 were formed per Table 3 below, wherein the values represent mass percentages.

TABLE 3
Formulation Mass (wt. %)

| | | | | | | | | | Working |
|---|---|---|---|---|---|---|---|---|---|
| Raw Materials | 1A | 1B | 2A | 2B | 3A | 3B | 4A | 4B | Range |
| diglycidyl ether of | 10.85 | 0 | 12.21 | 0 | 8.66 | 0 | 11.47 | 0 | 5-20 |
| Bisphenol A | | | | | | | | | |
| Blend of diglycidyl ether | 0 | 0 | 0 | 0 | | 0 | 0 | 0 | 5-20 |
| of Bisphenol A and F | | | | | | | | | |
| with reactive diluent | | | | | | | | | |
| 2-ethylhexyl glycidyl | 1.35 | 0 | 0 | 0 | 1.08 | 0 | 0 | 0 | 0-5 |
| ether (EHGE) | | | | | | | | | |
| Liquid Hydrocarbon | 9.75 | 9.75 | 9.75 | 14.57 | 9.85 | 9.85 | 6.1 | 6.1 | 5-15 |
| Resin | | | | | | | | | |
| benzyl alcohol | 0 | 0 | 0 | 0 | 0 | 0 | 9.15 | 9.15 | 0-10 |
| Ag flakes | 78 | 78 | 78 | 78 | 80.37 | 80.37 | 73.24 | 73.24 | 65-90 |
| Ultra-Graphene | 0.05 | 0.05 | 0.05 | 0.05 | 0.031 | 0.031 | 0.031 | 0.031 | 0.01-0.5 |
| Modified cycloaliphatic | | 12.21 | 0 | 7.39 | 0 | 2.58 | 0 | 0 | 0-20 |
| polyamine | | | | | | | | | |
| Modified aliphatic amine | 0 | 0 | 0 | 0 | 0 | 0 | 0 | 11.47 | 0-20 |
| Phenalkamine-based | 0 | 0 | 0 | 0 | 0 | 7.165 | 0 | 0 | 0-20 |
| modified polyamine | | | | | | | | | |
| Modified amine | 0 | 0 | 0 | 0 | 0 | 0 | 0 | 0 | 0-20 |
| CTBN-Toughened | 0 | 0 | 0 | 0 | 0 | 0 | 0 | | 2-10 |
| Epoxidized Neopentyl | | | | | | | | | |
| Glycol Adduct | | | | | | | | | |
| Amine-terminated | 0 | 0 | 0 | 0 | 0 | 0 | 0 | 0 | 2-5 |
| butadiene-acrylonitrile | | | | | | | | | |
| copolymer | | | | | | | | | |
| Ratio (A:B) | 1 | 1 | 1 | 1 | 1 | 1 | 2 | 1 | 1:1-2:1 |

Exemplary two-part epoxies 5-8 were formed per Table 4 below, wherein the values represent mass percentages.

TABLE 4
Formulation Mass (wt. %)

| | | | | | | | | | Working |
|---|---|---|---|---|---|---|---|---|---|
| Raw Materials | 5A | 5B | 6A | 6B | 7A | 7B | 8A | 8B | Range |
| diglycidyl ether of | 10.51 | 0.00 | 10.47 | 0.00 | 0.00 | 0.00 | 0.00 | 0.00 | 5-20 |
| Bisphenol A | | | | | | | | | |
| Blend of diglycidyl ether | 0.00 | 0.00 | 0.00 | 0.00 | 18.18 | 0.00 | 11.03 | 0.00 | 5-20 |
| of Bisphenol A and F | | | | | | | | | |
| with reactive diluent | | | | | | | | | |
| 2-ethylhexyl glycidyl | 1.31 | 0.00 | 1.31 | 0.00 | 0.00 | 0.00 | 0.00 | 0.00 | 0-5 |
| ether (EHGE) | | | | | | | | | |
| Liquid Hydrocarbon | 6.30 | 6.10 | 9.40 | 8.85 | 3.43 | 3.43 | 9.65 | 12.20 | 5-15 |
| Resin | | | | | | | | | |
| benzyl alcohol | 6.30 | 9.15 | 0.00 | 5.90 | 0.00 | 0.00 | 0.00 | 0.00 | 0-10 |
| Ag flakes | 75.55 | 73.24 | 75.24 | 70.80 | 78.40 | 78.40 | 79.27 | 77.04 | 65-90 |
| Ultra-Graphene | 0.031 | 0.031 | 0.050 | 0.050 | 0.000 | 0.000 | 0.050 | 0.050 | 0.01-0.5 |
| Modified cycloaliphatic | 0.00 | 0.00 | 0.00 | 11.08 | 0.00 | 0.00 | | 0.00 | 0-20 |
| polyamine | | | | | | | | | |
| Modified aliphatic amine | 0.00 | 11.47 | 0.00 | 0.00 | 0.00 | 0.00 | 0.00 | 0.00 | 0-20 |
| Phenalkamine-based | 0.00 | 0.00 | 0.00 | 0.00 | 0.00 | 0.00 | 0.00 | 0.00 | 0-20 |
| modified polyamine | | | | | | | | | |
| Modified amine | 0.00 | 0.00 | 0.00 | 0.00 | 0.00 | 18.18 | 0.00 | 10.72 | 0-20 |
| CTBN-Toughened | 0.00 | 0.00 | 3.52 | 0.00 | 0.00 | 0.00 | 0.00 | 0.00 | 2-10 |
| Epoxidized Neopentyl | | | | | | | | | |
| Glycol Adduct | | | | | | | | | |
| Amine-terminated | 0.00 | 0.00 | 0.00 | 3.32 | 0.00 | 0.00 | 0.00 | 0.00 | 2-5 |
| butadiene-acrylonitrile | | | | | | | | | |
| copolymer | | | | | | | | | |
| Ratio (A:B) | 2 | 1 | 1 | 1 | 2 | 1 | 2 | 1 | 2:1-1:1 |

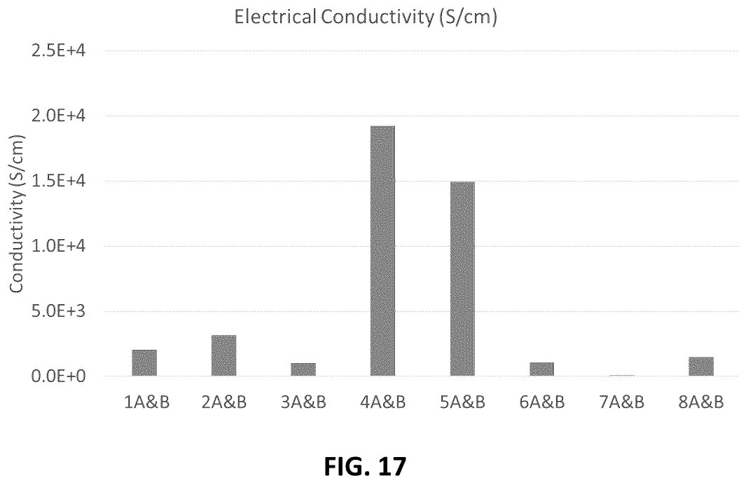

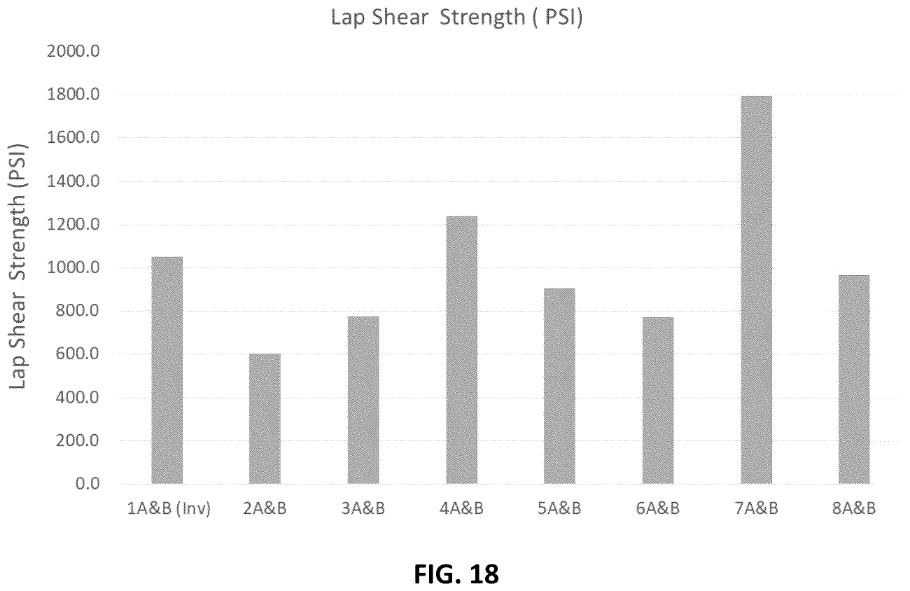

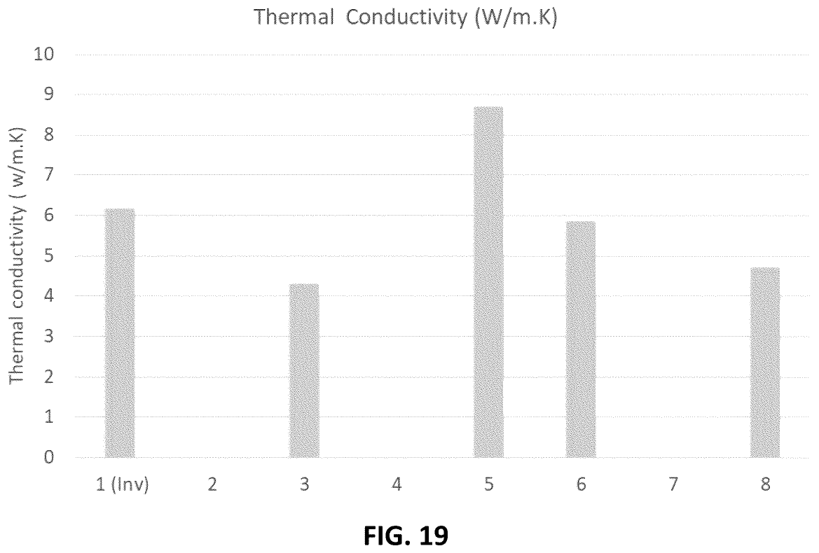

The electromechanical properties of the exemplary two-part conductive epoxies per Tables 3 and 4 above are shown in Table 5 below. Additionally, the electrical conductivity, thermal conductivity and lap shear strength for the exemplary two-part conductive epoxies are shown in FIGS. 17-19.

TABLE 5
2-Part Formulation Properties

| | | | | | | | | | | Working |
|---|---|---|---|---|---|---|---|---|---|---|
| Property | Units | 1 | 2 | 3 | 4 | 5 | 6 | 7 | 8 | Range |
| Cure Temp | C. | 120 | 120 | 120 | 90 | 90 | 120 | 120 | 120 | 90-120 |
| Cure Time | h | 2 | 2 | 2 | 2 | 1 | 2 | 2 | 2 | 1-2 |
| Film | μm | 37 | 30 | 90 | 64 | 75 | 90 | 85 | 75 | 20-100 |
| Thickness | | | | | | | | | | |
| Resistivity | mΩ*m | 42.40 | 42.40 | 42.40 | 84.00 | 84.00 | 42.40 | 84.00 | 84.00 | 30-100 |
| Conductivity | S/cm | 2045 | 3145 | 1034 | 19231 | 14925 | 1068 | 93 | 1454 | 90-25000 |
| Thermal | W/mk | 6.2 | — | 4.3 | — | 8.7 | 5.8 | — | 4.7 | 4-9 |
| Conductivity | | | | | | | | | | |
| Lap Shear | psi | 1048.6 | 600.5 | 773.1 | 1235.7 | 903.6 | 768.7 | 1791.2 | 964.5 | 500-2000 |
| Strength | | | | | | | | | | |

The components of exemplary one-part conductive epoxies per Table 1 above are shown in Table 6 below.

TABLE 6

| Component | Material | Chemical Name |
|---|---|---|
| Epoxy 1 | H61-110 | resorcinol diglycidyl diglycidyl |
| | | ether + latent curing agent |
| Epoxy 2 | Epikote | diglycidyl ether of Bisphenol |
| | Resin 240 | A/F + 2-ethylhexyl glycidyl ether |
| Epoxy 3 | Epon Resin 862 | diglycidyl ether of Bisphenol F |
| Epoxy 4 | Devcon A | diglycidyl ether of Bisphenol A |
| Non-Reactive | Liquid | 4,4′-dimethyl-2,2-diphenylpropane |
| Diluent | Hydrocarbon | |
| | Resin | |
| Solvent 1 | MEK^{a} | methyl ethyl ketone |
| Solvent 2 | Benzyl Alchol | Benzyl Alchol |
| Conductive Filler | Silver Flake | Conductive Additive |
| Conductive Filler | Silver —Cu | Conductive Additive |
| Conductive Filler | Ultra-Graphene | Conductive Additive |
| Ionic Liquid | Cyphos IL 169 | tributyl(ethyl) phosphonium |
| | | diethyl phosphate |
| Curing Agent 1 | Anicimine 2441 | Modified Polyamine |
| Curing Agent 2 | Dicyanex 1400B | Dicyandiamide |
| Strength Additive | Hypox RM 20 | CTBN-Toughened Epoxidized |
| | | Neopentyl Glycol Adduct |

^{a}MEK = methyl ethyl ketone

The components exemplary two-part conductive epoxies per Tables 3-4 above are shown in Table 7 below.

TABLE 7

| Component | Material | Chemical Name |
|---|---|---|
| Epoxy Resin I | Devcon A | diglycidyl ether of Bisphenol A |
| Epoxy Resin II | Epokite Resin 240 | Blend of diglycidyl ether of Bisphenol A and F with |
| | | reactive diluent |
| Reactive Diluent | Epodil 746 | 2-ethylhexyl glycidyl ether (EHGE) |
| Non-reactive Diluent | Liquid Hydrocarbon | 4,4′-dimethyl-2,2-diphenylpropane |
| | Resin | |
| Solvent | benzyl alcohol | benzyl alcohol |
| Conductive Filler I | Ag flakes | Ag flakes |
| Conductive Filler IV | Ultra-Graphene | Ultra-Graphene |
| Hardener, Curing | Ancamine 1618 | Modified cycloaliphatic polyamine |
| Agent I | | |
| Hardener, Curing | Ancamine 2914UF | Modified aliphatic amine |
| Agent II | | |
| Hardener, Curing | Sunmide CX 1151 | Phenalkamine-based modified polyamine |
| Agent III | | |
| Hardener, | Epicure 580 | Modified amine |
| Curing Agent IV | | |
| Additive I | Hypox RM 20 | CTBN-Toughened Epoxidized Neopentyl Glycol |
| | | Adduct |
| Additive II | Hypro 1300X16 | Amine-terminated butadiene-acrylonitrile |
| | ATBN | copolymer |

### First Exemplary One-Part Epoxy

A graphene-powered electrically and thermally conductive epoxy composition was prepared by mixing 9.6% by mass of an epoxy resin with a latent curing agent (H61-110, manufactured by Epoxy Technology), 11.9% by mass of long chain hydrocarbon based non-reactive diluent as plasticizer (LV5, manufactured by Evonik), 0.03% by mass of ultra-graphene (Ultra-Graphene, manufactured by Nanotech Energy CO., LTD), and 78.5% by mass of a silver flakes (5-8 microns) (47MR-11F, manufactured by Inframat Chemical Co., Ltd.).

At first, ultra-graphene was exfoliated into the non-reactive diluent/plasticizer LV5 by high shear mixing at 10,000 rpm. Then, H61-110 epoxy resin and exfoliated graphene dispersion in LV5 were charged into the glass reactor or MTI planetary mixer reactor. After 30 minutes of thorough mixing, silver flakes are charged slowly into the reactor within 15 minutes. Then, the mixing process was continued for another 1 hr below room temperature under vacuum using overhead mixer/planetary mixer. Next, the final prepared electrically conductive adhesive composition was applied on a polyethylene terephthalate film having a thickness of 100 um. The resultant was subjected to a heat treatment in a conventional oven of 150° C. for 30 minutes to form a film. As a result, an electrically conductive adhesive film was formed.

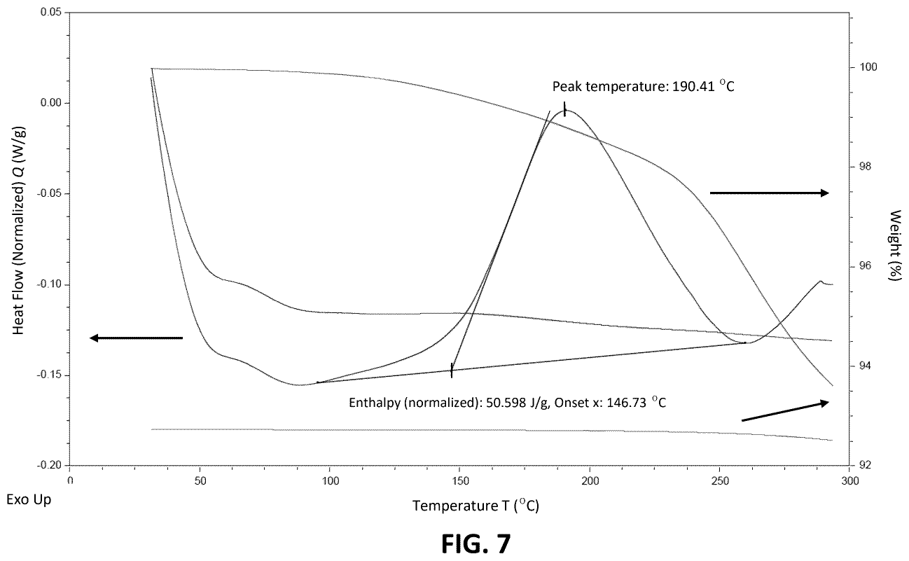

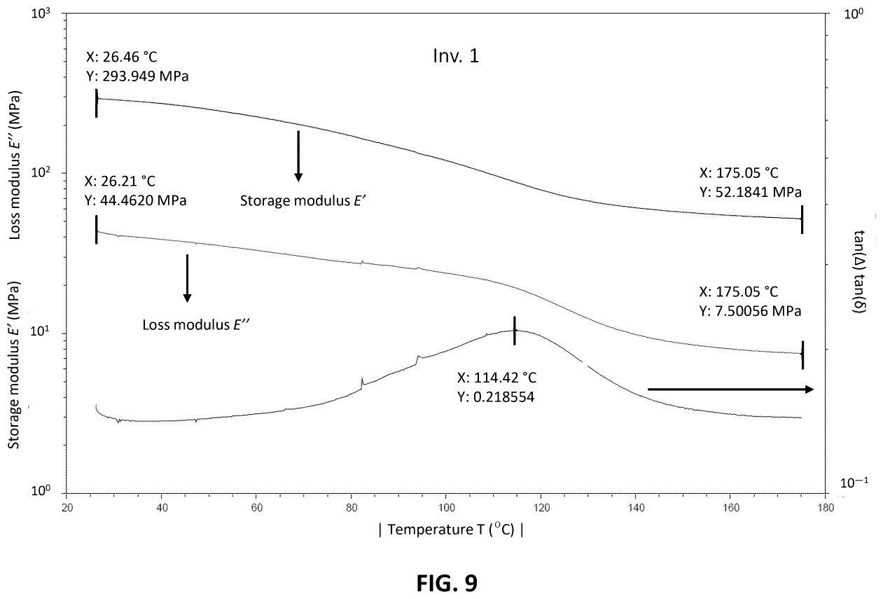

Thermograms for the first exemplary one-part epoxy were obtained. FIG. 7 shows differential scanning calorimetry (DSC) and thermogravimetric analysis (TGA) thermograms of the first exemplary one-part epoxy. FIG. 9 shows the dynamic mechanical analysis of the first exemplary one-part epoxy.

### Second Exemplary One-Part Epoxy

An electrically and thermally conductive epoxy composition was prepared by mixing 17.59% by mass of an epoxy resin with latent curing agent (H61-110, manufactured by Epoxy Technology), 12.07% by mass of MEK solvent (MEK, manufactured by Sigma Aldrich and 70% by mass of a silver flakes (5-8 microns) (47MR-11F, manufactured by Inframat Chemical Co., Ltd.) in the glass reactor or MTI planetary mixer.

First, H61-110 epoxy resin was dissolved in MEK completely within 15 minutes. Silver flakes were charged slowly into the reactor within 15 minutes. Then, the reaction mixture was agitated thoroughly for 60 minutes. Then, vacuum was employed at the last 5 min to remove trapped air bubbles with continuous stirring using overhead stirrer/planetary mixer. The final prepared electrically conductive adhesive composition was applied on a polyethylene terephthalate film having a thickness of 100 um. The resultant film was subjected to a heat treatment in a conventional oven of 120° C. for 30 minutes to form a cured film. As a result, an electrically conductive adhesive film was formed.

### Third Exemplary One-Part Epoxy

An exemplary second graphene-based conductive epoxy composition was prepared with the diluent used in the first exemplary one-part epoxy and the solvent in the second exemplary one-part epoxy. Instead of using non-reactive diluent in the first exemplary one-part epoxy and low boiling point solvent in the second exemplary one-part epoxy, both low boiling point solvent and non-reactive diluent are added in the formulation.

### Fourth and Fifth Exemplary One-Part Epoxies

The same process was followed as in previous Exemplary One-part epoxies 1-3, for the preparation of ECA. In the fourth and fifth exemplary one-part epoxies, carboxyl-terminated butadiene acrylonitrile (CTBN) toughening epoxidized neopentyl glycol adduct and phosphonium ionic liquid was added to enhance the electrical, thermal, and mechanical properties of ECA with varied amounts of the ionic liquid. The ionic liquid acts as a dispersing agent as well as latent curing agent while CTBN toughening epoxidized neopentyl glycol adduct helps to enhance the flexibility of the ECA to enhance the electrical, thermal, and mechanical properties of the epoxy.

The exemplary fourth and fifth one-part epoxies were applied on a polyethylene terephthalate film having a wet thickness of 100 um. The resultant film was subjected to a heat treatment in an oven at 150° C. for 30 minutes to form a cured film.

### Sixth Exemplary One-Part Epoxy

In the sixth exemplary one-part epoxy, the silver flakes in the third exemplary one-part epoxy were replaced with a silver-copper composite.

### Seventh and Eighth Exemplary One-Part Epoxies

Seventh and eighth conductive epoxies were prepared by mixing two different epoxy resins, a latent curing agent, a latent curing accelerator, a non-reactive diluent, silver flakes, and ultra-graphene. Long chain hydrocarbon based non-reactive diluent was added as plasticizer.

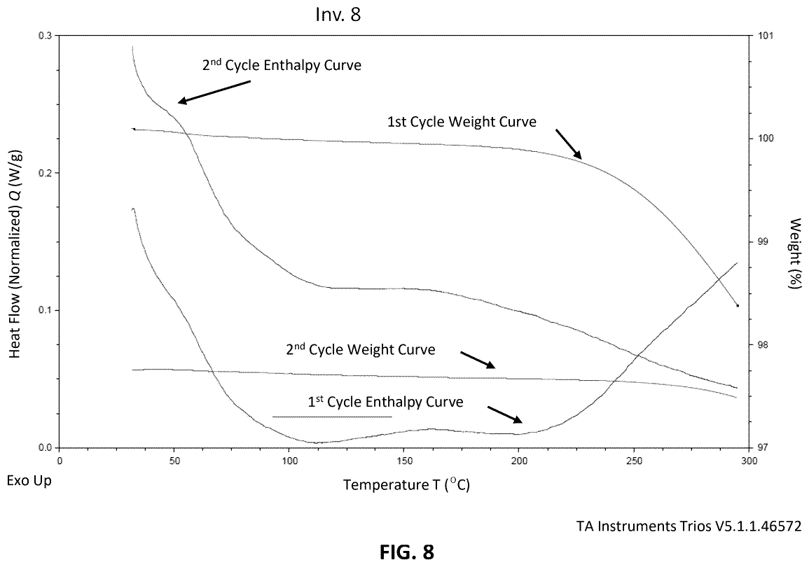

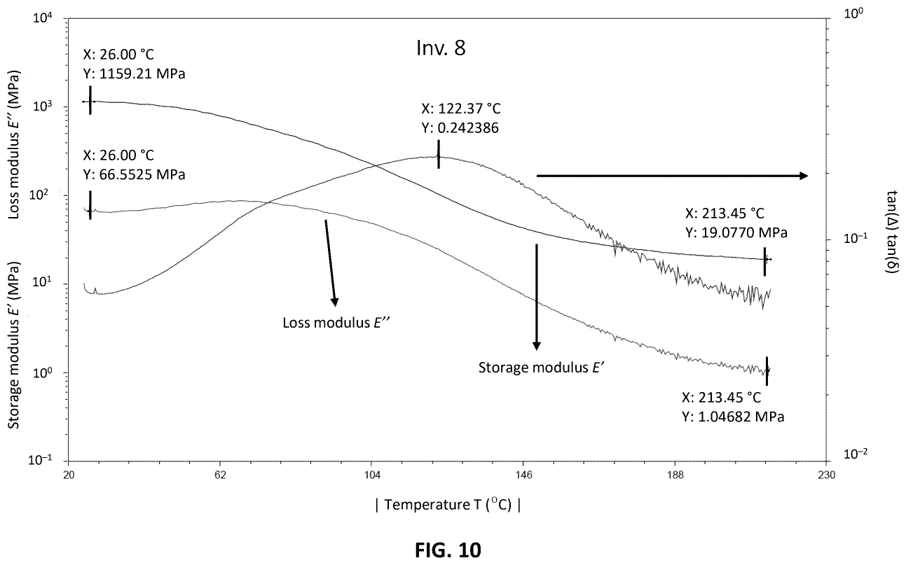

Thermograms for the eighth exemplary one-part epoxy were obtained. FIG. 8 shows differential scanning calorimetry (DSC) and thermogravimetric analysis (TGA) thermograms of the eighth exemplary one-part epoxy. FIG. 10 shows the dynamic mechanical analysis of the eighth exemplary one-part epoxy.

### Ninth Exemplary One-Part Epoxy

The ninth exemplary one-part epoxy increases the silver content of the eighth exemplary one-part epoxy. The amount of silver flakes was increased in Example 9 relative to Example 8.

The final prepared electrically conductive adhesive composition was applied on a polyethylene terephthalate film having a wet thickness of 100 um. The resultant film was subjected to a heat treatment in an oven of 150° C. for 30 minutes to form a cured film. As a result, an electrically conductive adhesive film was formed.

### Tenth Exemplary One-Part Epoxy

In the tenth exemplary one-part epoxy CTBN toughen epoxidized neopentyl glycol adduct and phosphonium ionic liquid were added. These additives are found to be effective to further enhance the electrical, thermal, and mechanical properties of ECA. Ionic liquid acts as a dispersing agent as well as a latent curing agent. CTBN toughen epoxidized neopentyl glycol adduct helps to enhance the flexibility of the ECA. Combination of both enhances electrical, thermal, and mechanical properties. The tenth exemplary one-part epoxy was applied on a polyethylene terephthalate film having a wet thickness of 100 um. The resultant was subjected to a heat treatment in an oven at 150° C. for 30 minutes to form a film.

### First Exemplary Two-Part Epoxy

A first exemplary two-part epoxy was prepared by mixing 10.85% by mass of an epoxy resin (diglycidyl ether of Bisphenol A, manufactured by Devcon, ITW Global), 1.35% Epodil 746 (2-ethylhexyl glycidyl ether (EHGE), manufactured by Evonik), 9.75% by mass of long chain hydrocarbon based non-reactive diluent as plasticizer (LV5, manufactured by Evonik), 0.05% by mass of ultra-graphene (Ultra-Graphene, manufactured by Nanotech Energy CO., LTD), and 78.0% by mass of a silver flakes (5-8 microns) (47MR-11F, manufactured by Inframat Chemical Co., Ltd.). The graphene was exfoliated into the non-reactive diluent/plasticizer LV5 by high shear mixing at 10,000 rpm. Then, diglycidyl ether of Bisphenol A epoxy resin, 2-ethylhexyl glycidyl ether as reactive diluent and exfoliated graphene dispersion in LV5 were charged into the glass reactor or MTI planetary mixer/reactor. After 30 minutes thorough mixing, silver flakes are charged slowly into the reactor within 15 minutes. Then, the mixing process was continued for another 1 h below room temperature under vacuum using overhead mixer/planetary mixer.

The same process was repeated for the formulation of part B (Epoxy harder). Instead of diglycidyl ether of Bisphenol A and 2-ethylhexyl glycidyl ether (reactive diluent), modified cycloaliphatic polyamine (Ancamine 1618 from Evonik) was used as a hardener for part B of the two-part ECA.

Next, the first exemplary two-part epoxy was prepared by thoroughly mixing part A and part B in 1:1 weight or volume, and applying the mixture on a few polyethylene terephthalate films having a thickness of around 100 μm. The resultant film was subjected to a heat treatment in a conventional oven at different temperature from 70 to 150° C. for 2 hours to form a cured film.

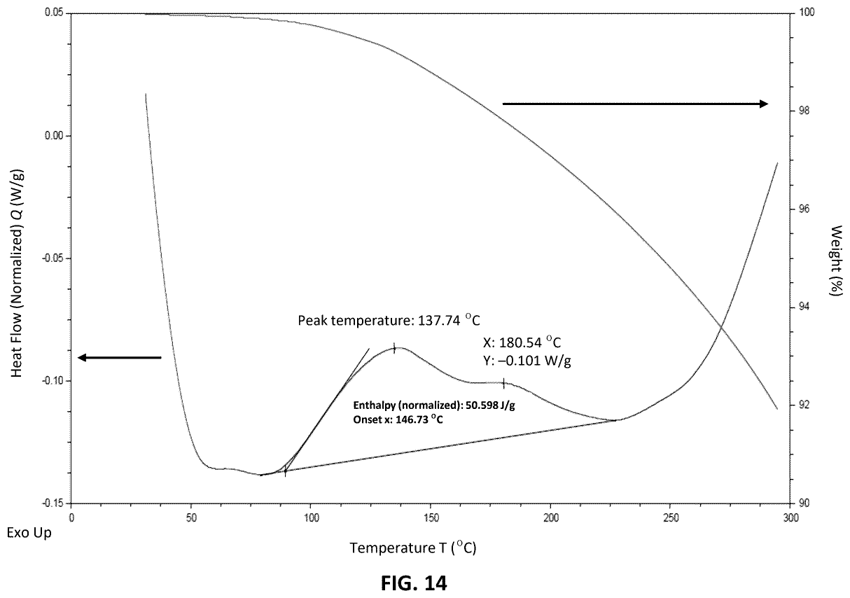

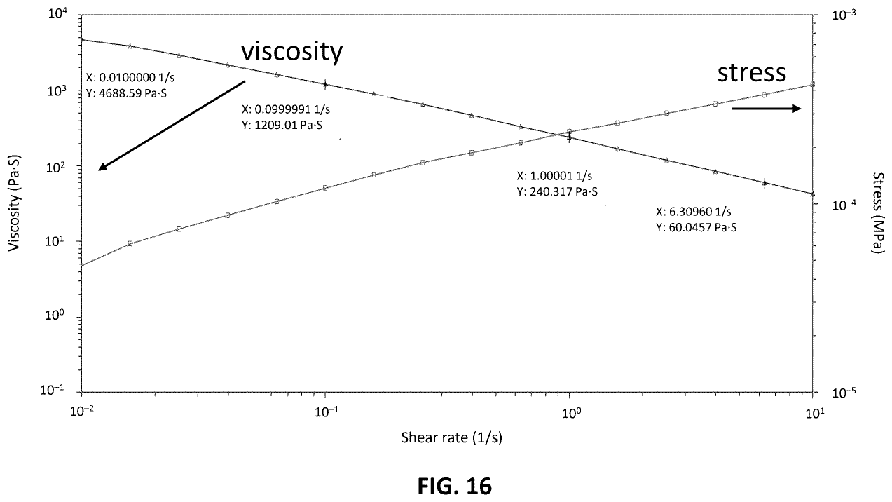

FIG. 14 shows DSC and TGA thermograms for the first exemplary two-part epoxy. FIG. 16 shows a viscosity and stress curves versus shear rate for the first exemplary two-part epoxy after the mixing operations described above.

### Second Exemplary Two-Part Epoxy

A second exemplary two-part epoxy was formed congruently to the first exemplary two-part epoxy, but without the reactive diluent, 2-ethylhexyl glycidyl ether, in part A, and with different concentrations of the non-reactive diluent and modified cycloaliphatic polyamine in part B to control the viscosity and balance the stoichiometric ratio.

Next, the finally prepared electrically conductive adhesive composition of part A and part B in 1:1 weight or volume ratio was mixed thoroughly and applied on a polyethylene terephthalate film having a thickness of around 100 μm. The resultant film was subjected to a heat treatment in a conventional oven at 120° C. for 1 hour to form a cured film. As a result, an electrically conductive adhesive film was formed.

### Third Exemplary Two-Part Epoxy

A third exemplary two-part epoxy was formed congruently to the first exemplary two-part epoxy, but the cycloaliphatic polyamine and Phenylamine-based modified polyamine (Sunmide CX 1151 from Evonik) were used as hardener instead of the modified cycloaliphatic polyamine (Ancamine 1618 from Evonik), and the amount of silver flakes and the non-reactive diluent are slightly increased for both parts A and B to control the desired viscosity and electrical conductivity.

### Fourth and Fifth Exemplary Two-Part Epoxies

Fourth and fifth exemplary two-part epoxies were formed congruently to the first exemplary two-part epoxy, but with the addition of CTBN-Toughened Epoxidized Neopentyl Glycol Adduct, and with a modified aliphatic amine strength additive in part B instead of the cycloaliphatic polyamine and Phenalkamine-based modified polyamine strength additives.

Parts A and B of the fourth and fifth exemplary two-part epoxies were mixed, respectively, in a 2:1 weight or volume ratio. The fourth and fifth exemplary two-part epoxies were applied on polyethylene terephthalate films and cured at 90° C. and at 70-120° C., respectively.

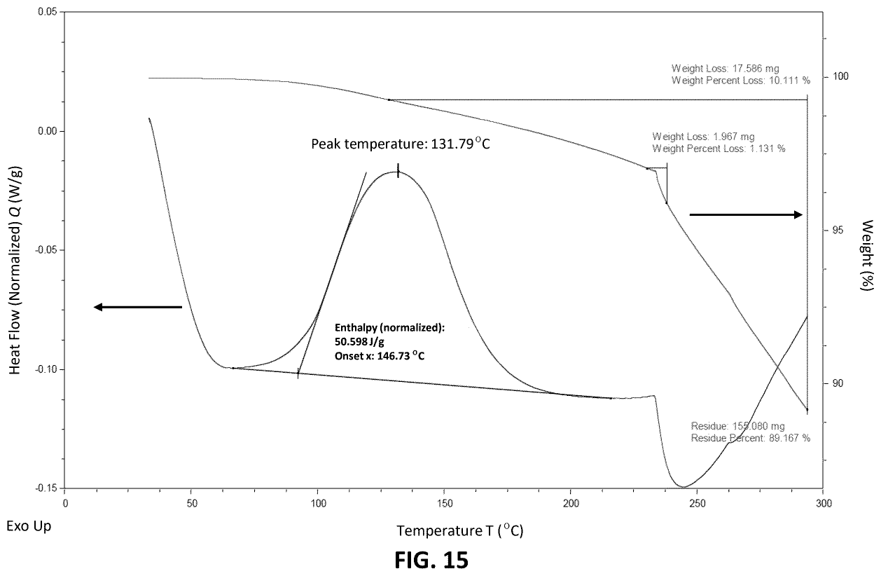

FIG. 15 shows DSC and TGA thermograms for the fifth exemplary two-part epoxy.

### Sixth Exemplary Two-Part Epoxy

A sixth exemplary two-part epoxy was formed congruently to the fifth exemplary two-part epoxy, with the addition of an amine-terminated butadiene-acrylonitrile copolymer. Parts A and B of the sixth exemplary two-part epoxy were mixed in a 1:1 weight or volume ratio and applied on a polyethylene terephthalate film having a thickness of around 100 μm and cured in a conventional oven at 120° C. for 2 hours.

### Seventh and Eighth Exemplary Two-Part Epoxies

Seventh and eighth exemplary two-part epoxies were formed of diglycidyl ether of Bisphenol A and F with reactive diluent (Epikote Resin 240 from Westlake) and modified amine (Epicure 580) from Hexion for part B. The seventh exemplary two-part epoxy contained more silver than the eighth exemplary two-part epoxy. Parts A and B of the seventh and eighth exemplary two-part epoxies were mixed, respectively, applied on a polyethylene terephthalate film having a thickness of around 100 μm and cured in an oven of 120° C. for 30 minutes to form a cured film.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

1. A 1-part conductive epoxy comprising:
an epoxy resin;
a diluent comprising a low-viscosity hydrocarbon;
silver; and
graphene.

2. The 1-part conductive epoxy of claim 1, wherein the epoxy resin comprises one or more components selected from the group consisting of:
a resorcinol diglycidyl ether epoxy resin,
a diglycidyl ether of Bisphenol A, and
a diglycidyl ether of Bisphenol F.

3. The 1-part conductive epoxy of claim 1, wherein the low-viscosity hydrocarbon of the diluent comprises one or more liquid hydrocarbon resins selected from the group consisting of
a glycidyl-ether-family hydrocarbon with a linear carbon chain comprising at least one carbon ring in the linear carbon chain,
a glycidyl-ether-family hydrocarbon comprising at least 10 carbons,
4,4′-dimethyl-2,2-diphenylpropane,
a glycidyl-ether-family hydrocarbon having a molecular weight of at least 200 g/mol, and
a glycidyl-ether-family hydrocarbon having a molecular weight of less than 300 g/mol.

4. The 1-part conductive epoxy of claim 1, wherein the graphene has a concentration in the 1-part conductive epoxy of at least 0.03% (wt.).

5. The 1-part conductive epoxy of claim 1, wherein the graphene has a width, a length, or both of 1-10 micrometers.

6. The 1-part conductive epoxy of claim 1, wherein the graphene has a surface area of about 400-2,000 m²/g.

7. The 1-part conductive epoxy of claim 1, wherein the graphene has a thickness of about 1-5 nm.

8. The 1-part conductive epoxy of claim 1, wherein the silver comprises silver flakes, colloidal silver nanoparticles, silver nanowires, spherical silver microparticles, silver-coated copper, silver-coated glass powder, silver-coated ceramic powder, or any combination thereof.

9. The 1-part conductive epoxy of claim 1, wherein the silver has a concentration by weight of about 55-90%.

10. The 1-part conductive epoxy of claim 1, wherein the epoxy resin has a concentration by weight of at most about 25%.

11. The 1-part conductive epoxy of claim 1, wherein the diluent has a concentration by weight of at least about 2%.

12. The 1-part conductive epoxy of claim 1, wherein the graphene has a concentration by weight of less than about 0.3%.

13. The 1-part conductive epoxy of claim 1, further comprising a solvent selected from the group consisting of methyl ethyl ketone and benzyl alcohol.

14. The 1-part conductive epoxy of claim 13, wherein the solvent has a concentration by weight of less than about 30%.

15. The 1-part conductive epoxy of claim 1, further comprising an ionic liquid selected from the group consisting of tributyl(ethyl) phosphonium diethyl phosphate and trihexyl (tetradecyl) phosphonium bis 2,4,4-(trimethyl pentyl)-phosphinate.

16. The 1-part conductive epoxy of claim 15, wherein the ionic liquid has a concentration by weight of at most about 4%.

17. The 1-part conductive epoxy of claim 1, further comprising a latent curing agent selected from the group consisting of dicyandiamide, organic acid hydrazide, tertiary amine imidazole, and a boron trifluoride amine complex.

18. The 1-part conductive epoxy of claim 1, further comprising a strength additive selected from the group consisting of neopentyl glycol and butadiene-acrylonitrile.

19. The 1-part conductive epoxy of claim 18, wherein the strength additive has a concentration by weight of at most about 8%.

20. A two-part conductive epoxy comprising:
a first part comprising an epoxy resin, a non-reactive diluent, silver, and graphene; and
a second part comprising at least one curing agent, a reactive diluent, silver, and graphene.
